(19) United States
(12) Patent Application Publication
(10) Pub. No.: US 2026/0267400 A1
(43) Pub. Date: Sep. 10, 2026

(54) USER INTERFACES AND TECHNIQUES FOR REPRESENTING INTERACTIONS

(71) Applicant: Apple Inc., Cupertino, CA (US)

(72) Inventor: Agatha Y. YU, Oakland, CA (US)

(21) Appl. No.: 19/462,990

(22) Filed: Jan. 28, 2026

Related U.S. Application Data
(60) Provisional application No. 63/970,288, filed on Jan. 28, 2026.
(60) Provisional application No. 63/751,256, filed on Jan. 29, 2025.

(51) Int. Cl. G06F 3/01; G06F 3/0481; G06F 3/16; H04N 23/695

(52) U.S. Cl. CPC G06F 3/011; G06F 3/0481; G06F 3/167; H04N 23/695

(57) ABSTRACT

The present disclosure generally relates to displaying content. Some techniques are for emphasizing content in accordance with some embodiments. Other techniques are for removing content in accordance with some embodiments. Other techniques are for displaying content in accordance with some embodiments. Other techniques are for changing modality of output in accordance with some embodiments.

### CROSS-REFERENCE TO RELATED APPLICATIONS

This application claims priority to U.S. Patent Application No. 63/970,288, entitled “User Interfaces and Techniques for Representing Interactions,” filed January 28, 2026, and U.S. Provisional Patent Application No. 63/751,256, entitled “User Interfaces and Techniques for Representing Interactions,” filed January 29, 2025. The content of this application is hereby incorporated by reference in its entirety.

### BACKGROUND

Electronic devices often manage content. Such management of content often includes removing content, adding content, and emphasizing content.

### SUMMARY

Existing techniques for displaying content are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient processes and interfaces for displaying content. Such processes and interfaces optionally complement or replace other processes for displaying content. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more input devices and one or more display components is described. In some embodiments, the method comprises: detecting, via the one or more input devices, an input corresponding to a software agent; and in response to detecting the input corresponding to the software agent, concurrently displaying, via the one or more display components: a first user interface element with a first manner of emphasis; and a second user interface element with a second manner of emphasis different from the first manner of emphasis, wherein the second user interface element is separate from the first user interface element; and while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, concurrently displaying, via the one or more display components: the first user interface element with a third manner of emphasis different from the first manner of emphasis; and the second user interface element with a fourth manner of emphasis different from the second manner of emphasis and the third manner of emphasis.

In some embodiments, a non-transitory computer-readable storage medium storing one or more programs configured to be executed by one or more processors of a computer system that is in communication with one or more input devices and one or more display components is described. In some embodiments, the one or more programs includes instructions for: detecting, via the one or more input devices, an input corresponding to a software agent; and in response to detecting the input corresponding to the software agent, concurrently displaying, via the one or more display components: a first user interface element with a first manner of emphasis; and a second user interface element with a second manner of emphasis different from the first manner of emphasis, wherein the second user interface element is separate from the first user interface element; and while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, concurrently displaying, via the one or more display components: the first user interface element with a third manner of emphasis different from the first manner of emphasis; and the second user interface element with a fourth manner of emphasis different from the second manner of emphasis and the third manner of emphasis.

In some embodiments, a transitory computer-readable storage medium storing one or more programs configured to be executed by one or more processors of a computer system that is in communication with one or more input devices and one or more display components is described. In some embodiments, the one or more programs includes instructions for: detecting, via the one or more input devices, an input corresponding to a software agent; and in response to detecting the input corresponding to the software agent, concurrently displaying, via the one or more display components: a first user interface element with a first manner of emphasis; and a second user interface element with a second manner of emphasis different from the first manner of emphasis, wherein the second user interface element is separate from the first user interface element; and while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, concurrently displaying, via the one or more display components: the first user interface element with a third manner of emphasis different from the first manner of emphasis; and the second user interface element with a fourth manner of emphasis different from the second manner of emphasis and the third manner of emphasis.

In some embodiments, a computer system configured to communicate with one or more input devices and one or more display components is described. In some embodiments, the computer system comprises one or more processors and memory storing one or more programs configured to be executed by the one or more processors. In some embodiments, the one or more programs includes instructions for: detecting, via the one or more input devices, an input corresponding to a software agent; and in response to detecting the input corresponding to the software agent, concurrently displaying, via the one or more display components: a first user interface element with a first manner of emphasis; and a second user interface element with a second manner of emphasis different from the first manner of emphasis, wherein the second user interface element is separate from the first user interface element; and while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, concurrently displaying, via the one or more display components: the first user interface element with a third manner of emphasis different from the first manner of emphasis; and the second user interface element with a fourth manner of emphasis different from the second manner of emphasis and the third manner of emphasis.

In some embodiments, a computer system configured to communicate with one or more input devices and one or more display components is described. In some embodiments, the computer system comprises means for performing each of the following steps: detecting, via the one or more input devices, an input corresponding to a software agent; and in response to detecting the input corresponding to the software agent, concurrently displaying, via the one or more display components: a first user interface element with a first manner of emphasis; and a second user interface element with a second manner of emphasis different from the first manner of emphasis, wherein the second user interface element is separate from the first user interface element; and while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, concurrently displaying, via the one or more display components: the first user interface element with a third manner of emphasis different from the first manner of emphasis; and the second user interface element with a fourth manner of emphasis different from the second manner of emphasis and the third manner of emphasis.

In some embodiments, a computer program product is described. In some embodiments, the computer program product comprises one or more programs configured to be executed by one or more processors of a computer system that is in communication with one or more input devices and one or more display components. In some embodiments, the one or more programs include instructions for: detecting, via the one or more input devices, an input corresponding to a software agent; and in response to detecting the input corresponding to the software agent, concurrently displaying, via the one or more display components: a first user interface element with a first manner of emphasis; and a second user interface element with a second manner of emphasis different from the first manner of emphasis, wherein the second user interface element is separate from the first user interface element; and while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, concurrently displaying, via the one or more display components: the first user interface element with a third manner of emphasis different from the first manner of emphasis; and the second user interface element with a fourth manner of emphasis different from the second manner of emphasis and the third manner of emphasis.

In some embodiments, a method that is performed at a computer system that is in communication with one or more input devices, one or more display components, and one or more movement components is described. In some embodiments, the method comprises: while displaying, via the one or more display components, a user interface element, detecting, via the one or more input devices, an input to dismiss the user interface element; and in response to detecting the input to dismiss the user interface element: moving, via the one or more movement components, a portion of the computer system; and ceasing display of, via the one or more display components, the user interface element.

In some embodiments, a non-transitory computer-readable storage medium storing one or more programs configured to be executed by one or more processors of a computer system that is in communication with one or more input devices, one or more display components, and one or more movement components is described. In some embodiments, the one or more programs includes instructions for: while displaying, via the one or more display components, a user interface element, detecting, via the one or more input devices, an input to dismiss the user interface element; and in response to detecting the input to dismiss the user interface element: moving, via the one or more movement components, a portion of the computer system; and ceasing display of, via the one or more display components, the user interface element.

In some embodiments, a transitory computer-readable storage medium storing one or more programs configured to be executed by one or more processors of a computer system that is in communication with one or more input devices, one or more display components, and one or more movement components is described. In some embodiments, the one or more programs includes instructions for: while displaying, via the one or more display components, a user interface element, detecting, via the one or more input devices, an input to dismiss the user interface element; and in response to detecting the input to dismiss the user interface element: moving, via the one or more movement components, a portion of the computer system; and ceasing display of, via the one or more display components, the user interface element.

In some embodiments, a computer system configured to communicate with one or more input devices, one or more display components, and one or more movement components is described. In some embodiments, the computer system comprises one or more processors and memory storing one or more programs configured to be executed by the one or more processors. In some embodiments, the one or more programs includes instructions for: while displaying, via the one or more display components, a user interface element, detecting, via the one or more input devices, an input to dismiss the user interface element; and in response to detecting the input to dismiss the user interface element: moving, via the one or more movement components, a portion of the computer system; and ceasing display of, via the one or more display components, the user interface element.

In some embodiments, a computer system configured to communicate with one or more input devices, one or more display components, and one or more movement components is described. In some embodiments, the computer system comprises means for performing each of the following steps: while displaying, via the one or more display components, a user interface element, detecting, via the one or more input devices, an input to dismiss the user interface element; and in response to detecting the input to dismiss the user interface element: moving, via the one or more movement components, a portion of the computer system; and ceasing display of, via the one or more display components, the user interface element.

In some embodiments, a computer program product is described. In some embodiments, the computer program product comprises one or more programs configured to be executed by one or more processors of a computer system that is in communication with one or more input devices, one or more display components, and one or more movement components. In some embodiments, the one or more programs include instructions for: while displaying, via the one or more display components, a user interface element, detecting, via the one or more input devices, an input to dismiss the user interface element; and in response to detecting the input to dismiss the user interface element: moving, via the one or more movement components, a portion of the computer system; and ceasing display of, via the one or more display components, the user interface element.

In some embodiments, a method that is performed at a computer system that is in communication with one or more input devices and one or more display components is described. In some embodiments, the method comprises: while the computer system is operating in a standby state and without detecting, via the one or more input devices, an input directed to the computer system: in accordance with a determination that a subject had a first set of one or more interactions while the computer system was operating in an active state, displaying, via the one or more display components, a first set of one or more user interface elements, wherein the active state is different from the standby state; and in accordance with a determination that the subject had a second set of one or more interactions while the computer system was operating in the active state, displaying, via the one or more display components, a second set of one or more user interface elements different from the first set of one or more user interface elements, wherein the second set of one or more interactions is different from the first set of one or more interactions.

In some embodiments, a non-transitory computer-readable storage medium storing one or more programs configured to be executed by one or more processors of a computer system that is in communication with one or more input devices and one or more display components is described. In some embodiments, the one or more programs includes instructions for: while the computer system is operating in a standby state and without detecting, via the one or more input devices, an input directed to the computer system: in accordance with a determination that a subject had a first set of one or more interactions while the computer system was operating in an active state, displaying, via the one or more display components, a first set of one or more user interface elements, wherein the active state is different from the standby state; and in accordance with a determination that the subject had a second set of one or more interactions while the computer system was operating in the active state, displaying, via the one or more display components, a second set of one or more user interface elements different from the first set of one or more user interface elements, wherein the second set of one or more interactions is different from the first set of one or more interactions.

In some embodiments, a transitory computer-readable storage medium storing one or more programs configured to be executed by one or more processors of a computer system that is in communication with one or more input devices and one or more display components is described. In some embodiments, the one or more programs includes instructions for: while the computer system is operating in a standby state and without detecting, via the one or more input devices, an input directed to the computer system: in accordance with a determination that a subject had a first set of one or more interactions while the computer system was operating in an active state, displaying, via the one or more display components, a first set of one or more user interface elements, wherein the active state is different from the standby state; and in accordance with a determination that the subject had a second set of one or more interactions while the computer system was operating in the active state, displaying, via the one or more display components, a second set of one or more user interface elements different from the first set of one or more user interface elements, wherein the second set of one or more interactions is different from the first set of one or more interactions.

In some embodiments, a computer system configured to communicate with one or more input devices and one or more display components is described. In some embodiments, the computer system comprises one or more processors and memory storing one or more programs configured to be executed by the one or more processors. In some embodiments, the one or more programs includes instructions for: while the computer system is operating in a standby state and without detecting, via the one or more input devices, an input directed to the computer system: in accordance with a determination that a subject had a first set of one or more interactions while the computer system was operating in an active state, displaying, via the one or more display components, a first set of one or more user interface elements, wherein the active state is different from the standby state; and in accordance with a determination that the subject had a second set of one or more interactions while the computer system was operating in the active state, displaying, via the one or more display components, a second set of one or more user interface elements different from the first set of one or more user interface elements, wherein the second set of one or more interactions is different from the first set of one or more interactions.

In some embodiments, a computer system configured to communicate with one or more input devices and one or more display components is described. In some embodiments, the computer system comprises means for performing each of the following steps: while the computer system is operating in a standby state and without detecting, via the one or more input devices, an input directed to the computer system: in accordance with a determination that a subject had a first set of one or more interactions while the computer system was operating in an active state, displaying, via the one or more display components, a first set of one or more user interface elements, wherein the active state is different from the standby state; and in accordance with a determination that the subject had a second set of one or more interactions while the computer system was operating in the active state, displaying, via the one or more display components, a second set of one or more user interface elements different from the first set of one or more user interface elements, wherein the second set of one or more interactions is different from the first set of one or more interactions.

In some embodiments, a computer program product is described. In some embodiments, the computer program product comprises one or more programs configured to be executed by one or more processors of a computer system that is in communication with one or more input devices and one or more display components. In some embodiments, the one or more programs include instructions for: while the computer system is operating in a standby state and without detecting, via the one or more input devices, an input directed to the computer system: in accordance with a determination that a subject had a first set of one or more interactions while the computer system was operating in an active state, displaying, via the one or more display components, a first set of one or more user interface elements, wherein the active state is different from the standby state; and in accordance with a determination that the subject had a second set of one or more interactions while the computer system was operating in the active state, displaying, via the one or more display components, a second set of one or more user interface elements different from the first set of one or more user interface elements, wherein the second set of one or more interactions is different from the first set of one or more interactions.

In some embodiments, a method that is performed at a computer system that is in communication with one or more input devices and one or more output devices is described. In some embodiments, the method comprises: detecting, via the one or more input devices, a subject in a physical environment; and in response to detecting the subject in the physical environment: in accordance with a determination that the subject has a first likelihood of interaction with the computer system, outputting, via the one or more output devices, a first modality of output without outputting, via the one or more output devices, a second modality of output different from the first modality of output; and in accordance with a determination that the subject has a second likelihood of interaction with the computer system, outputting, via the one or more output devices, the first modality of output and the second modality of output, wherein the second likelihood of interaction is different from the first likelihood of interaction.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, a subject in a physical environment; and in response to detecting the subject in the physical environment: in accordance with a determination that the subject has a first likelihood of interaction with the computer system, outputting, via the one or more output devices, a first modality of output without outputting, via the one or more output devices, a second modality of output different from the first modality of output; and in accordance with a determination that the subject has a second likelihood of interaction with the computer system, outputting, via the one or more output devices, the first modality of output and the second modality of output, wherein the second likelihood of interaction is different from the first likelihood of interaction.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, a subject in a physical environment; and in response to detecting the subject in the physical environment: in accordance with a determination that the subject has a first likelihood of interaction with the computer system, outputting, via the one or more output devices, a first modality of output without outputting, via the one or more output devices, a second modality of output different from the first modality of output; and in accordance with a determination that the subject has a second likelihood of interaction with the computer system, outputting, via the one or more output devices, the first modality of output and the second modality of output, wherein the second likelihood of interaction is different from the first likelihood of interaction.

In some embodiments, a computer system that is configured to communicate with one or more input devices and one or more output devices is described. In some embodiments, the computer system comprises one or more processors and memory storing one or more programs configured to be executed by the one or more processors. In some embodiments, the one or more programs includes instructions for: detecting, via the one or more input devices, a subject in a physical environment; and in response to detecting the subject in the physical environment: in accordance with a determination that the subject has a first likelihood of interaction with the computer system, outputting, via the one or more output devices, a first modality of output without outputting, via the one or more output devices, a second modality of output different from the first modality of output; and in accordance with a determination that the subject has a second likelihood of interaction with the computer system, outputting, via the one or more output devices, the first modality of output and the second modality of output, wherein the second likelihood of interaction is different from the first likelihood of interaction.

In some embodiments, a computer system that is configured to communicate with one or more input devices and one or more output devices is described. In some embodiments, the computer system comprises means for performing each of the following steps: detecting, via the one or more input devices, a subject in a physical environment; and in response to detecting the subject in the physical environment: in accordance with a determination that the subject has a first likelihood of interaction with the computer system, outputting, via the one or more output devices, a first modality of output without outputting, via the one or more output devices, a second modality of output different from the first modality of output; and in accordance with a determination that the subject has a second likelihood of interaction with the computer system, outputting, via the one or more output devices, the first modality of output and the second modality of output, wherein the second likelihood of interaction is different from the first likelihood of interaction.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, a subject in a physical environment; and in response to detecting the subject in the physical environment: in accordance with a determination that the subject has a first likelihood of interaction with the computer system, outputting, via the one or more output devices, a first modality of output without outputting, via the one or more output devices, a second modality of output different from the first modality of output; and in accordance with a determination that the subject has a second likelihood of interaction with the computer system, outputting, via the one or more output devices, the first modality of output and the second modality of output, wherein the second likelihood of interaction is different from the first likelihood of interaction.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a computer system in accordance with some embodiments.

FIGS. 1B-1G illustrate the use of Application Programming Interfaces (APIs) to perform operations.

FIGS. 2A-2C are diagrams illustrating exemplary components and user interfaces of an electronic device in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6M illustrate exemplary user interfaces for displaying content in accordance with some embodiments.

FIG. 7 is a flow diagram illustrating a process for emphasizing content in accordance with some embodiments.

FIG. 8 is a flow diagram illustrating a process for removing content in accordance with some embodiments.

FIG. 9 is a flow diagram illustrating a process for displaying content in accordance with some embodiments.

FIGS. 10A-10G illustrate exemplary user interfaces for changing modality of output in accordance with some embodiments.

FIG. 11 is a flow diagram illustrating a process for changing modality of output in accordance with some embodiments.

### DETAILED DESCRIPTION

The description to follow sets forth exemplary processes, components, parameters, and the like. While specific examples are set out below, it should be recognized that such embodiments should not be understood as limiting the scope of the present disclosure to the explicit descriptions of the examples set forth herein but instead should be understood as providing illustrative examples.

One or more steps of the processes described herein can rely on (e.g., be contingent on) one or more conditions being satisfied. In some embodiments, a process is performed by iterating a process multiple times. In some embodiments, contingent steps can be satisfied on different iterations of the same process and still be within the scope of the processes described herein. For example, for a given process that includes two steps that are contingent on different conditions, one of ordinary skill in the art would understand that the given process is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct elements and should not be limited to the stated numerical descriptor unless explicitly stated with an order and/or that they are separate and/or different. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompasses any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device and/or user-device interfaces more efficient (e.g., by helping the user to provide proper inputs and reducing user mistakes when operating/interacting with the device) through various techniques, including by providing improved feedback (e.g., visual, haptic, acoustic, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

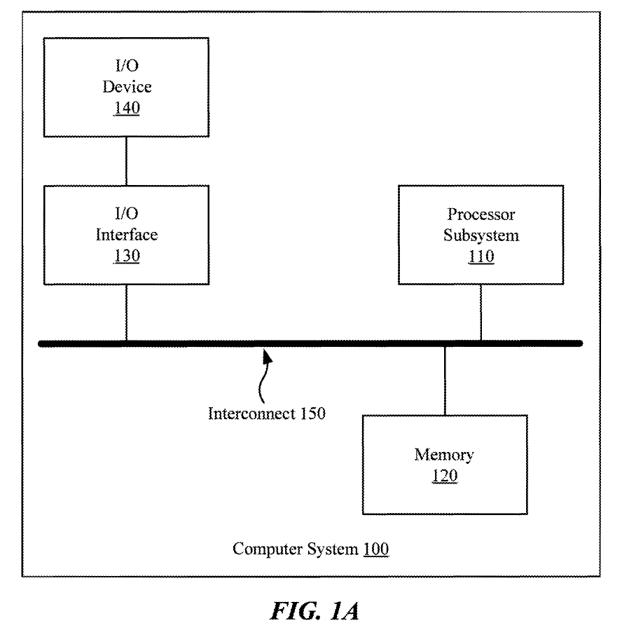

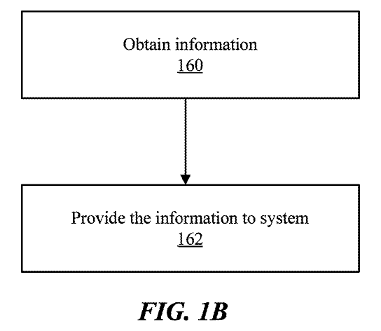

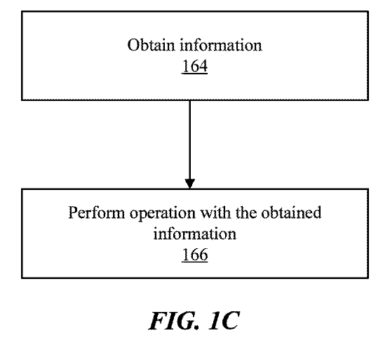

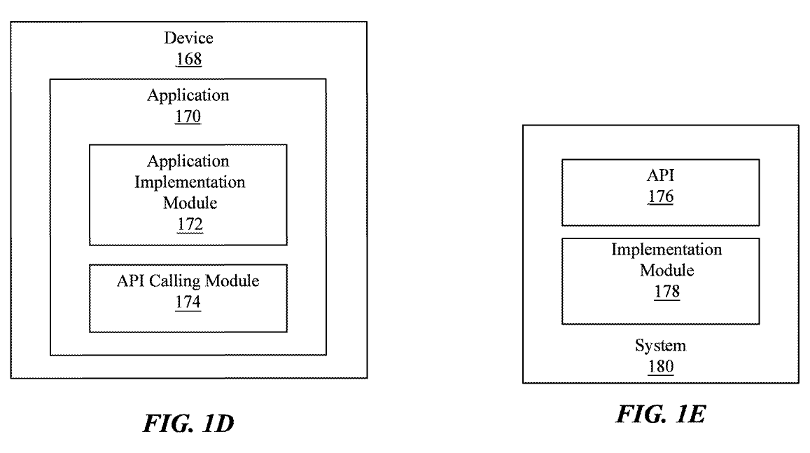

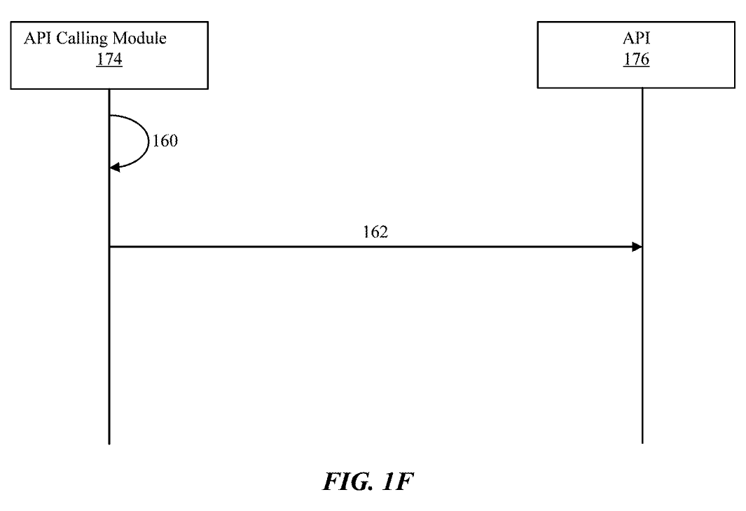

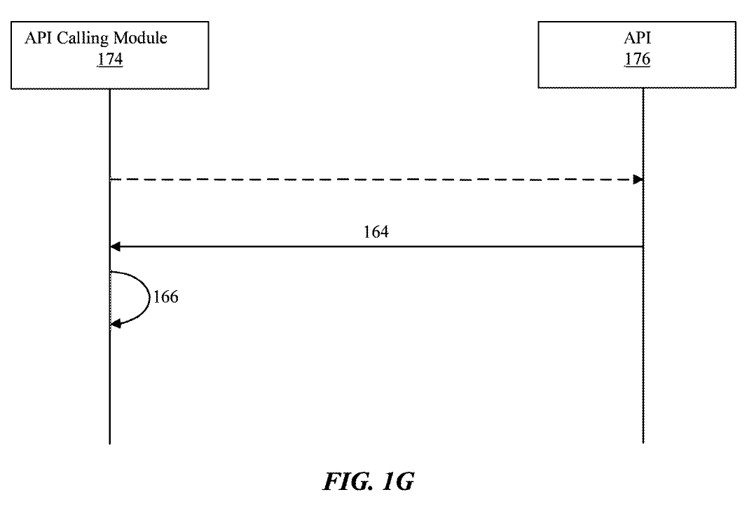

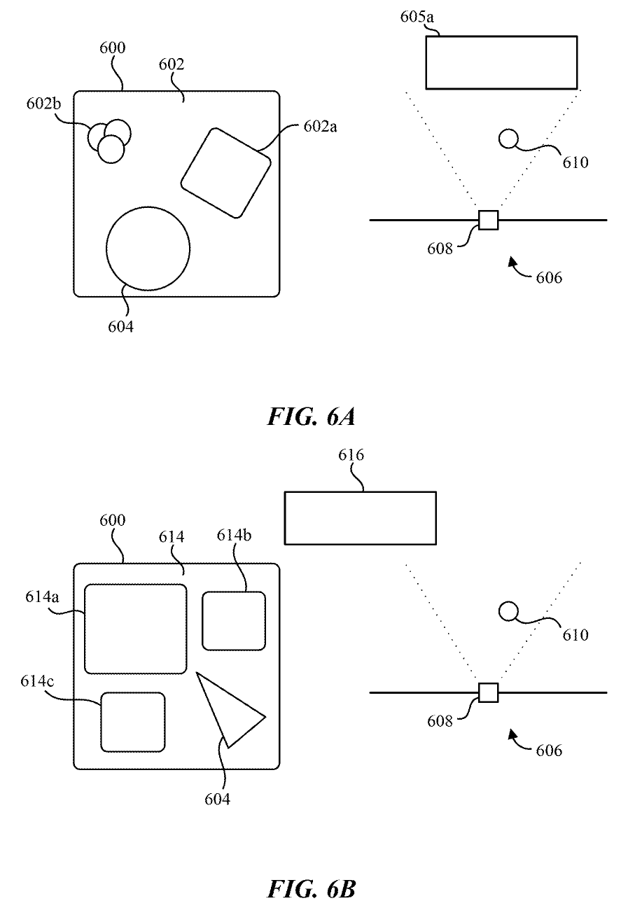

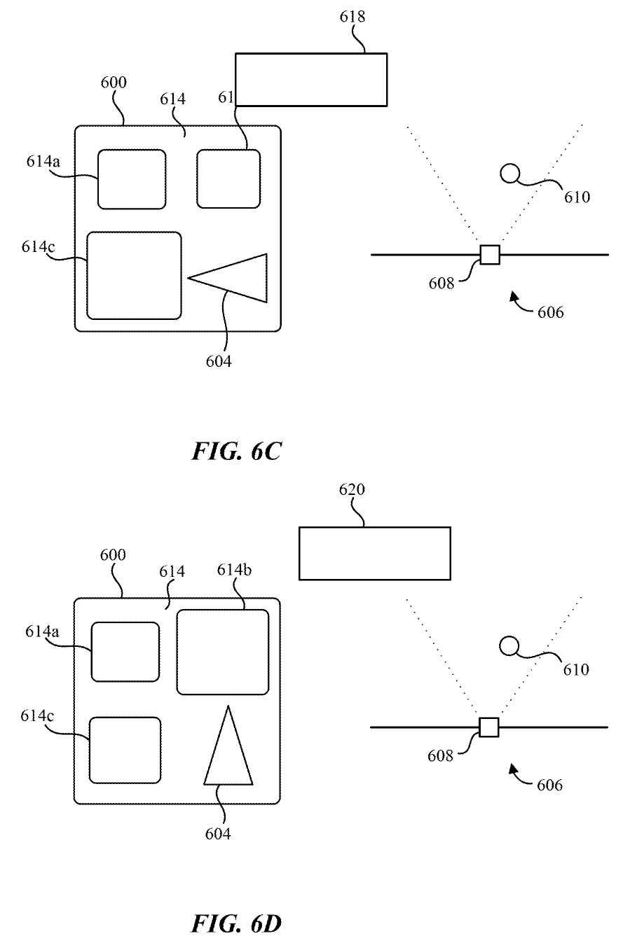

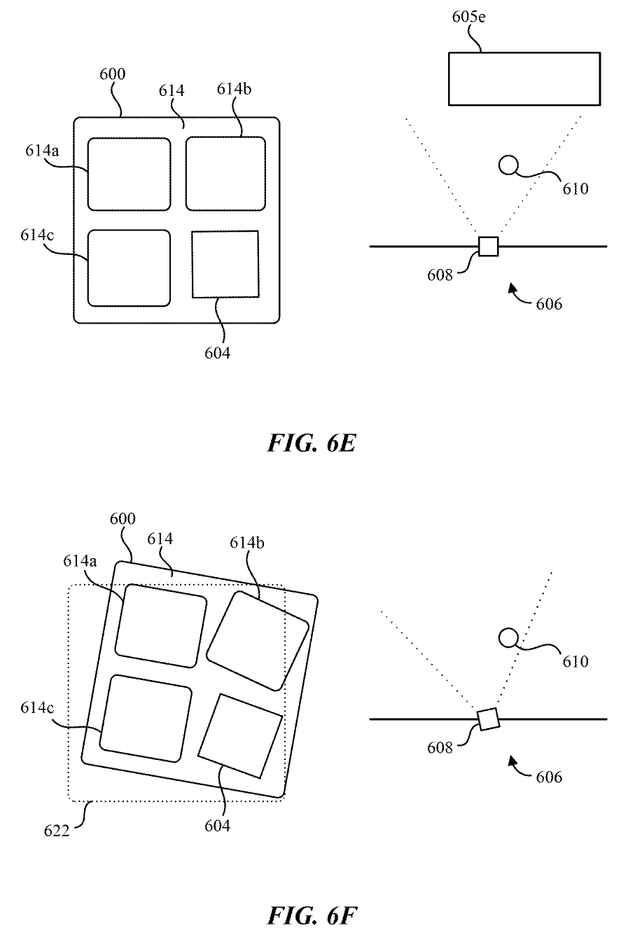

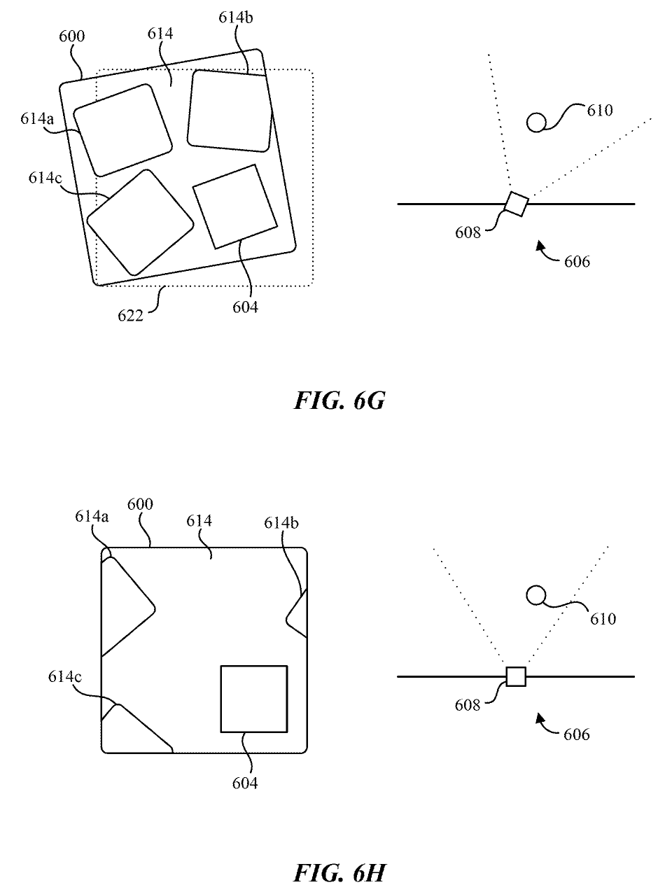

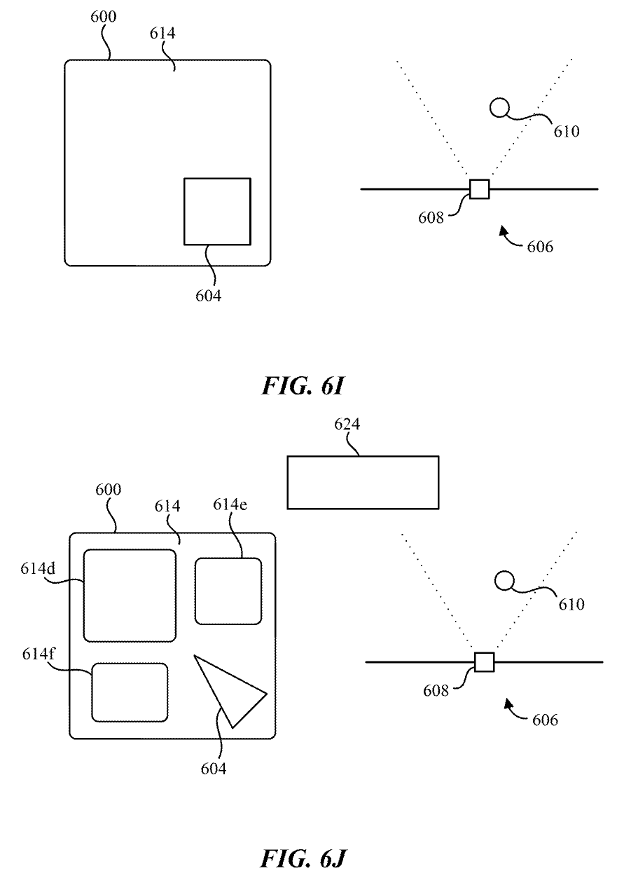

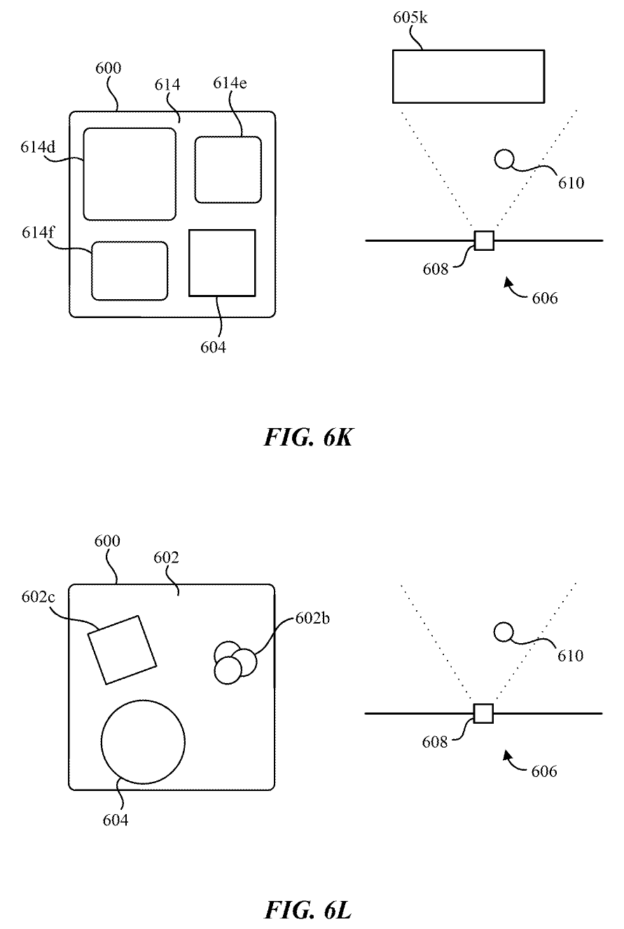

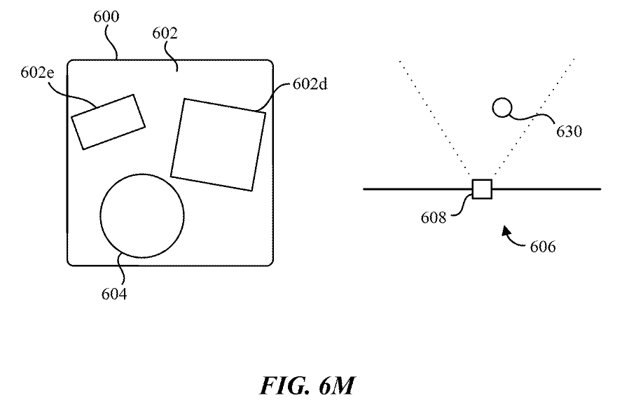

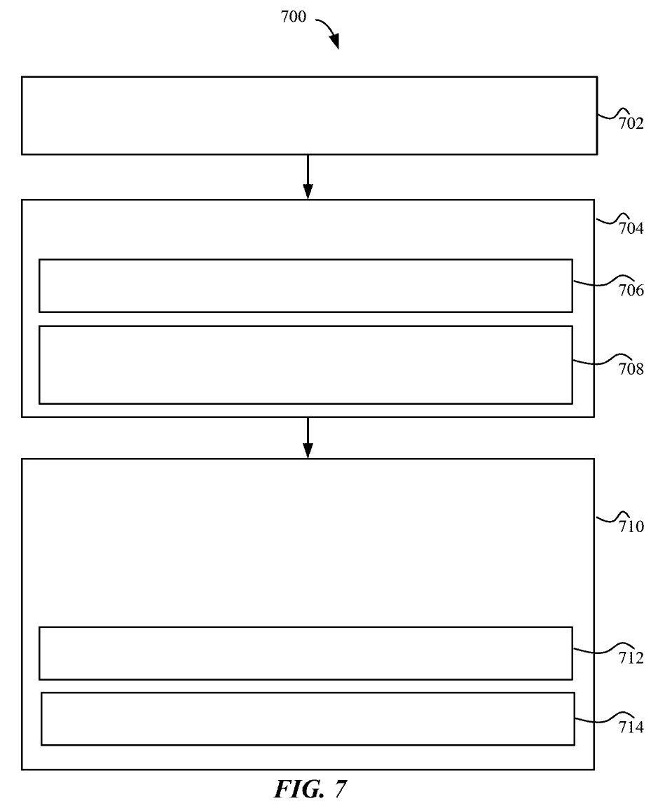

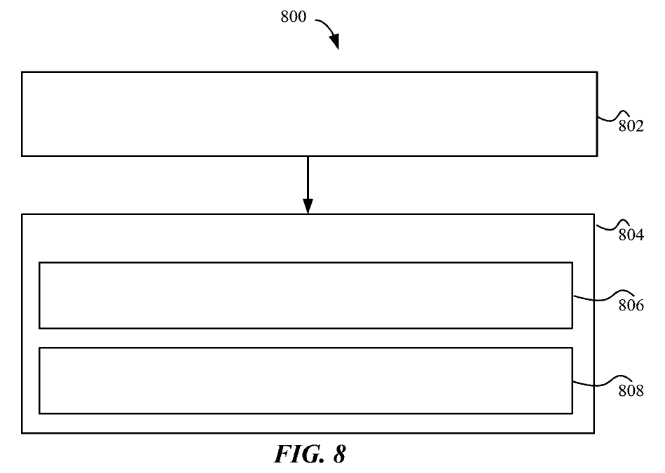

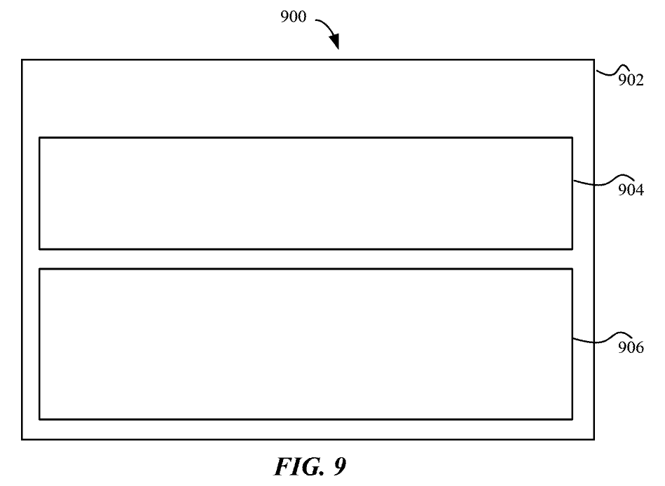

Below, FIGS. 1A-1G, 2A-2C, and 3-5 provide a description of exemplary devices for performing the techniques for displaying content. FIGS. 6A-6M illustrate exemplary user interfaces for displaying content in accordance with some embodiments. FIG. 7 is a flow diagram illustrating a process for emphasizing content in accordance with some embodiments. The user interfaces in FIGS. 6A-6M are used to illustrate the processes described below, including the processes in FIG. 7. FIG. 8 is a flow diagram illustrating a process for removing content in accordance with some embodiments. The user interfaces in FIGS. 6A-6M are used to illustrate the processes described below, including the processes in FIG. 8. FIG. 9 is a flow diagram illustrating a process for displaying content in accordance with some embodiments. The user interfaces in FIGS. 6A-6M are used to illustrate the processes described below, including the processes in FIG. 9.

FIG. 1A depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1A depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, and/or television), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR and/or LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1A, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1A, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystems (e.g., processor subsystem 110), each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments, each instruction stored by memory 120 and executed by processor subsystem 110 corresponds to an operation for completing the functionality described herein. For example, memory 120 can store program instructions to implement the functionality associated with processes 700, 800, 900, and 1100 (FIGS. 7, 8, 9, and 11) described below.

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (e.g., a user, a person, an animal, another computer system different from the computer system, and/or an object) and/or an input (e.g., a tap input and/or a non-tap input (e.g., a verbal input, an acoustic request, an acoustic command, an acoustic statement, a swipe input, a hold-and-drag input, a gaze input, an air gesture, and/or a mouse click)) from a detected user. In some embodiments, I/O device 140 enables computer system 100 to identify users associated with and/or without an account within an environment. For example, computer system 100 can detect a known user (e.g., a user that corresponds to an account) and access information about the user using the known user’s account. In some embodiments, as part of computer system 100 detecting a user, computer system 100 detects that the user’s account is associated with (e.g., is included in and/or identified with respect to) a group of users. For example, computer system 100 can access information associated with a family of accounts in response to detecting a member of the family that is defined as a group of accounts. In some embodiments, an account corresponding to a user can be connected with additional accounts and/or additional computer systems. For example, computer system 100 can detect such additional computer systems and/or detect such computer systems for detecting the user. In some embodiments, computer system 100 detects unknown users and enables guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user’s gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output device. For example, a tactile output device can be a haptic component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, and/or digital art). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, and/or audio sensors). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or methods described herein.

It should be recognized that application 170 can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 170 is an application that is pre-installed on device 168 at purchase (e.g., a first-party application). In some embodiments, application 170 is an application that is provided to device 168 via an operating system update file (e.g., a first-party application or a second-party application). In some embodiments, application 170 is an application that is provided via an application store. In some embodiments, the application store can be an application store that is pre-installed on device 168 at purchase (e.g., a first-party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to a system (e.g., 162).

In some embodiments, the system (e.g., 180 shown in FIG. 1E) is an operating system hosted on device 168. In some embodiments, the system (e.g., 180 shown in FIG. 1E) is an external device (e.g., a server, a peripheral device, an accessory, and/or a personal computing device) that includes an operating system.

Referring to FIG. 1C and FIG. 1G, application 170 obtains information (e.g., 164). In some embodiments, the information obtained at 164 includes positional information, time information, notification information, user information, environment information, electronic device state information, weather information, media information, historical information, event information, hardware information, and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. As illustrated in FIG. 1D, device 168 includes application 170 and an operating system (e.g., system 180 shown in FIG. 1E). Application 170 includes application implementation module 172 and API calling module 174. System 180 includes API 176 and implementation module 178. It should be recognized that device 168, application 170, and/or system 180 can include more, fewer, and/or different components than illustrated in FIGS. 1D and 1E.

In some embodiments, application implementation module 172 includes a set of one or more instructions corresponding to one or more operations performed by application 170. For example, when application 170 is a messaging application, application implementation module 172 can include operations to receive and send messages. In some embodiments, application implementation module 172 communicates with API calling module 174 to communicate with system 180 via API 176 (shown in FIG. 1E).

In some embodiments, API 176 is a software module (e.g., a collection of computer-readable instructions) that provides an interface that allows a different module (e.g., API calling module 174) to access and/or use one or more functions, methods, procedures, data structures, classes, and/or other services provided by implementation module 178 of system 180. For example, API calling module 174 can access a feature of implementation module 178 through one or more API calls or invocations (e.g., embodied by a function or a method call) exposed by API 176 (e.g., a software and/or hardware module that can receive API calls, respond to API calls, and/or send API calls) and can pass data and/or control information using one or more parameters via the API calls or invocations. In some embodiments, API 176 allows application 170 to use a service provided by a Software Development Kit (SDK) library. In some embodiments, application 170 incorporates a call to a function or method provided by the SDK library and provided by API 176 or uses data types or objects defined in the SDK library and provided by API 176. In some embodiments, API calling module 174 makes an API call via API 176 to access and use a feature of implementation module 178 that is specified by API 176. In such embodiments, implementation module 178 can return a value via API 176 to API calling module 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low-level logic that executes in part on the hardware component.

In some embodiments, API 176 allows a developer of API calling module 174 (which can be a third-party developer) to leverage a feature provided by implementation module 178. In such embodiments, there can be one or more API-calling modules (e.g., including API calling module 174) that communicate with implementation module 178. In some embodiments, API 176 allows multiple API-calling modules written in different programming languages to communicate with implementation module 178 (e.g., API 176 can include features for translating calls and returns between implementation module 178 and API calling module 174) while API 176 is implemented in terms of a specific programming language. In some embodiments, API calling module 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing a secure connection (e.g., with an accessory)), a device detection API (e.g., for locating nearby devices (e.g., media devices and/or smartphone)), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API. In some embodiments, the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, LiDAR data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 178 is a system (e.g., operating system, and/or server system) software module (e.g., a collection of computer-readable instructions) that is constructed to perform an operation in response to receiving an API call via API 176. In some embodiments, implementation module 178 is constructed to provide an API response (via API 176) as a result of processing an API call. By way of example, implementation module 178 and API calling module 174 can each be any one of an operating system, a library, a device driver, an API, an application program, or other module. It should be understood that implementation module 178 and API calling module 174 can be the same or different type of module from each other. In some embodiments, implementation module 178 is embodied at least in part in firmware, microcode, or hardware logic.

In some embodiments, implementation module 178 returns a value through API 176 in response to an API call from API calling module 174. While API 176 defines the syntax and result of an API call (e.g., how to invoke the API call and what the API call does), API 176 might not reveal how implementation module 178 accomplishes the function specified by the API call. Various API calls are transferred via the one or more application programming interfaces between API calling module 174 and implementation module 178. Transferring the API calls can include issuing, initiating, invoking, calling, receiving, returning, and/or responding to the function calls or messages. In other words, transferring can describe actions by either of API calling module 174 or implementation module 178. In some embodiments, a function call or other invocation of API 176 sends and/or receives one or more parameters through a parameter list or other structure.

In some embodiments, implementation module 178 provides more than one API, each providing a different view of or with different aspects of functionality implemented by implementation module 178. For example, one API of implementation module 178 can provide a first set of functions and can be exposed to third-party developers, and another API of implementation module 178 can be hidden (e.g., not exposed) and provide a subset of the first set of functions and also provide another set of functions, such as testing or debugging functions which are not in the first set of functions. In some embodiments, implementation module 178 calls one or more other components via an underlying API and thus is both an API calling module and an implementation module. It should be recognized that implementation module 178 can include additional functions, methods, classes, data structures, and/or other features that are not specified through API 176 and are not available to API calling module 174. It should also be recognized that API calling module 174 can be on the same system as implementation module 178 or can be located remotely and access implementation module 178 using API 176 over a network. In some embodiments, implementation module 178, API 176, and/or API calling module 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform processes 700, 800, 900, and 1100 (FIGS. 7, 8, 9, and 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, API 176 defines a first API call that can be provided by AP I-calling module 1180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 168) that runs the application. In some embodiments, the implementation module is included in an electronic device that is separate from the device that runs the application.

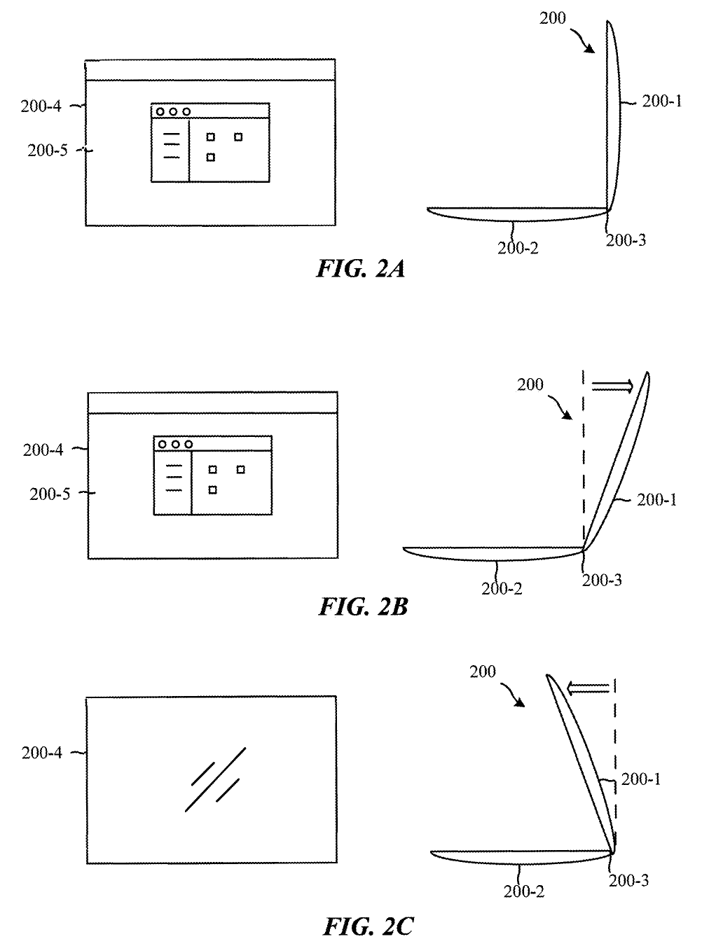

FIGS. 2-5 illustrate exemplary components and user interfaces of device 200 in accordance with some embodiments. Device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., and is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIGS. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user’s eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

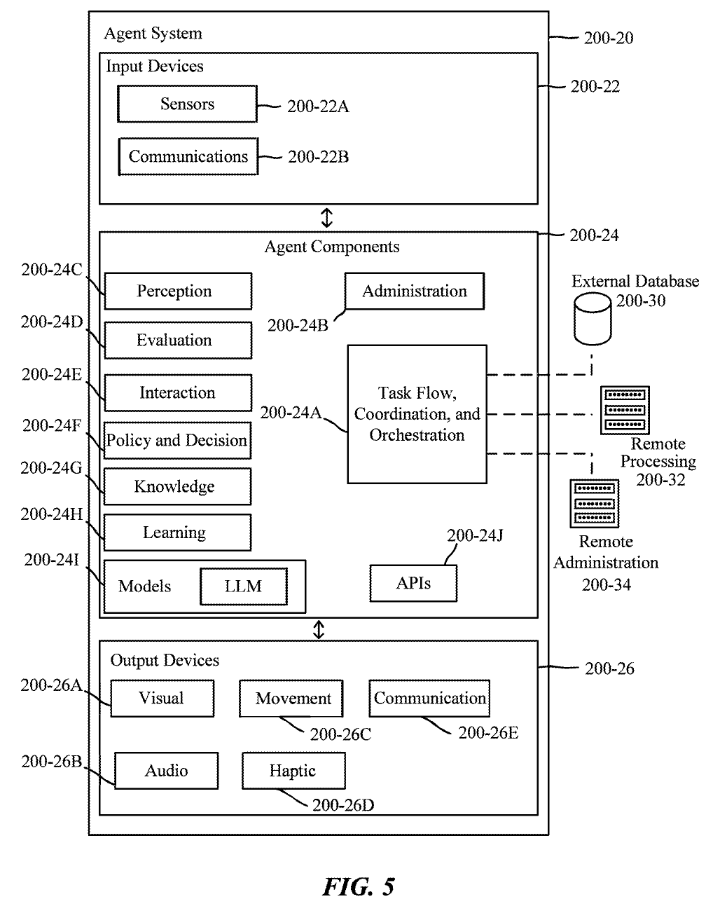

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output device that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0-360 degrees), to move laterally (e.g., right, left, down, up, and/or any combination thereof), and/or to tilt (e.g., 0-360 degrees).

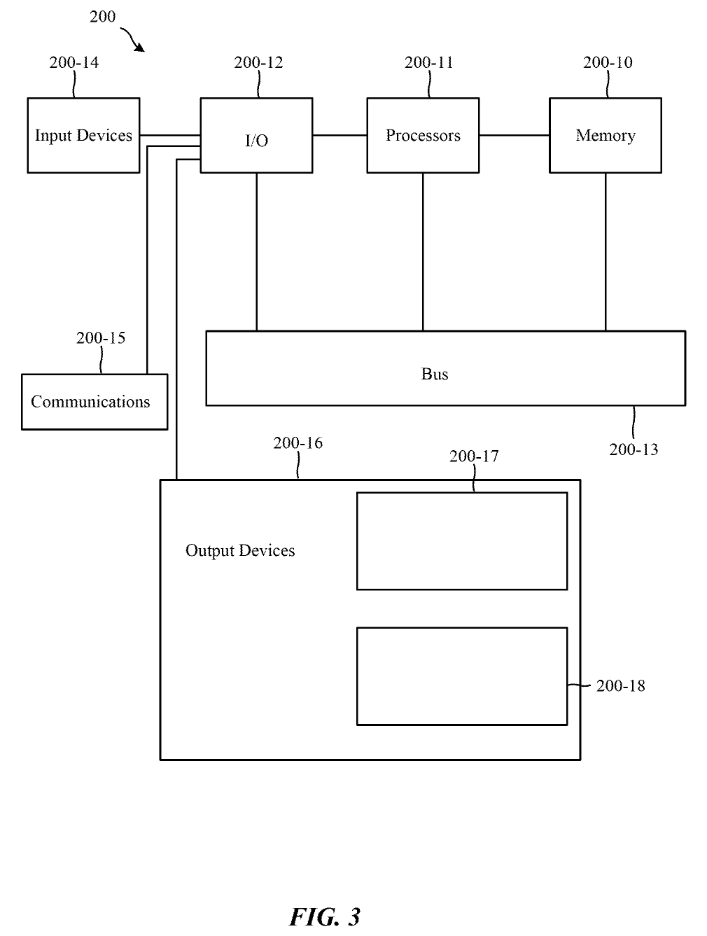

FIG. 3 illustrates exemplary block diagram of device 200. In some embodiments, device 200 includes some or all of the components described with respect to FIGS. 1A-1G, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output devices”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of device 200 can include one or more non-transitory computer-readable storage mediums, for storing computer-executable instructions, which, when executed by one or more computer processors 200-11, for example, cause the computer processors to perform the techniques described below, including processes 700, 800, 900, and 1100 (FIGS. 7, 8, 9, and 11). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Device 200 is not limited to the components and configuration of FIG. 3, but can include other and/or additional components in a multitude of possible configurations, all of which are intended to be within the scope of this disclosure.

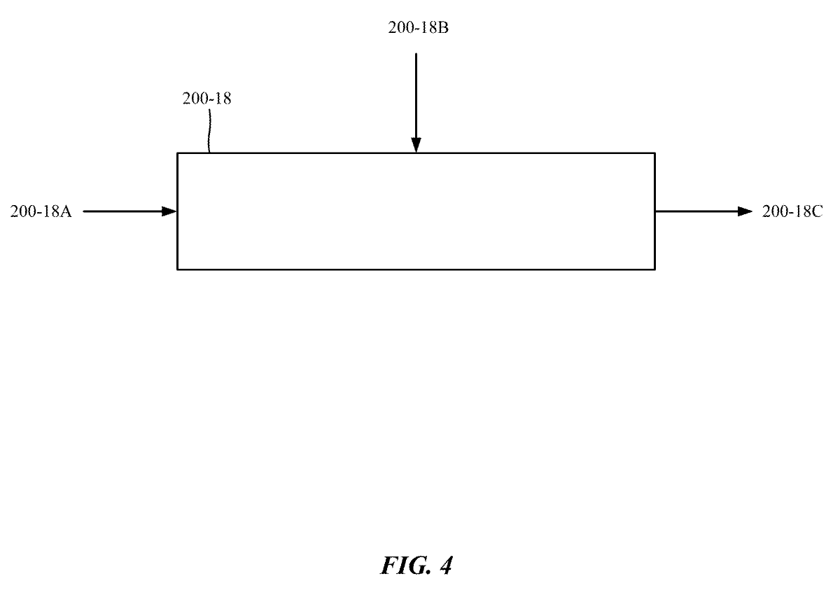

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user’s eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a user, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “person,” “object,” and/or “animal” can be interchanged with “user” throughout this disclosure, unless explicitly indicated otherwise. For example, use the term “user” can likewise be understood to also refer to “user,” unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20. As illustrated in FIG. 5, agent system 200-20 has a dotted box boundary that encloses input devices 200-22, agent components 200-24, and output devices 200-26. In some embodiments, agent system 200-20 includes fewer, more, and/or different components than illustrated in FIG. 5. In some embodiments, agent system 200-20 is implemented on a single device (e.g., computer system 100 and/or device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input devices 200-22 includes components for performing sensing and/or communications functions of agent system 200-20. As illustrated in FIG. 5, input devices 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input devices 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input devices 200-22 includes fewer, more, and/or different components than those illustrated in FIG. 5. In some embodiments, input devices 200-22 are implemented in hardware and/or software.

In some embodiments, agent components 200-24 includes components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-24I, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 includes fewer, more, and/or different components than those illustrated in FIG. 5. In some embodiments, agent components 200-24 is implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-24I (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., user, person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input devices) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user (and/or a user). For example, a user context can include the user’s appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input devices) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device’s understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input devices) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. For example, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-24I performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-24I includes functionality performed by an operating system of a device implementing agent system 200-20. In some embodiments, models component 200-24I includes functionality performed by one or more applications of a device implementing agent system 200-20.

In some embodiments, agent system 200-20 responds to natural language input. For example, agent system 200-20 responds to a natural language input that is in the form of a statement, a question, a command, and/or a request. In some embodiments, agent system 200-20 outputs text and/or speech output that is provided in a natural language or mimicking a natural language style. For example, agent system 200-20 can process the natural language question “How hot is it outside?” with a speech response that indicates the current temperature outside at the user’s location (e.g., “It is 18 degrees outside.”). In some embodiments, agent system 200-20 responds to natural language input by providing information (e.g., weather, travel, and/or calendar information) and/or performing a task (e.g., opening a document, searching a database, and/or opening an application).

In some embodiments, agent system 200-20 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user’s request. In some embodiments, data models used by agent system 200-20 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output devices 200-26 includes components for performing output functions of agent system 200-20. The exemplary output devices illustrated in FIG. 5 are described briefly below. In some embodiments, output devices 200-26 include fewer components, more, and/or different components than those illustrated in FIG. 5. In some embodiments, output devices 200-26 are implemented in hardware and/or software.

As illustrated in FIG. 5, output devices 200-26 includes one or more visual output devices 200-26A. One or more visual output devices 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output devices 200-26A can include: a display component, a projector, a head mounted display (HMD), a light-emitting diode (“LED”), and/or a component that creates visually perceptible effects (e.g., movement). This list is not intended to be exhaustive, and one or more visual output devices 200-26A can include other visual output devices not explicitly identified herein that detect, generate, and/or otherwise provide data that can be used (e.g., processed, stored, and/or transformed) for outputting visual output.

As illustrated in FIG. 5, output devices 200-26 include one or more audio output devices 200-26B. One or more audio output devices 200-26B can include any component that functions to output (e.g., generate and/or create), and/or cause output of, an audio output (e.g., an output that is audibly perceptible, such as a sound, music, speech, and/or audio media content). Examples of one or more audio output devices 200-26B can include: a speaker, an audio amplifier, a tone generator, and/or a component that creates audibly perceptible effects (e.g., movement such as vibrations). This list is not intended to be exhaustive, and one or more audio output devices 200-26B can include other audio output devices not explicitly identified herein that detect, generate, and/or otherwise provide data that can be used (e.g., processed, stored, and/or transformed) for outputting audio output.

As illustrated in FIG. 5, output devices 200-26 include one or more movement output devices 200-26C (also referred to herein as a “movement component”). One or more movement output devices 200-26C can include any component that functions to output (e.g., generate and/or create), and/or cause output of, a movement output (e.g., an output that includes physical movement of the device and/or another device/component). Examples of one or more movement output devices 200-26C can include: a movement controller, an actuator, a mechanical linkage, an electromechanical device, and/or a component that creates physical movement. This list is not intended to be exhaustive, and one or more movement output devices 200-26C can include other movement output devices not explicitly identified herein that detect, generate, and/or otherwise provide data that can be used (e.g., processed, stored, and/or transformed) for outputting movement output. As illustrated in FIG. 5, output devices 200-26 include one or more haptic output devices 200-26D. One or more haptic output devices 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output devices 200-26D can include: a speaker, a component that generates vibrations, a component that generates texture changes, a component that generates pressure changes, and/or a component that creates perceivable tactile effects. This list is not intended to be exhaustive, and one or more haptic output devices 200-26D can include other haptic output devices not explicitly identified herein that detect, generate, and/or otherwise provide data that can be used (e.g., processed, stored, and/or transformed) for outputting haptic output.

As illustrated in FIG. 5, output devices 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input device and an output device).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-20 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output devices that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I’m so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, acoustic output, sound, and/or speech) (also referred to herein as a “verbal response,” an “audio response,” and/or an “acoustic response) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user’s personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user’s personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (e.g., person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user’s appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user’s voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user’s expression (e.g., detects if a person is sad and responds with a kind statement or question). In some embodiments, expressions (e.g., whether and/or how they are used and/or how they are output) depends on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user’s voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user’s routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. For example, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). For example, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments, an agent (and/or device) determines and/or performs an operation based on an intent corresponding to a user. For example, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or device 200.

FIGS. 6A-6M illustrate exemplary user interfaces for displaying display content in accordance with some embodiments. The user interfaces in these figures are used to illustrate the processes described below, including the processes in FIGS. 7-9.

FIGS. 6A-6M illustrate computer system 600 as a tablet. It should be recognized that computer system 600 can be other types of computer systems such as a smartphone, a smart watch, a laptop, a communal device, a smart speaker, an accessory, a personal gaming system, a desktop computer, a fitness tracking device, and/or a head-mounted display (HMD) device. In some embodiments, computer system 600 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 600 includes and/or is in communication with one or more output devices (e.g., a display screen, a projector, a touch-sensitive display, a speaker, and/or a movement component). In some embodiments, computer system 600 includes one or more components and/or features described above in relation to computer system 100 and/or electronic device 200. In some embodiments, computer system 600 is, includes, implements, and/or is in communication with one or more agent systems as described above with respect to FIG. 5 (e.g., referred to as "the agent" below).

FIGS. 6A-6M are split between a left side and a right side to illustrate a subject in a physical environment interacting with the agent via computer system 600. In the examples illustrated in FIGS. 6A-6M, the right side illustrates a top-down schematic view of physical environment 606 that includes computer system representation 608 (e.g., representing computer system 600) and first subject representation 610 (e.g., a person interacting with computer system 600 by providing inputs, the first subject). In some embodiments, the relative positioning of computer system representation 608 and first subject representation 610 is indicative of relative physical positioning in a physical environment. The top-down schematic view includes a field-of-view of one or more cameras of computer system 600 (represented by the dotted lines casting away from computer system representation 608). The left side of FIGS. 6A-6M illustrate output of computer system 600. While FIGS. 6A-6M illustrate computer system 600 outputting particular content, it should be recognized that such content is merely for explanatory purposes and that such content can be in different forms, at different locations, at different sizes, include different content, and/or that more, fewer, and/or different content can be output in accordance with techniques described herein.

While the examples in FIGS. 6A-6M include computer system 600 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, inputs detected by computer system 600 are passive inputs that are not purposefully directed at computer system 600 by a subject (e.g., a person, an animal, an object, and/or a device). Examples of such inputs include, but are not limited to, motion of the subject through the environment, location of the subject within the environment, direction that the subject is facing and/or looking, light levels within the environment, and/or sound levels within the environment.

FIG. 6A illustrates computer system 600 displaying dreaming user interface 602 with agent representation 604, which is a visual representation of the agent. As illustrated in FIG. 6A, agent representation 604 is a circle at the bottom left quadrant of dreaming user interface 602. In some embodiments, computer system 600 displays agent representation 604 as a circle to indicate that the agent and/or computer system 600 are in a standby state (e.g., a lower power state and/or a state when computer system 600 and/or the agent are waiting to receive an input and/or notification). In some embodiments, the one or more cameras of computer system 600 are not powered while the agent and/or computer system 600 are in the standby state. In some embodiments, computer system 600 captures media at a slower rate (e.g., via the one or more cameras) when in the standby state and when not in the standby state.

In some embodiments, computer system 600 displays agent representation 604 in a different size and/or at a different location within dreaming user interface 602. For example, computer system 600 can display agent representation 604 as smaller and/or centered within dreaming user interface 602. For another example, computer system 600 can display agent representation 604 as partially off screen with only a top portion of agent representation 604 visible within dreaming user interface 602. It should be recognized that computer system 600 can display agent representation 604 in other manners to indicate that the agent and/or computer system 600 are in the standby state. For example, computer system 600 can display agent representation 604 in a different shape and/or different color, such as shaped as a moon and/or colored yellow. For another example, to indicate that the agent and/or computer system 600 is in the standby state, computer system 600 can display agent representation 604 as dimmer (e.g., less illuminated) than when computer system 600 displays agent representation 604 when the agent and/or computer system 600 is in and active (e.g., not standby) state. For another example, computer system 600 can display agent representation 604 as enlarging and shrinking to give an appearance of slow deep breaths and/or snoring. For another example, computer system 600 can display agent representation 604 with facial features that resemble sleeping, such as closed eyes and/or a relaxed mouth. It should also be recognized that computer system 600 can display dreaming user interface 602 in other manners to indicate that the agent and/or computer system 600 are in the standby state. For example, computer system 600 can display dreaming user interface 602 as dimmed (e.g., less illuminated) when the agent and/or the computer system 600 are in the standby state than when the agent and/or computer system 600 are in the active state. For another example, computer system 600 can display dreaming user interface 602 and/or other user interface objects displayed within dreaming user interface 602 as blurred.

In some embodiments, as part of displaying dreaming user interface 602, computer system 600 outputs audio corresponding to dreaming user interface 602. For example, computer system 600 can output soft music and/or nature sounds. For another example, while displaying agent representation 604 with the appearance of snoring, computer system 600 can output sounds of snoring that are synced with visual movement of agent representation 604.

At FIG. 6A, computer system 600 detects and recognizes the first subject (e.g., the first subject is known to computer system 600) within the environment (e.g., via the one or more cameras, the one or more microphones, and/or a personal device of the first subject) (e.g., as indicated by first subject representation 610 being illustrated within physical environment 606). In some embodiments, computer system 600 recognizes the first subject because the first subject has an account on computer system 600. In some embodiments, computer system 600 recognizes the first subject because of previous interactions between the first subject and computer system 600. For example, computer system 600 recognizes the first subject (e.g., via the one or more cameras and/or the one or more microphones) because of stored information, such as facial recognition and/or voice recognition, from previous interactions between the first subject and computer system 600. In some embodiments, computer system 600 recognizes the first subject via a personal device (e.g., a smart watch, a smart phone, and/or a tablet) of the first subject that is in communication with computer system 600. For example, computer system 600 recognizes the first subject because computer system 600 has access to account information located on the first subject’s smart watch.

As illustrated in FIG. 6A, in response to detecting and recognizing the first subject within the environment, computer system 600 displays music element 602a and balloon element 602b, which are both user interface elements that correspond to (e.g., are representative of previous conversations of, previous interactions of, communications sent or received by, reminders for, upcoming events of, and/or suggested content for) the first subject. For example, music element 602a can represent a recently downloaded album and balloon element 602b can represent an upcoming party.

In some embodiments, the user interface elements that correspond to the first subject (e.g., displayed by computers system 600 within dreaming user interface 602) correspond to interactions between the first subject and computer system 600. For example, music element 602a can correspond to an album recently downloaded by the first subject to computer system 600 and balloon element 602b can correspond to an event that the first subject entered into first subject’s calendar on computer system 600. In some embodiments, the user interface elements that correspond to the first subject correspond to interactions between the first subject and the agent. For example, music element 602a can correspond to an album that the first subject asked the agent to download and balloon element 602b can correspond to an upcoming birthday that the first subject asked the agent to remind them about. In some embodiments, the user interface elements that correspond to the first subject correspond to information that the agent and/or computer system 600 have access. For example, music element 602a can correspond to a newly released album of an artist that the first subject listens to that the first subject has not asked for yet, and balloon element 605b can correspond to an upcoming party that is on the first subject’s calendar but was not entered using computer system 600 (e.g., the event was entered on another computer system separate from computer system 600).

It should be recognized that user interface elements (e.g., displayed within dreaming user interface 602 that correspond to the first subject) can correspond to different interactions and/or the same interaction. For example, music element 602a and balloon element 602b can correspond to the same discussion about an upcoming party (e.g., the music and the decorations for the same party). For another example, music element 602a can correspond to an earlier request by the first subject to play that album and balloon element 602b can correspond to a different interaction where the first subject ordered balloons for the party. It should also be recognized that user interface elements that correspond to the first subject can correspond to different applications and/or the same application. For example, music element 602a and balloon element 602b can both correspond to the calendar application where music element 602a corresponds to a concert that is on the first subject’s calendar and balloon element 602b corresponds to a party on the first subject’s calendar. For another example, music element 602a can correspond to music on a music streaming application and balloon element 602b can correspond to a party invitation in an email application.

In some embodiments, computer system 600 displays agent representation 604 as interacting with the user interface elements within dreaming user interface. For example, computer system 600 can alter the appearance agent representation 604 to correspond to one or more of the user interface elements within dreaming user interface 602, such as displaying agent representation 604 as blue if one or more of the user interface elements is blue. For another example, computer system 600 can display agent representation 604 as focused towards one of the user interface elements, such as displaying agent representation 604 as smiling towards one of the user interface elements (e.g., when computer system 600 displays agent representation 604 with facial features).

In some embodiments, computer system 600 displays more or less than two user interface elements corresponding to the first subject within dreaming user interface 602. In some embodiments, computer system 600 cycles through user interface elements corresponding to the first subject within dreaming user interface 602. For example, at a time after displaying music element 602a and balloon element 602b, computer system 600 displays a user interface element representing an upcoming movie that the agent thinks the first subject would like and a user interface element representing the first subject’s new best running speed and ceases to display music element 602a and balloon element 602b (e.g., without detecting additional inputs from the first subject). For another example, computer system 600 ceases display of balloon element 602b and displays the user interface element representing the first subject’s new best running speed while continuing to display music element 602a. In some embodiments, within dreaming user interface 602, computer system 600 displays one or more user interface elements corresponding to the first subject as including text that corresponds to the user element. For example, computer system 600 can display balloon element 602b as having text referencing the date of the party. For another example, computer system 600 can display music element 602a with text of the title of the downloaded album.

In some embodiments, computer system 600 displays the user interface elements that correspond to the first subject while not displaying agent representation 604 within dreaming user interface 602. For example, computer system 600 displays music element 602a and balloon element 602b and does not display agent representation 604 within dreaming user interface 602. In some embodiments, computer system 600 displays a background within dreaming user interface 602 that is preset by the first subject. For example, computers system 600 displays an image of a university logo that the first subject preset as the background for dreaming user interface 602. In some embodiments, computer system 600 alters the background within dreaming user interface 602 based on which user interfaces corresponding to the first subject that computer system 600 is displaying within dreaming user interface 602. For example, in response to displaying music element 602a within dreaming user interface 602, computer system 600 can display album art for the downloaded album as the background for dreaming user interface 602.

In some embodiments, in response to detecting the first subject within the environment and/or the first subject walking toward computer system 600, computer system 600 transitions from an off state to an on state. In some embodiments in response to detecting the first subject within the environment, computer system 600 transitions from an off state to the standby state and displays dreaming user interface 602. In some embodiments, computer system 600 does not display user interface elements (e.g., within dreaming user interface 602) corresponding to a particular subject (e.g., the first subject) until computer system 600 detects and recognizes the particular subject within the environment. For example, computer system 600 displays agent representation 604 and no other user interface elements within dreaming user interface 602 before the first subject is detected and recognized within the environment. For another example, before detecting the first subject within the environment, computer system 600 displays generic (e.g., not corresponding to a particular user) user interface elements within dreaming user interface 602 such as a user interface element corresponding to the current weather and a user interface element corresponding to recent news headlines.

In some embodiments, while in the standby state and in response to detecting the first subject within the environment, computer system 600 does not physically move a portion (e.g., including one or more input devices and/or one or more output devices) of computer system 600 to keep the first subject within the field-of-view of computer system 600. In some embodiments, while in the standby state and in response to detecting the first subject within the environment, computer system 600 physically moves the portion of computer system 600 to keep the first subject centered within the field-of-view of computer system 600. In some embodiments, while in the standby state and in response to detecting the first subject within the environment, computer system 600 physically moves the portion of computer system 600 to keep the first subject within the field-of-view of computer system 600 without keeping the first subject centered within the field-of-view of computer system 600 (e.g., moving the portion of computer system 600 to keep the first subject anywhere within the field-of-view of computer system 600). For example, computer system 600 can move the portion of computer system 600 until dreaming user interface 602 is visible to the first subject without centering the first subject within the field-of-view of computer system 600.

At FIG. 6A, computer system 600 detects input 605a (e.g., a verbal input) from the first subject corresponding to the first subject asking computer system 600 and/or the agent for suggestions of things to do with friends. It should be recognized that input 605a can be other types of inputs other than a verbal input, such as an air-gesture input and/or a typing input (e.g., via a physical or virtual keyboard). It should also be recognized that input 605a can correspond to other types of requests such as dinner options, job opportunities, conversation starters, shopping suggestions, and/or vacation ideas.

In some embodiments, if computer system 600 does not physically move the portion of computer system 600 to keep the first subject centered within the field-of-view of computer system 600 when in the standby state, in response to detecting input 605a, computer system 600 moves the portion of computer system 600 to center the first subject within the field-of-view of computer system 600. In some embodiments, in response to detecting input 605a, if computer system 600 does not detect the first subject within the field-of-view of computer system 600, computer system 600 physically moves the portion of computer system 600 to place the first subject within the field-of-view of computer system 600 (e.g., anywhere within the field-of-view of computer system 600). At FIG. 6A, computer system 600 detects that the first subject is within the field-of-view of computer system 600 and does not physically move the portion of computer system 600.

At FIG. 6B, in response to detecting input 605a, computer system 600 transitions the agent and/or computer system 600 from the standby state to the active state. As illustrated in FIG. 6B, in response to detecting input 605a, computer system 600 displays suggestion user interface 614 and ceases display of dreaming user interface 602. In response to detecting input 605a, computer system 600 displays suggestion user interface 614 as including biking suggestion indicator 614a, picnic suggestion indicator 614b, and tennis suggestion indicator 614c which each correspond to a different suggestion corresponding to the request for suggestions of things to do with friends (e.g., input 605a). As illustrated in FIG. 6B, computer system 600 displays agent representation 604 in the bottom right quadrant of suggestion user interface 614 and as a different shape (e.g., a triangle) than how computer system 600 displays agent representation 604 within dreaming user interface 602 (e.g., a circle) in FIG. 6A. In some embodiments, computer system 600 displays an animation of agent representation 604 changing shape and moving from the bottom left quadrant to the bottom right quadrant of suggestion user interface 614. It should be recognized that computer system 600 can display agent representation 604 at a different size and/or a different location within suggestion user interface 614. For example, computer system 600 can display agent representation 604 as smaller to make room for more suggestion indicators. It should be recognized that the suggestions and suggestion indicators discussed here are for demonstrative purposes and that computer system 600 can output different content corresponding to different suggestions in response to detecting input 605a.

At FIG. 6B, computer system 600 ceases display of agent representation 604 as a circle to indicate that the agent and/or computer system 600 have transitioned to the active state from the standby state. As illustrated in FIG. 6B, computer system 600 displays agent representation 604 as a triangle as part of indicating that the agent and/or computer system 600 are in the active state. It should be recognized that computer system 600 can display agent representation 604 in other manners to indicate that the agent and/or computer system 600 are in the active state. For example, computer system 600 can display agent representation 604 brighter (e.g., more illuminated) when in the active state than when in the standby state. For another example, when computer system 600 displays agent representation 604 with facial features, computer system 600 can display agent representation 604 with open eyes that appear focused on the first subject. It should also be recognized that computer system 600 can display suggestion user interface 614 in a different manner to indicate that the agent and/or computer system 600 are in the active state. For example, computer system 600 can display suggestion user interface 614 as brighter when the agent and/or computer system 600 are in the active state than when the agent and/or computer system 600 are in the standby state.

In some embodiments, computer system 600 displays an animation of agent representation 604 transitioning from indicating the standby state to indicating the active state. For example, computer system 600 displays an animation of agent representation 604 shaking while becoming less round while transitioning to appear as a triangle. For another example, if computer system 600 is displaying agent representation 604 as appearing to be sleeping to indicate the standby state, computer system 600 can animate agent representation 604 as waking up as part of transitioning to displaying agent representation 604 as indicating the active state. In some embodiments, computer system 600 displays suggestion user interface 614 as brighter than dreaming user interface 602 to indicate that the agent and/or computer system 600 have transitioned from the standby state to the active state.

At FIG. 6B, computer system 600 outputs content corresponding to the suggestion that corresponds to biking suggestion indicator 614a. As part of outputting content corresponding to the suggestion that corresponds to biking suggestion indicator 614a, computer system 600 outputs audio content 616 to inform the first subject that there is a biking trail. As illustrated in FIG. 6B, as part of outputting content corresponding to the suggestion that corresponds to biking suggestion indicator 614a, computer system 600 visually emphasizes biking suggestion indicator 614a by displaying agent representation 604 as appearing focused towards biking suggestion indicator 614a and displaying biking suggestion indicator 614a as larger than the other suggestion indicators (e.g., picnic suggestion indicator 614b and/or tennis suggestion indicator 614c).

As illustrated in FIG. 6B, computer system 600 displays agent representation 604 as appearing focused towards biking suggestion indicator 614a by displaying agent representation 604 as a triangle pointing in the direction of biking suggestion indicator 614a. It should be recognized that computer system 600 can display agent representation 604 in a different manner to appear focused towards biking suggestion indicator 614a. For example, computer system 600 can move agent representation 604 closer to biking suggestion indicator 614a. For another example, if computer system 600 displays agent representation 604 as having facial features, computer system 600 can display agent representation 604 as looking towards biking suggestion indicator 614a.

In some embodiments, in response to detecting input 605a, computer system 600 displays agent representation 604 within suggestion user interface 614 before displaying biking suggestion indicator 614a, picnic suggestion indicator 614b, and/or tennis suggestion indicator 614c. In some embodiments, when computer system 600 displays agent representation 604 within suggestion user interface 614 before displaying the suggestion indicators, computer system 600 displays agent representation 604 as a shape other than a triangle before displaying agent representation 604 as a triangle as part of outputting content corresponding to the suggestion that corresponds to biking suggestion indicator 614a as illustrated in FIG. 6B. For example, computer system 600 can display agent representation 604 as a square since computer system 600 ceases display of agent representation 604 as a circle when indicating that the agent and/or computer system 600 have transitioned to the active state from the standby state.

In some embodiments, in response to detecting input 605a while displaying agent representation 604 and before displaying the suggestion indicators, computer system 600 displays agent representation 604 in a manner that gives the appearance that the request within input 605a is being processed by the agent. For example, computer system 600 can animate agent representation 604 as cycling through several colors to appear to be processing the request within input 605a. For another example, if computer system 600 is displaying agent representation 604 with facial features, computer system 600 can animate agent representation 604 to appear to be thinking. In some embodiments, the request within input 605a is processed by the agent. In some embodiments, the request within input 605a is processed by computer system 600. In some embodiments, the request within input 605a is processed by another computer system in communication with computer system 600 and/or the agent.

It should be understood that although the above describes displaying the agent representation in a manner that gives an appearance that the request is being processed before displaying the suggestion indicators, the timing of this appearance may be at a different time. For example, while ceasing display of dreaming user interface 602 and displaying suggestion user interface 614, computer system 600 may display agent representation 604 in the manner that gives the appearance that the request is being processed. In another example, after ceasing display of the dreaming user interface 602 and before displaying suggestion user interface 614, computer system 600 can displays a separate user interface during the processing of input 605a.

At FIG. 6C, at a time after outputting content corresponding to the suggestion that corresponds to biking suggestion indicator 614a, computer system 600 outputs content corresponding to the suggestion that corresponds to tennis suggestion indicator 614c (e.g., without detecting additional inputs from the first subject). As part of outputting content corresponding to the suggestion that corresponds to tennis suggestion indicator 614c, computer system 600 outputs audio content 618 to inform the first subject that tennis courts are open today. As illustrated in FIG. 6C, as part of outputting content corresponding to the suggestion that corresponds to tennis suggestion indicator 614c, computer system 600 emphasizes tennis suggestion indicator 614c by shrinking biking suggestion indicator 614a and enlarging tennis suggestion indicator 614c so that tennis suggestion indicator 614c is larger than biking suggestion indicator 614a and/or picnic suggestion indicator 614b. Also illustrated in FIG. 6C, computer system 600 illustrates agent representation 604 as appearing focused towards tennis suggestion indicator 614c.

At FIG. 6D, at a time after outputting content corresponding to the suggestion that corresponds to tennis suggestion indicator 614c, computer system 600 outputs content corresponding to the suggestion that corresponds to picnic suggestion indicator 614b (e.g., without detecting additional inputs from the first subject). As part of outputting content corresponding to the suggestion that corresponds to picnic suggestion indicator 614b, computer system 600 outputs audio content 620 to inform the first subject that they could have a picnic. As illustrated in FIG. 6D, as part of outputting content corresponding to the suggestion that corresponds to picnic suggestion indicator 614b, computer system 600 emphasizes picnic suggestion indicator 614b by shrinking tennis suggestion indicator 614c and enlarging picnic suggestion indicator 614b so that picnic suggestion indicator is larger than biking suggestion indicator 614a and/or tennis suggestion indicator 614c. Also illustrated in FIG. 6D, computer system 600 illustrates agent representation 604 as appearing focused towards picnic suggestion indicator 614b.

In FIGS. 6B-6E, computer system 600 displays suggestion user interface 614 as including three suggestion indicators corresponding to three suggestions. In some embodiments, computer system 600 displays more or less than three suggestion indicators within suggestion user interface 614, depending on the number of suggestions computer system 600 has content for to output. Suggestion indicators correspond to content from applications different than the agent that the agent has access to. In some embodiments, suggestion indicators correspond to different content from the same application. For example, biking suggestion indicator 614a and picnic suggestion indicator 614b can correspond to content from a map application. In some embodiments, suggestion indicators correspond to different content from different applications. For example, biking suggestion indicator 614a can correspond to content from a map application and tennis suggestion indicator 614c can correspond to content from a social media application.

In some embodiments, computer system 600 displays the suggestion indicators one at a time instead of all at one. For example, while outputting content corresponding to the suggestion that correspond tennis suggestion indicator 614c, computer system 600 displays tennis suggestion indicator 614c and computer system 600 replaces tennis suggestion indicator 614c with picnic suggestion indicator 614b when computer system 600 switches to outputting content corresponding to the suggestion that corresponds to picnic suggestion indicator 614b.

In some embodiments, computer system 600 adds suggestion indicators to suggestion user interface 614 as computer system 600 outputs content corresponding to suggestions that correspond to those suggestion indicators. For example, computer system 600 displays biking suggestion indicator 614a as part of outputting content corresponding to the suggestion that corresponds to biking suggestion indicator 614a, then computer system 600 displays tennis suggestion indicator 614c as part of outputting content correspond to the suggestion that corresponds to tennis suggestion indicator 614c without ceasing display of biking suggestion indicator 614a. In some embodiments, when computer system 600 adds suggestion indicators to suggestion user interface 614 as computer system 600 outputs content corresponding to suggestions that correspond to those suggestion indicators, computer system 600 displays each suggestion indicator in a different location within suggestion user interface 614. For example, computer system 600 displays biking suggestion indicator 614a in the top left quadrant of suggestion user interface 614 and then displays tennis suggestion indicator 614c in the bottom left quadrant of suggestion user interface 614. In some embodiments, when computer system 600 adds suggestion indicators to suggestion user interface 614 as computer system 600 outputs content corresponding to suggestions that correspond to those suggestion indicators, computer system 600 initially displays each suggestion indicator at a default location within suggestion user interface 614 before moving them to a new location within suggestion user interface 614. For example, computer system 600 displays biking suggestion indicator 614a at the center of suggestion user interface 614 and then moves biking suggestion indicator 614a to the upper left quadrant of suggestion user interface 614 to make room to display tennis suggestion indicator 614c at the center of suggestion user interface 614. In some embodiments, when computer system 600 adds suggestion indicator to suggestion user interface 614 as computer system 600 outputs content corresponding to suggestions that correspond to those suggestion indicators, computer system 600 displays suggestion indicators as larger when first displayed within suggestion user interface 614 and smaller when computer system 600 displays a new suggestion indicator. For example, computer system 600 displays tennis suggestion indicator 614c as occupying twenty-five percent of suggestion user interface 614 and, in response to displaying picnic suggestion indicator 614b, computer system 600 decreases the size of tennis suggestion indicator 614c to fifteen percent of suggestion user interface 614.

In some embodiments, computer system 600 displays an animation of agent representation 604 transitioning from appearing focused towards one suggestion indicator to appearing focused towards another suggestion indicator. For example, when computer system 600 displays agent representation 604 as a triangle, computer system 600 rotates the displayed triangle form of agent representation 604 from pointing at biking suggestion indicator 614a to pointing at tennis suggestion indicator 614c. For another example, when computer system displays agent representation 604 with facial features, computer system 600 moves the eyes of agent representation 604 from appearing focused toward tennis suggestion indicator 614c to appearing focus toward picnic suggestion indicator 614b.

In some embodiments, computer system 600 displays agent representation 604 in a different manner depending on the suggestion indicator that agent representation 604 appears to be focused towards. For example, computer system 600 can display agent representation 604 as a bike while agent representation 604 is focused towards biking suggestion indicator 614a and display agent representation 64 as a picnic basket while agent representation 604 is focused towards picnic suggestion indicator 614b. For another example, when computer system 600 displays agent representation 604 as having facial features, computer system 600 can display agent representation 604 as wearing a biking helmet while agent representation 604 is focused towards biking suggestion indicator 614a and display agent representation 604 as eating a sandwich while agent representation 604 is focused toward picnic suggestion indicator 614b.

In some embodiments, computer system 600 displays agent representation 604 as appearing focused in different manners for each suggestion indicator. For example, computer system 600 can display agent representation 604 as an animation of a ball bouncing toward tennis suggestion indicator 614c when focused towards tennis suggestion indicator 614c and computer system 600 can display agent representation 604 as an arrow pointing towards picnic suggestion indicator 614b when focused towards picnic suggestion indicator 614b. In some embodiments, computer system 600 does not display agent representation 604 as focused towards a suggestion indicator. For example, computer system 600 displays agent representation 604 as square while outputting content corresponding to suggestions that correspond to the suggestion indicators. For another example, when computer system 600 displays agent representation 604 as having facial features, computer system 600 displays agent representation 604 as appearing to look toward the first subject while computer system 600 outputs content corresponding to suggestions that correspond to the suggestion indicators.

In some embodiments, computer system 600 visually emphasizes suggestion indicators in a manner other than displaying the emphasized suggestion indicator as larger than the other suggestion indicators. For example, computer system 600 displays the emphasized suggestion indicator with a border and displays the other non-emphasized suggestion indicators without borders. For another example, computer system 600 animates the emphasized suggestion indicator and does not animate the non-emphasized suggestion indicators. In some embodiments, computer system 600 visually emphasizes each suggestion indicator in a different manner. For example, computer system 600 visually emphasizes biking suggestion indicator 614a by enlarging biking suggestion indicator 614a and computer system 600 visually emphasizes picnic suggestion indicator 614b by enhancing the colors of picnic suggestion indicator 614b.

In some embodiments, computer system 600 displays one or more suggestion indicators with text that corresponds to that suggestion indicator. For example, computer system 600 displays tennis suggestion indicator 614c with text indicating the hours of operation of a tennis complex that is open and displays picnic suggestion indicator 614b with text indicating a name of a nearby park that has a picnic area. In some embodiments, computer system 600 displays a suggestion indicator with text as part of visually emphasizing that suggestion indicator. For example, computer system 600 displays picnic suggestion indicator 614b with text of the name of the nearby park while computer system 600 visually emphasizes picnic suggestion indicator 614b and displays picnic suggestion indicator 614b without text while computer system 600 is not visually emphasizing picnic suggestion indicator 614b.

In some embodiments, computer system 600 displays a background within suggestion user interface 614 that is preset by the first subject. For example, computer system 600 can display suggestion user interface 614 with an image of a beach preselected by the first subject as the background of suggestion user interface 614. In some embodiments computer system 600 alters the displayed background with suggestion user interface 614 based on which suggestion computer system 600 is outputting corresponding content for. For example, computer system 600 displays suggestion user interface 614 with an image of a picnic while outputting content corresponding to the suggestion that corresponds to picnic suggestion indicator 614b and displays suggestion user interface 614 with an image of tennis racquet while outputting content corresponding to the suggestion that corresponds to tennis suggestion indicator 614c.

As illustrated in FIG. 6E, at a time after outputting content corresponding to the suggestion that corresponds to picnic suggestion indicator 614b, in response to completing output of content corresponding to the suggestions, computer system 600 displays agent representation 604 not as focused on one of the suggestion indicators (e.g., biking suggestion indicator 614a, tennis suggestion indicator 614c, and/or picnic suggestion indicator 614b). In some embodiments, if computer system 600 moves agent representation 604 towards suggestion indicators as part of displaying agent representation 604 as focused towards those suggestion indicators, at a time after displaying agent representation 604 as focused towards picnic suggestion indicator 614b, computer system 600 displays agent representation 604 at a default location, which is the bottom right quadrant of suggestion user interface 614 in this scenario.

Also illustrated in FIG. 6E, in response to completing output of content corresponding to the suggestions, computer system 600 displays each of the suggestion indicators at the same size (e.g., computer system 600 does not display any of the suggestion indicators as emphasized). In some embodiments, computer system 600 displays each suggestion indicator as the same size by increasing the size of biking suggestion indicator 614a and tennis suggestion indicator 614c until they are the same size as picnic suggestion indicator 614b. In some embodiments, computer system 600 displays each suggestion indicator as the same size by decreasing the size of picnic suggestion indicator 614b until it is the same size as biking suggestion indicator 614a and tennis suggestion indicator 614c. In some embodiments, computer system 600 displays each suggestion indicator as the same size by shrinking picnic suggestion indicator 614b while increasing the size of biking suggestion indicator 614a and tennis suggestion indicator 614c until the suggestions indicators are the same size.

At FIG. 6E, computer system 600 detects input 605e (e.g., a verbal input) from the first subject corresponding to the first subject informing the agent and/or computer system 600 that the first subject does not want to do outside activities (e.g., it is too hot outside) (e.g., the first subject is rejecting the suggestions output by computer system 600). It should be recognized that input 605e can be other types of inputs other than a verbal input, such as an air-gesture input and/or a physical input. In some embodiments, input 605e corresponds to the first subject rejecting one or more (e.g., a few) of the suggestions output by computer system 600 instead of all of the current suggestions output by computer system 600. For example, input 605e can correspond to the first subject rejecting the suggestion that corresponds to biking suggestion indicator 614a by informing the agent that the first subject’s bike has a flat tire. For another example, input 605e can correspond to the first subject rejecting the suggestions that correspond to biking suggestion indicator 614a and tennis suggestion indicator 614c by informing the agent that the first subject does not want to do any activities that require special equipment.

At FIGS. 6F-6I, in response to detecting input 605e (e.g., in response to the first subject rejecting the suggestions output by computer system 600), computer system 600 physically moves the portion of computer system 600 in a manner that shakes the display on which computer system 600 displays suggestion user interface 614. While computer system 600 physically moves the portion of computer system 600 in response to detecting input 605e, computer system 600 moves agent representation 604 within suggestion user interface 614 in a manner that mimics the physical movements of the portion of computer system 600 (e.g., shaking). Also while computer system 600 moves the portion of computer system 600 in response to detecting input 605e, computer system 600 animates the suggestion indicators (e.g., biking suggestion indicator 614a, tennis suggestion indicator 614c, and/or picnic suggestion indicator614b) to appear to fall off the displayed suggestion user interface 614 until computer system 600 is no longer displaying the suggestion indicators. At FIGS. 6F-6G, the dotted boundary of neutral position 622 indicates a position of the portion of computer system 600 when computer system is not moving computer system 600 (e.g., when the portion of computer system 600 is in a neutral and/or default position).

At FIG. 6F, in response to detecting input 605e, computer system 600 moves and twists (e.g., rotate along a vertical plane) the portion of computer system 600 to the right (e.g., as indicated by the position of computer system 600 in comparison to neutral position 622 and by computer system representation 608 being rotated in comparison to the position of computer system representation 608 in FIGS. 6A-6E) (e.g., moves in a first direction). As illustrated in FIG. 6F, computer system 600 displays agent representation 604 as rotated to the right as part of computer system 600 moving agent representation 604 in a manner that mimics of the motion of the portion of computer system 600. At FIG. 6F, computer system 600 begins animating picnic suggestion indicator 614b as falling off the edge of suggestion user interface 614. As illustrated in FIG. 6F, as part of computer system 600 animating picnic suggestion indicator 614b as falling off the edge of suggestion user interface 614, computer system 600 displays picnic suggestion indicator 614b as rotated towards the right edge of suggestion user interface 614.

At FIG. 6G, at a time after computer system 600 moves the portion of computer system 600 to the right, computer system 600 rotates and twists the portion of computer system 600 to the left, (e.g., as indicated by the position of computer system 600 in comparison to neutral position 622 and computer system representation 608 being rotated in the opposite direction of how computer system representation 608 is illustrated in FIG. 6F) (e.g., moves in a second direction). As illustrated in FIG. 6G, computer system 600 displays agent representation 604 as rotated to the left as part of computer system 600 moving agent representation 604 in a manner that mimics of the motion of the portion of computer system 600.

At FIG. 6G, computer system 600 begins animating biking suggestion indicator 614a and tennis suggestion indicator 614c as falling off the left edge of suggestion user interface 614. As illustrated in FIG. 6G, as part of computer system 600 animating biking suggestion indicator 614a and tennis suggestion indicator 614c as falling off the left edge of suggestion user interface 614, computer system 600 displays biking suggestion indicator 614a and tennis suggestion indicator 614c as rotated towards the left edge of suggestion user interface 614. At FIG. 6G, computer system 600 continues to animate picnic suggestion indicator 614b as falling off the right edge of suggestion user interface 614. As illustrated in FIG. 6G, as part of animating picnic suggestion indicator 614b as falling off the right edge of suggestion user interface 614, computer system 600 displays picnic suggestion indicator 614b as partially off the edge of suggestion user interface 614 with the top right corner of picnic suggestion indicator 614b no longer displayed within suggestion user interface 614.

At FIG. 6H, computer system 600 moves the portion of computer system 600 back to the position it was in before moving the portion of computer system 600 to the right in FIG. 6F (e.g., the same position as illustrated in FIG. 6E). This return to a previous position of the portion of computer system 600 is also indicated by the position of computer system representation 608 being in the same position within physical environment 606 in FIG. 6H as computer system representation 608 is within physical environment 606 in FIG. 6F. At FIG. 6H, computer system 600 ceases moving the portion of computer system 600. As illustrated in FIG. 6H, computer system 600 displays agent representation 604 in the position that computer system 600 displayed agent representation 604 before moving agent representation to the right in FIG. 6F (e.g., the same position as illustrated in FIG. 6E).

At FIG. 6H, computer system 600 continues to animate picnic suggestion indicator 614b as falling off the right edge of suggestion user interface 614 and continues to animate biking suggestion indicator 614a and tennis suggestion indicator 614c as falling of the left side of suggestion user interface 614. As illustrated in FIG. 6H, as part of animating the suggestion indicators (e.g., biking suggestion indicator 614a, picnic suggestion indicator 614b, and/or tennis suggestion indicator 614c) as falling off the edges of suggestion user interface 614, computer system 600 displays the suggestion indicators as farther off the edges of suggestion user interface 614 (e.g., less of the suggestion indicators are displayed) than computer system 600 displays the suggestion indicators in FIG. 6G.

It should be recognized that computer system 600 can animate the suggestion indicators (e.g., biking suggestion indicator 614a, tennis suggestion indicator 614c, and/or picnic suggestion indicator 614b) as falling off the edge of suggestion user interface 614 in a manner other than the one illustrated in FIGS. 6F-6H. In some embodiments, computer system 600 animates the suggestion indicators as falling off in a different order than the order illustrated within FIGS. 6F-6H (e.g., picnic suggestion indicator 614b, followed by biking suggestion indicator 614a and tennis suggestion indicator 614c). For example, computer system 600 can animate (e.g., animate to appear to fall of suggestion user interface 614) biking suggestion indicator 614a first, followed by animating picnic suggestion indicator 614b, and then tennis suggestion indicator 614c. In some embodiments, computer system 600 animates all of the suggestion indicators as falling off suggestion user interface 614 simultaneously. For example, instead of computer system 600 initiating animating only picnic suggestion indicator 614b as falling off the edge of suggestion user interface 614 at FIG. 6F, computer system 600 initiates animating all of the suggestion indicators as falling off the edge of suggestion user interface 614 simultaneously. In some embodiments, computer system 600 animates each suggestion indicator as falling off suggestion user interface 614 at the same speed (e.g., each suggestion indicator travels the same amount of distance across suggestion user interface 614 within a given amount of time). In some embodiments computer system 600 animates different suggestion indicators as falling of suggestion user interface 614 at different speeds. For example, computer system 600 can animate tennis suggestion indicator 614c as falling faster than picnic suggestion indicator 614b so that each suggestion indicator ceases to be visible at the same time.

In some embodiments, computer system 600 animates the suggestion indicators (e.g., to cease display of suggestion indicators within suggestion user interface 614) in a manner other than animating the suggestion indicators as falling off the edges of suggestion user interface 614. For example, computer system 600 can animate the suggestion indicators as floating away out of the top of suggestion user interface 614. For another example, computer system 600 can spin the suggestion indicators to and off the sides of suggestion user interface 614 in a manner resembling thrown discs.

It should be recognized that, in response to detecting input 605e (e.g., in response to the first subject rejecting the suggestions output by computer system 600), computer system 600 can move the portion of computer system 600 in a different manner than the one illustrated in FIGS. 6F-6I. For example, computer system 600 tilts the portion of computer system 600 down then up, so that suggestion user interface 614 faces the floor before again facing the first subject. In some embodiments computer system 600 does not move the portion of computer system 600 in response to detecting input 605e.

At FIG. 6I, computers system 600 has completed animating the suggestion indicators as falling off the sides of suggestion user interface 614 and no longer displays portions of the suggestion indicators within suggestion user interface 614. In some embodiments, while computer system 600 is animating the suggestion indicators as falling off the edges of suggestion user interface 614, computer system 600 outputs haptic feedback. For example, computer system 600 can vibrate while computer system 600 animates the suggestion indicators as falling off the edges of suggestion user interface 614. For another example, computer system 600 can vibrate as computer system 600 reaches the far left and/or far right of the movements described in FIGS. 6F-6G. In some embodiments, while computer system 600 is animating the suggestion indicators as falling off the edges of suggestion user interface 614, computer system 600 outputs audio content. For example, computer system 600 can output the sounds of objects falling. For another example, computer system 600 can output the sounds of a rattle.

In some embodiments, in response to detecting an input from the first subject and/or a detected state of the first subject, a determination is made that the first subject no longer wants suggestions from the agent. For example, in response to detecting the first subject walking away from computer system 600, a determination is made that the first subject no longer wants suggestions from the agent. For another example, in response to detecting a verbal input from the first subject that corresponds to the first subject saying that the agent has made enough suggestions, a determination is made that the first subject no longer wants suggestions from the agent. In some embodiments, in response to a determination that the first subject no longer wants suggestions from the agent, computer system 600 ceases display of suggestion user interface 614 and displays a different user interface than suggestion user interface 614 without continuing as described in FIGS. 6J-6L. For example, in response to a determination that the first subject no longer wants suggestions from the agent, computer system 600 displays a home screen user interface

As illustrated in FIG. 6J, in response to detecting input 605e, computers system 600 displays three new suggestion indicators, which are book suggestion indicator 614d, bowling suggestion indicator 614e, and museum suggestion indicator 614f. At FIG. 6J, in response to detecting the content of input 605e indicating that the first subject does not want to do outside activities, the suggestions corresponding to the new suggestion indicators are all indoor activities. Also at FIG. 6J, computer system 600 outputs content corresponding to the suggestion that corresponds to book suggestion indicator 614d. As part of outputting content corresponding to the suggestion that corresponds to book suggestion indicator 614d, computer system 600 outputs audio content 624 to inform the first subject that the library is having a book fair. As illustrated in FIG. 6J, as part of outputting content corresponding to the suggestion that corresponds to book suggestion indicator 614d, computer system 600 visually emphasizes book suggestion indicator 614d by displaying agent representation 604 as appearing focused towards book suggestion indicator 614d and displaying book suggestion indicator 614d as larger than the other suggestion indicators (e.g., bowling suggestion indicator 614e and/or museum suggestion indicator 614f).

At FIG. 6K, computer system 600 detects input 605k (e.g., a verbal input) corresponding to the first subject liking (e.g., agreeing to) the suggestion corresponding to book suggestion indicator 614d. As illustrated in FIG. 6K, in response to detecting input 605k, computer system 600 displays agent representation 604 as a square and ceases displaying agent representation 604 as a triangle focused towards book suggestion indicator 614d. In some embodiments, computer system 600 displays agent representation 604 as a square in response to detecting input 605k to indicate to the first subject that the agent and/or computer system 600 is listening to what the first subject is saying. For example, in response to detecting input 605k, computer system 600 ceases display of suggestions user interface 614, and displays a different user interface without the suggestion indicators that includes displaying agent representation 604 as a square to indicate agent representation 604 is listening. In this example, after detecting the end of input 605k, computer system 600 maintains agent representation 604 as a square.

As illustrated in FIG. 6K, in response to detecting input 605k, computer system 600 continues to display book suggestion indicator 614d as visually emphasized. In some embodiments, in response to detecting input 605k, computer system 600 increases the visual emphasis of book suggestion indicator 614d. For example, computer system 600 increases the size of book suggestion indicator 614d. For another example, computer system 600 animates book suggestion indicator 614d. As another example, computer system 600 continues to display book suggestion indicator 614d while ceasing display of bowling suggestion indicator 614e and museum suggestion indicator 614f. In some embodiments, if computer system 600 is displaying another suggestion indicator (e.g., bowling suggestion indicator 614e or museum suggestion indicator 614f) as visually emphasized (e.g., displayed as larger and agent representation 604 is displayed as focused towards the suggestion indicator), in response to detecting input 605k, computer system 600 visually enhances book suggestion indicator 614d, which includes computer system 600 displaying book suggestion indicator 614d as larger.

In some embodiments, in response to detecting input 605k, computer system 600 outputs additional content corresponding to the suggestion that corresponds to book suggestion indicator 614d. For example, computer system 600 displays the times that the book fair is open. For another example, computer system 600 outputs audio to inform the first subject that proceeds from the bookfair go towards supporting the library system.

In some embodiments, at a time after detecting input 605k, computer system 600 outputs content corresponding to bowling suggestion indicator 614e and/or museum suggestion indicator 614f in a manner similar to how computer system 600 output content corresponding to picnic suggestion indicator 6141b and tennis suggestion indicator 614c in FIGS. 6C-6D. In some embodiments, at a time after and in response to detecting input 605k, computer system 600 ceases display of book suggestion indicator 614d, bowling suggestion indicator 614e, and/or museum suggestion indicator 614f.

In some embodiments, in response to detecting input 605e corresponding to the first subject rejecting some but not all of the suggestions output by computer system 600, computer system 600 moves the portion of computer system 600 and agent representation 604 as described above in FIGS. 6F-6I and animates the suggestion indicators that correspond to rejected suggestions as falling off the edge of suggestion user interface 614 while maintaining display of the suggestion indicators that correspond to non-rejected suggestions. For example, in response to detecting input 605e as rejecting activities that require food, computer system 600 moves the portion of computer system 600 and agent representation 604 as described with respect to FIGS. 6F-6I while animating picnic suggestion indicator 614b as falling off the right edge of suggestion user interface 614 and while maintaining display of biking suggestion indicator 614a and tennis suggestion indicator 614c. In some embodiments, in response to detecting input 605e corresponding to the first subject rejecting some but not all of the suggestions output by computer system 600, computer system 600 replaces the suggestion indicators that correspond to rejected suggestions with suggestion indicators that correspond to new suggestions while maintaining display of the suggestion indicators that correspond to non-rejected suggestions.

As illustrated in FIG. 6L, at a time after detecting input 605k, computer system 600 ceases display of user interface 614 and displays dreaming user interface 602 as including book element 602c and balloon element 602b and not including music element 602a and ceases display of user interface 614. At FIG. 6L, computer system 600 displays book element 602c within dreaming user interface 602 because book element 602c corresponds to the interaction between the agent and the first subject that is described above with respect to FIGS. 6J-K.

At FIG. 6M, at a time after displaying dreaming user interface 602 as including book element 602c, computer system 600 detects a second subject and not the first subject within the environment (e.g., as indicated by second subject representation 630 being illustrated within physical environment 606 and first subject representation 610 not being illustrated within physical environment 606) and recognizes the second subject. As illustrated in FIG. 6M, computer system 600 is displaying dreaming user interface 602 and, in response to detecting the second subject (e.g., and not the first subject), computer system 600 displays dreaming user interface 602 with concert element 602e and countdown element 602d. Please note that since computer system 600 displays user interfaced objects within dream user interface 602 that correspond to (e.g., are representative of previous conversations of, previous interactions of, communications sent or received by, reminders for, upcoming events of, and/or suggested content for) a detected subject, computer system 600 displays different user interface elements depending on which subject computer system 600 detected within the environment. Because of this, computer system 600 displays different user interface objects within dreaming user interface 602 when detecting the first subject (e.g., as illustrated in FIG. 6A and FIG. 6L) than when detecting the second subject (e.g., as illustrated in FIG. 6M).

In some embodiments computer system 600 detects a third subject within the environments and does not recognize (e.g., the third subject is not known to computer system 600) the third subject. For example, computer system 600 detects the third subject but the third subject does not have an account on computer system 600. For another example, this is the first interaction between the third subject and computer system 600 (e.g., there are not previous interactions between the other subject and computer system 600). In some embodiments, in response to detecting the third subject within the environment while not recognizing the third subject, computer system 600 displays agent representation 604 and no other user interface elements within dreaming user interface 602.

In some embodiments, in response to detecting the third subject within the environment while not recognizing the third subject, computer system 600 displays dreaming user interface 602 with agent representation 604 and user interface elements that correspond to public information. For example, in response to detecting the third subject within the environment while not recognizing the third subject, computer system 600 displays dreaming user interface 602 with agent representation 604 and user interface elements that correspond to the weather and/or current events. In some embodiments, in response to detecting the third subject within the environment while not recognizing the third subject, computer system 600 displays a user interface other than dreaming user interface 302. For example, in response to detecting the third subject within the environment while not recognizing the third subject, computer system 600 can display a clock user interface.

In some embodiments, computer system 600 detects and recognizes multiple subjects (e.g., the first subject and the second subject) within the environment at the same time and, in response, computer system 600 displays a combination of user interface elements that correspond to each of the detected known subjects. For example, in response to detecting and recognizing the first subject and the second subject while displaying dreaming user interface 602, computer system 600 displays balloon element 602b (e.g., which corresponds to the first subject) and concert element 602e (e.g., which corresponds to the second subject). In some embodiments, when computer system 600 detects and recognizes multiple subjects within the environment, computer system 600 displays user interface elements that correspond to the subject that is first detected by computer system 600. In some embodiments, when computer system 600 detects and recognizes multiple subjects within the environment, computer system 600 displays user interface elements that correspond to the subject with the highest permission levels within computers system 600. In some embodiments, when computer system 600 detects and recognizes multiple subjects within the environment, computer system 600 displays user interface elements that do not correspond to a particular subject within the environment (e.g., similar to the response described above in relation to computer system 600 detecting and not recognizing the third subject within the environment).

FIG. 7 is a flow diagram illustrating a process (e.g., process 700) for emphasizing content in accordance with some embodiments. Some operations in process 700 are, optionally, combined, the orders of some operations are, optionally, changed, and some operations are, optionally, omitted.

As described below, process 700 provides an intuitive way for emphasizing content. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication with (and/or includes) one or more input devices (e.g., as discussed above with respect to FIG. 6A) (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface) and one or more display components (e.g., as discussed above with respect to FIG. 6A) (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, an electronic device, and/or a personal computing device.

The computer system detects (702), via the one or more input devices, an input (e.g., 605a, 605e, and/or 605k) (e.g., a tap input and/or a voice input) corresponding to a software agent (e.g., as described above with respect to FIG. 5). In some embodiments, the input is a tap input on a user interface element and/or a voice input requesting that an operation be performed. In some embodiments, a representation (e.g., a graphical representation, an image, user interface element, button, and/or affordance) of the software agent is displayed while detecting the input corresponding to the software agent. In some embodiments, a representation (e.g., a graphical representation, an image, user interface element, button, and/or affordance) of the software agent is not displayed while detecting the input corresponding to the software agent.

In response to detecting the input corresponding to the software agent, the computer system concurrently displays (704), via the one or more display components, (706) a first user interface element (e.g., 614a, 614b, 614c, 614d, 614e, and/or 614f) (e.g., content responsive to the input corresponding to the software agent) with a first manner of emphasis (e.g., 614a in FIG. 6B).

In response to detecting the input corresponding to the software agent, the computer system concurrently displays (704), via the one or more display components, (708) a second user interface element (e.g., 614a, 614b, 614c, 614d, 614e, and/or 614f) (e.g., content responsive to the input corresponding to the software agent) with a second manner of emphasis (e.g., 614c in FIG. 6B) different from the first manner of emphasis, wherein the second user interface element is separate from the first user interface element. In some embodiments, the first user interface element corresponds to and/or is from the software agent. In some embodiments, the first user interface element includes content obtained via an application different from and/or separate from the software agent, such as an application executing on the computer system or another computer system different from the computer system. In some embodiments, displaying the first user interface element with the first manner of emphasis includes displaying the first user interface element in a first size, a first set of one or more colors, a first amount of bold, and/or at a first location. In some embodiments, displaying the first user interface element with the first manner of emphasis includes displaying the first user interface element with emphasis. In some embodiments, the second user interface element corresponds to and/or is from the software agent. In some embodiments, the second user interface element includes content obtained via the application or another application different from the application and the software agent, such as an application executing on the computer system or another computer system different from the computer system. In some embodiments, displaying the second user interface element with the second manner of emphasis includes displaying the second user interface element in a second size (e.g., different from the first size), a second set of one or more colors (e.g., different from the first set of one or more colors), a second amount of bold (e.g., different from the first amount of bold), and/or at a second location (e.g., different from the first location). In some embodiments, displaying the second user interface element with the second manner of emphasis includes displaying the second user interface element without emphasis.

While concurrently displaying the first user interface element and the second user interface element, after displaying the first user interface element with the first manner of emphasis, after displaying the second user interface element with the second manner of emphasis, and without detecting, via the one or more input devices, an input (e.g., as discussed above with respect to FIGS. 6B and 6C) since detecting the input corresponding to the software agent, the computer system concurrently displays (710), via the one or more display components, (712) the first user interface element with a third manner of emphasis (e.g., 614a in FIG. 6C) different from the first manner of emphasis (e.g., without displaying the first user interface element with the first manner of emphasis).

While concurrently displaying the first user interface element and the second user interface element, after displaying the first user interface element with the first manner of emphasis, after displaying the second user interface element with the second manner of emphasis, and without detecting, via the one or more input devices, an input (e.g., as discussed above with respect to FIGS. 6B and 6C) since detecting the input corresponding to the software agent, the computer system concurrently displays (710), via the one or more display components, (714) the second user interface element with a fourth manner of emphasis (e.g., 614c in FIG. 6C) different from the second manner of emphasis and the third manner of emphasis (e.g., without displaying the second user interface element with the second manner of emphasis). In some embodiments, the third manner of emphasis is the second manner of emphasis. In some embodiments, the third manner of emphasis is different from the second manner of emphasis. In some embodiments, while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, the computer system changes display of the first user interface element from being displayed with the first manner of emphasis to the third manner of emphasis. In some embodiments, the fourth manner of emphasis is the first manner of emphasis. In some embodiments, the fourth manner of emphasis is different from the first manner of emphasis. In some embodiments, while concurrently displaying the first user interface element and the second user interface element, after displaying the first user interface element with the first manner of emphasis, after displaying the second user interface element with the second manner of emphasis, and without detecting, via the one or more input devices, an input since detecting the input corresponding to the software agent, the computer system changes display of the second user interface element from being displayed with the second manner of emphasis to the fourth manner of emphasis. Changing how different user interface elements are displayed without detecting an input from a user and instead based on output of a software agent allows the computer system to emphasize different parts of output as the output of the software agent proceeds, thereby providing improved visual feedback to the user and/or performing an operation when a set of conditions has been met without requiring further user input.

In some embodiments, the computer system is in communication with (and/or includes) one or more output devices (e.g., as discussed above with respect to FIG. 6A) (e.g., including the one or more display components, an audio component, and/or a haptic component). In some embodiments, while concurrently displaying the first user interface element with the third manner of emphasis and the second user interface element with the fourth manner of emphasis, the computer system outputs, via the one or more output devices, audio content (e.g., 616, 618, 620, and/or 624) (e.g., a beep, a tone, one or more words, music, and/or an alert sound) corresponding to (e.g., referencing and/or based on) a respective user interface element (e.g., 614a, 614b, 614c, 614d, 614e, and/or 614f) (e.g., a virtual button, an icon, a widget, a control, and/or a window) (and/or without detecting, via the one or more input devices, an input since detecting the input corresponding to the software agent). In some embodiments, in conjunction with (e.g., before, while, and/or after) outputting the audio content corresponding to the respective user interface, the computer system displays, via the one or more display components, a representation (e.g., a graphical representation, an image, user interface element, button, and/or affordance) of the software agent performing an animation (e.g., moving as if to indicate talking) based on the audio content corresponding to the respective user interface element. In some embodiments, in conjunction with (e.g., before, while, and/or after) concurrently displaying the first user interface element with the third manner of emphasis and the second user interface element with the fourth manner of emphasis and outputting the audio content corresponding to the respective user interface element, in accordance with a determination that the respective user interface element is the first user interface element with the third manner of emphasis, the computer system displays, via the one or more display components, the first user interface element with a fifth manner of emphasis (e.g., size of 614a in FIG. 6D) different from the third manner of emphasis (e.g., without displaying the first user interface element with the third manner of emphasis). In some embodiments, the fifth manner of emphasis is the first manner of emphasis, the second manner of emphasis, and/or the fourth manner of emphasis. In some embodiments, the fifth manner of emphasis is different from the first manner of emphasis, the second manner of emphasis, and/or the fourth manner of emphasis. In some embodiments, in conjunction with concurrently displaying the first user interface element with the third manner of emphasis and the second user interface element with the fourth manner of emphasis and outputting the audio content corresponding to the respective user interface element, in accordance with a determination that the respective user interface element is the second user interface element with the fourth manner of emphasis, the computer system displays, via the one or more display components., the second user interface element with a sixth manner of emphasis (e.g., size of 614b in FIG. 6D) different from the fourth manner of emphasis (e.g., without displaying the second user interface element with the fourth manner of emphasis). In some embodiments, the sixth manner of emphasis is the fifth manner of emphasis, first manner of emphasis, the second manner of emphasis, and/or the third manner of emphasis. In some embodiments, the fifth manner of emphasis is different from the fifth manner of emphasis, first manner of emphasis, the second manner of emphasis, and/or the third manner of emphasis. Changing how different user interface elements are displayed without detecting an input from a user and instead based on output of a software agent referencing a particular user interface element allows the computer system to emphasize different parts of output as the output of the software agent proceeds, thereby providing improved visual feedback to the user and/or performing an operation when a set of conditions has been met without requiring further user input.

In some embodiments, the input corresponding to the software agent is a first input (e.g., 605a, 605e, and/or 605k) corresponding to the software agent. In some embodiments, while concurrently displaying the first user interface element with the third manner of emphasis and the second user interface element with the fourth manner of emphasis, the computer system detects, via the one or more input devices, a second input (e.g., 605a, 605e, and/or 605k) corresponding to the software agent. In some embodiments, the first input corresponding to the software agent is the same as and separate from the second input corresponding to the software agent. In some embodiments, the first input corresponding to the software agent is different from the second input corresponding to the software agent. In some embodiments, the second input corresponding to the software agent is an audible input (e.g., a clap, a snap, and/or a verbal input) (e.g., “Tell me more about the first option,”). In some embodiments, in response to detecting the second input corresponding to the software agent, the computer system concurrently displays, via the one or more display components: the first user interface element with a seventh manner of emphasis (e.g., size of 614d in FIG. 6J) different from the third manner of emphasis (e.g., without displaying the first user interface element with the third manner of emphasis); and the second user interface element with an eighth manner of emphasis (e.g., size of 614e in FIG. 6J) different from the fourth manner of emphasis (e.g., without displaying the second user interface element with the fourth manner of emphasis). In some embodiments, the seventh manner of emphasis is the first manner of emphasis, the second manner of emphasis, and/or the fourth manner of emphasis. In some embodiments, the seventh manner of emphasis is different from the first manner of emphasis, the second manner of emphasis, and/or the fourth manner of emphasis. In some embodiments, the eighth manner of emphasis is the seventh manner of emphasis, first manner of emphasis, the second manner of emphasis, and/or the third manner of emphasis. In some embodiments, the eighth manner of emphasis is different from the seventh manner of emphasis, the first manner of emphasis, the second manner of emphasis, and/or the third manner of emphasis. Changing how different user interface elements are displayed in response to detecting an input from a user when such change of display was previously performed based on output of a software agent allows the computer system to allow the user to direct presentation and optimize presentation to the user, thereby providing improved visual feedback to the user and/or performing an operation when a set of conditions has been met without requiring further user input.

In some embodiments, while displaying the first user interface element and the second user interface element (e.g., a virtual button, an icon, a widget, a control, and/or a window) (and/or in response to detecting the input corresponding to the software agent), the computer system displays, via the one or more display components, a representation (e.g., 604) (e.g., a graphical representation, an image, user interface element, button, and/or affordance) of the software agent (e.g., while concurrently displaying the first user interface element with the first manner of emphasis and the second user interface element with the second manner of emphasis or while concurrently displaying the first user interface element with the third manner of emphasis and the second user interface element with the fourth manner of emphasis). Displaying a representation of a software agent while automatically changing emphasis of different user interface elements based on output of the software agent allows the computer system to coordinate different output and/or indicate to a user that the changes are a result of the software agent, thereby providing improved visual feedback to the user and/or performing an operation when a set of conditions has been met without requiring further user input.

In some embodiments, the representation of the software agent is displayed while detecting the input corresponding to the software agent (e.g., as discussed above with respect to FIGS. 6A and 6B). Displaying a representation of a software agent while detecting an input corresponding to the software agent allows the computer system to indicate that the input is being provided to the software agent rather than some other application of the computer system, thereby providing improved visual feedback to the user and/or performing an operation when a set of conditions has been met without requiring further user input.

In some embodiments, the input corresponding to the software agent is detected while the representation of the software agent is not displayed (e.g., as discussed above with respect to FIGS. 6A and 6B). In some embodiments, the representation of the software agent was not previously displayed before the computer system displayed the representation of the software agent while displaying the first user interface element and the second user interface element. Detecting an input corresponding to a software agent while a representation of the software agent is not displayed allows the computer system to allow access to the software agent without requiring screen real estate to be used by the representation, thereby providing additional control options without cluttering the user interface with additional displayed controls and/or performing an operation when a set of conditions has been met without requiring further user input.

In some embodiments, displaying the representation of the software agent includes: while displaying the first user interface element with the first manner of emphasis, displaying, via the one or more display components, the representation of the software agent as directed to (e.g., oriented towards, looking at, and/or indicating) the first user interface element (e.g., 604 at FIG. 6B). In some embodiments, while displaying the second user interface element with the fourth manner of emphasis, displaying, via the one or more display components, the representation of the software agent as directed to the second user interface element (e.g., 604 at FIG. 6C) (e.g., without displaying the representation of the software agent directed to the first user interface element). Directing a representation of a software agent at different user interface elements in combination with changing display of the different user interface elements to emphasize particular user interface elements allows the computer system to use different modalities for emphasizing content, thereby providing improved visual feedback to the user and/or performing an operation when a set of conditions has been met without requiring further user input.

In some embodiments, displaying the representation of the software agent includes: after displaying the representation of the software agent as directed to the second user interface element, displaying, via the one or more display components, the representation of the software agent as directed to (e.g., 604 at FIG. 6E) (e.g., oriented towards, looking at, and/or indicating) a subject (e.g., 610) (e.g., a user, a person, an animal, another computer system different from the computer system, a device, and/or an object) in an environment (e.g., 606) (e.g., a physical and/or virtual environment). In some embodiments, while (and/or after) displaying the representation of the software agent as directed to the second user interface element, the computer system detects (e.g., via the one or more input devices and/or via another computer system in communication with the computer system) an orientation (e.g., direction, location and/or position) of the subject (and/or in a physical environment). In some embodiments, displaying the representation of the software agent directed to the subject includes the representation of the software agent is looking in a direction towards the orientation of the subject. Displaying a representation of a software agent as directed to a subject in an environment after displaying the representation as directed to different user interface elements allows the computer system to indicate when the software agent is waiting for a response and/or a request from the subject, thereby providing improved visual feedback to the user and/or performing an operation when a set of conditions has been met without requiring further user input.

In some embodiments, displaying the representation of the software agent includes: after displaying the representation of the software agent as directed to the second user interface, displaying, via the one or more display components, the representation of the software agent as directed to a default position (e.g., 604 at FIGS. 6A, 6E-6I, and 6K-6M) (e.g., direction and/or orientation) different from being directed to the first user interface element and different from being directed to the second user interface element (and/or different from being directed to a subject in an environment). In some embodiments, the subject includes a user, a person, an animal, another computer system different from the computer system, a device, and/or an object. In some embodiments, the environment includes a physical and/or virtual environment. Displaying a representation of a software agent as directed to a default position after displaying the representation as directed to different user interface elements allows the computer system to indicate when the software agent is waiting for a response and/or a request from a user, thereby providing improved visual feedback to the user and/or performing an operation when a set of conditions has been met without requiring further user input.

In some embodiments, the input corresponding to the software agent is an audible input (e.g., 605a, 605e, and/or 605k) (e.g., a clap, a snap, and/or a verbal input). In some embodiments, the verbal input for the software agent to perform an operation (e.g., “What can I do with friends nearby?”).

In some embodiments, the first user interface element includes first content from an application (e.g., as discussed above with respect to FIGS. 6B and 6J) (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application). In some embodiments, the second user interface element includes second content from the application. In some embodiments, the first content is different from the second content. Displaying different user interface elements from a single application while causing the different user interface elements to have different emphasis based on a software agent separate from the single application allows the computer system to use the single application in a dynamic manner that is directed by the software agent rather than the single application, thereby providing improved visual feedback to the user and/or performing an operation when a set of conditions has been met without requiring further user input.

In some embodiments, the first user interface element includes first content from a first application (e.g., as discussed above with respect to FIG. 6B) (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application). In some embodiments, the second user interface element includes second content from a second application (e.g., as discussed above with respect to FIG. 6C) (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application) different from the first application. In some embodiments, the first content is different from the second content. Displaying different user interface elements from different applications while causing the different user interface elements to have different emphasis based on a software agent separate from the different applications allows the computer system to use the different applications in a dynamic manner that is directed by the software agent rather than the different applications, thereby providing improved visual feedback to the user and/or performing an operation when a set of conditions has been met without requiring further user input.

In some embodiments, the third manner of emphasis is the second manner of emphasis. In some embodiments, the fourth manner of emphasis is the first manner of emphasis (e.g., as discussed above with respect to FIGS. 6B and 6C).

In some embodiments, the fourth manner of emphasis is the same as the first manner of emphasis (e.g., as discussed above with respect to FIGS. 6B and 6C).

In some embodiments, the first manner of emphasis includes a first size (e.g., size of 614a in FIG. 6B) (e.g., a dimension and/or a relative size to other user interface elements). In some embodiments, the second manner of emphasis includes a second size (e.g., size of 614c in FIG. 6B) (e.g., without including the first size) different from the first size. In some embodiments, displaying the first user interface element with the first manner of emphasis includes displaying the first user interface element at the first size. In some embodiments, displaying the second user interface element with the second manner of emphasis includes displaying the second user interface element at the second size. In some embodiments, the third manner of emphasis includes a third size. In some embodiments, displaying the first user interface element with the third manner of emphasis includes displaying the first user interface element with at third size. In some embodiments, the third size is different from the first size and/or the second size. In some embodiments, the third size is the first size and/or the second size. In some embodiments, the fourth manner of emphasis includes a fourth size. In some embodiments, displaying the second user interface element with the fourth manner of emphasis includes displaying the second user interface element at the fourth size. In some embodiments, the fourth size is different from the first size, second size, and/or the fourth size. In some embodiments, the fourth size is the same as the first size, second size, and/or the fourth size.

In some embodiments, the first manner of emphasis includes a border (e.g., as discussed above with respect to FIG. 6B) (e.g., outline and/or frame). In some embodiments, the second manner of emphasis does not include a border (e.g., as discussed above with respect to FIG. 6B). In some embodiments, the border is a differentiation in color, style and/or thickness of the edge of a respective user interface element. In some embodiments, displaying the first user interface element with the first manner of emphasis includes displaying the first user interface element with the border. In some embodiments, displaying the second user interface element with the second manner of emphasis includes displaying the second user interface element with the border.

In some embodiments, the computer system is in communication with (and/or includes) one or more output devices (e.g., as discussed above with respect to FIG. 6A) (e.g., including the one or more display components, an audio component, and/or a haptic component). In some embodiments, while displaying the first user interface element with the first manner of emphasis, the computer system outputs, via the one or more output devices, audio content (e.g., 616, 618, 620, and/or 624) (e.g., a beep, a tone, one or more words, music, and/or an alert sound) corresponding to the first user interface element. In some embodiments, while displaying the second user interface element with the second manner of emphasis, the computer system does not output, via the one or more output devices, audio content corresponding to the second user interface element. In some embodiments, while displaying the second user interface element with the fourth manner of emphasis, the computer system outputs, via the one or more output devices, audio content (e.g., 616, 618, 620, and/or 624) (e.g., a beep, a tone, one or more words, music, and/or an alert sound) corresponding to the second user interface element, wherein the audio content corresponding to the first user interface element is different from the audio content corresponding to the second user interface element. In some embodiments, while displaying the first user interface element with the third manner of emphasis, the computer system does not output, via the one or more output devices, audio content corresponding to the third user interface element. Coordinating audio output with emphasis of different user interface elements allows the computer system to convey information with different modalities, thereby providing improved visual feedback to the user and/or performing an operation when a set of conditions has been met without requiring further user input.

In some embodiments, after (and/or while) concurrently displaying the first user interface element and the second user interface element, after displaying the first user interface element with the third manner of emphasis, after displaying the second user interface element with the fourth manner of emphasis, and without detecting, via the one or more input devices, an input since detecting the input corresponding to the software agent, the computer system concurrently displays, via the one or more display components: the first user interface element with a ninth manner of emphasis (e.g., 614a, 614b, and/or 614c in FIG. 6E) (e.g., without displaying the first user interface element with the third manner of emphasis); and the second user interface element with the ninth manner of emphasis (e.g., 614a, 614b, and/or 614c in FIG. 6E) (e.g., without displaying the second user interface element with the fourth manner of emphasis). In some embodiments, the ninth manner of emphasis is the same as the second manner of emphasis and/or the first manner of emphasis. In some embodiments, the ninth manner of emphasis is different from the second manner of emphasis and/or the first manner of emphasis. Changing emphasis of different user interface elements to the same manner after emphasizing one more than others allows the computer system to indicate when it is done presenting the different user interface elements, thereby providing improved visual feedback to the user and/or performing an operation when a set of conditions has been met without requiring further user input.

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the user interface element of process 800 can be the first user interface element of process 700. For brevity, these details are not repeated herein.

FIG. 8 is a flow diagram illustrating a process (e.g., process 800) for removing content in accordance with some embodiments. Some operations in process 800 are, optionally, combined, the orders of some operations are, optionally, changed, and some operations are, optionally, omitted.

As described below, process 800 provides an intuitive way for removing content. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 600) that is in communication with (and/or includes) one or more input devices (e.g., as discussed above with respect to FIG. 6A) (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface), one or more display components (e.g., as discussed above with respect to FIG. 6A) (e.g., a display screen, a projector, a head mounted display, and/or a touch-sensitive display), and one or more movement components (e.g., as discussed above with respect to FIG. 6A) (e.g., an actuator, a movable base, a rotatable component, a motor, a lift, a level, and/or a rotatable base). In some embodiments, the computer system is a watch, a phone, a tablet, a fitness tracking device, a processor, a head-mounted display (HMD) device, a communal device, a media device, a speaker, a television, an electronic device, and/or a personal computing device.

While displaying, via the one or more display components, a user interface element (e.g., 614a, 614b, 614c, 614d, 614e, and/or 614f) (e.g., content responsive to an input corresponding to a software agent, as described above with respect to FIG. 5), the computer system detects (802), via the one or more input devices, an input (e.g., 605e) (e.g., a movement input, an air gesture, and/or a voice input) to dismiss (e.g., cease display of and/or remove) the user interface element. In some embodiments, the input to dismiss the user interface element is a voice input that changes a previous request and/or indicates that content corresponding to the user interface element is not right. In some embodiments, the user interface element corresponds to and/or is from the software agent. In some embodiments, the user interface element includes content obtained via an application different from the software agent, such as an application executing on the computer system or another computer system different from the computer system. In some embodiments, the input to dismiss the user interface element is detected while displaying a representation (e.g., a graphical representation, an image, user interface element, button, and/or affordance) of the software agent. In some embodiments, the input to dismiss the user interface element is directed to the software agent.

In response to (804) detecting the input to dismiss the user interface element, the computer system moves (806), via the one or more movement components, a portion (e.g., that includes an input device of the one or more input devices and/or an output device of the one or more output devices) of the computer system (e.g., 622 and/or as discussed above with respect to FIGS. 6F and 6G). In some embodiments, moving the portion includes moving the portion with a magnitude, in an amount, with a speed, and/or with a pattern in response to detecting the input to dismiss the user interface element. In some embodiments, the portion is moved by and/or in response to a request from the software agent.

In response to (804) detecting the input to dismiss the user interface element, the computer system ceases (808) display of, via the one or more display components, the user interface element (e.g., as discussed above with respect to FIGS. 6H and 6I). In some embodiments, the user interface element is no longer displayed before moving the portion of the computer system. In some embodiments, display of the user interface element is ceased after moving the portion of the computer system. In some embodiments, display of the user interface element is ceased while moving the portion of the computer system. In some embodiments, moving the portion of the computer system includes moving the portion away from a position of the portion while detecting the input to dismiss the user interface element and, after, moving back to the position of the portion while detecting the input to dismiss the user interface element. In response to detecting an input to dismiss a user interface element, moving a portion of the computer system in addition to ceasing display of the user interface element allows the computer system to provide indications of removal of the user interface element using different modalities, thereby providing improved visual feedback to the user and/or performing an operation when a set of conditions has been met without requiring further user input.

In some embodiments, before displaying the user interface element, the computer system detects, via the one or more input devices, an input (e.g., 605a) (e.g., a movement input, an air gesture, and/or a voice input). In some embodiments, the input corresponds to a software agent (e.g., as described above with respect to FIG. 5). In some embodiments, the input corresponds to a request to display the user interface element. In some embodiments, in response to detecting the input, the computer system displays, via the one or more display components, the user interface element. In some embodiments, the user interface element was not previously displayed before detecting the input. In response to detecting an input, displaying a user interface element that is later dismissed with movement of a portion of the computer system allows the computer system to provide content in response to different requests while allowing a user to then customize such content when the content is not what the user is wanting, thereby providing improved visual feedback to the user and/or performing an operation when a set of conditions has been met without requiring further user input.

In some embodiments, while detecting the input, the computer system displays, via the one or more display components, a representation (e.g., 604) (e.g., a graphical representation, an image, user interface element, button, and/or affordance) of a software agent (e.g., as described above with respect to FIG. 5). In some embodiments, in response to detecting the input to dismiss the user interface element, the computer system maintains display of the representation of the software agent while and/or after ceasing display of the user interface element. Displaying a representation of a software agent while detecting an input that causes a user interface element to be displayed allows the computer system to indicate that the input will be directed to the software agent, thereby providing improved visual feedback to the user and/or performing an operation when a set of conditions has been met without requiring further user input.

In some embodiments, the computer system is in communication with (and/or includes) one or more output devices (e.g., as discussed above with respect to FIG. 6A) (e.g., the one or more display components, an audio component, and/or a haptic component). In some embodiments, in response to detecting the input and in conjunction with (e.g., before, while, and/or after) displaying the user interface element, the computer system outputs, via the one or more output devices, audio content (e.g., 616, 618, 620, and/or 624) corresponding to the user interface element (e.g., “You could go to the park.” and/or “The bakery is open.”). Outputting audio corresponding to a user interface element allows the computer system to provide content in different modalities, thereby providing improved visual feedback to the user and/or performing an operation when a set of conditions has been met without requiring further user input.

In some embodiments, the input to dismiss the user interface element includes an input (e.g., 605e) corresponding to a rejection of content corresponding to the user interface element (e.g., as discussed above with respect to FIG. 6E). In some embodiments, the audible input is a clap, a snap, and/or a verbal input. In some embodiments, the audible input is a verbal input (e.g., “It’s too hot to be outside today,” or “Give me more options.”). In some embodiments, the rejection of the user interface element is a swipe input directed to the user interface element. An input to dismiss a user interface element being an input corresponding to a rejection of content corresponding to the user interface element allows the computer system to provide intuitive ways for a user to interact with content and to modify what content is presented without requiring a complicated set of inputs, thereby providing improved visual feedback to the user and/or performing an operation when a set of conditions has been met without requiring further user input.

In some embodiments, the input to dismiss the user interface element includes (and/or is) a verbal input (e.g., 605a, 605e, 605k) (e.g., voice request and/or vocal command).

In some embodiments, the input to dismiss the user interface element includes (and/or is) an air gesture (e.g., as discussed above with respect to FIG. 6E). In some embodiments, the air gesture includes a swipe in the air to dismiss the user interface element. In some embodiments, the air gesture includes wave gesture to dismiss the user interface element.

In some embodiments, the user interface element is a first user interface element (e.g., 614a, 614b, and/or 614c). In some embodiments, in conjunction with (e.g., before, while, and/or after) ceasing display of the first user interface element and without detecting, via the one or more input devices, an input since detecting the input to dismiss the user interface element, the computer system displays, via the one or more display components, a second user interface element (e.g., 614d, 614e, and/or 614f) (e.g., content responsive to the input corresponding to a software agent). In some embodiments, the second user interface element is different from the first user interface element. Displaying new content after dismissing old content allows the computer system to adjust to changing parameters and attempt to provide content that is wanted by a user, thereby providing improved visual feedback to the user and/or performing an operation when a set of conditions has been met without requiring further user input.

In some embodiments, in response to detecting the input to dismiss the user interface element and in conjunction with (e.g., before, while, and/or after) moving the portion of the computer system, the computer system displays, via the one or more display components, a movement (e.g., as discussed above with respect to FIG. 6F and 6G) (e.g., magnitude, amount, speed, and/or pattern) of a portion (e.g., a segment and/or section) of a representation (e.g., 604 in FIGS. 6F and 6G) (e.g., a graphical representation, an image, user interface element, button, and/or affordance) of a software agent (e.g., as described above with respect to FIG. 5). In some embodiments, while displaying the user interface element (and/or detecting the input to dismiss the user interface element), the computer system displays, via the one or more display components, the representation of the software agent. In some embodiments, before displaying the user interface element, the computer system displays, via the one or more display components, the representation of the software agent. Displaying a movement of a portion of a representation of a software agent in addition to moving a portion of the computer system allows the computer system to output responses to input with different modalities so as to ensure such information is conveyed to a user, thereby providing improved visual feedback to the user and/or performing an operation when a set of conditions has been met without requiring further user input.

In some embodiments, moving the portion of the computer system includes moving the portion of the computer system in a first manner (e.g., as discussed above with respect to FIG. 6G) (e.g., direction, magnitude, amount, speed, and/or pattern). In some embodiments, the movement of the portion of the representation of the software agent includes moving the portion of the representation of the software agent in a second manner (e.g., as discussed above with respect to FIG. 6G). In some embodiments, the second manner mimics (e.g., constrained mirroring, similar movement, and/or same movement but with a different range of motion as) the first manner. In some embodiments, the movement of the portion of the representation of the software agent is in the first manner. Changing display of a representation of a software agent to mimic movement of a portion of the computer system allows the computer system to coordinate different outputs so as to better convey information to a user, thereby providing improved visual feedback to the user and/or performing an operation when a set of conditions has been met without requiring further user input.

In some embodiments, the user interface element is a first user interface element. In some embodiments, while detecting the input to dismiss the first user interface element, the computer system displays, via the one or more display components, the first user interface element and a third user interface element (e.g., 614a, 614b, and/or 614c) (e.g., content responsive to an input corresponding to a software agent) different from the first user interface element. In some embodiments, in response to detecting the input to dismiss the first user interface element, the computer system ceases display of, via the one or more display components, the third user interface element. In some embodiments, in response to detecting the input to dismiss the first user interface element, the computer system ceases display of other user interface elements different from the first user interface element and the third user interface element. Dismissing multiple user interface element with a single input allows the computer system to quickly change direction when a user has expressed a desire to dismiss content being displayed, thereby providing improved visual feedback to the user and/or performing an operation when a set of conditions has been met without requiring further user input.

In some embodiments, the user interface element is a first user interface element. In some embodiments, while detecting the input to dismiss the first user interface element, the computer system displays, via the one or more display components, the first user interface element and a fourth user interface element (e.g., 614a, 614b, and/or 614c) (e.g., content responsive to an input corresponding to a software agent) different from the first user interface element. In some embodiments, in response to detecting the input to dismiss the first user interface element, the computer system maintains display of (e.g., the computer system displays the fourth user interface element without ceasing display of) the fourth user interface element (e.g., as discussed above with respect to FIG. 6I). In some embodiments, in response to detecting the input to dismiss the first user interface element, the computer system maintains display of other user interface elements different from the fourth user interface element. In some embodiments, after ceasing display of the user interface element (and/or moving the portion of the computer system), the computer system displays, via the one or more display components, the fourth user interface element and another user interface element different from the fourth user interface element. In some embodiments, the other user interface element is the first user interface element. In some embodiments, while displaying the fourth user interface element and the other user interface element, the computer system detects, via the one or more input devices an input (e.g., a movement input, an air gesture, and/or a voice input) to dismiss (e.g., cease display of and/or remove) the fourth user interface element. In some embodiments, in response to detecting the input to dismiss the fourth user interface element, the computer system ceases display of, via the one or more display components, the fourth user interface element, and the computer system maintains display of (e.g., the computer system displays the other user interface element without ceasing display of) the other user interface element (and/or the computer system moves, via the one or more movement components, the portion of the computer system). Dismissing a single user interface element of multiple user interface element with an input allows the computer system to cater its output to a user and ensure that content that the user wants is maintained while content that the user does not want is not maintained, thereby providing improved visual feedback to the user and/or performing an operation when a set of conditions has been met without requiring further user input.

In some embodiments, before moving the portion of the computer system (and/or while detecting the input to dismiss the user interface element), the computer system is at an initial position (e.g., 600 in FIG. 6E) (e.g., default position and/or orientation). In some embodiments, after moving the portion of the computer system (e.g., 600 in FIG. 6F), the computer system moves, via the one or more movement components, the portion of the computer system to the initial position (e.g., 600 at FIG. 6H) (e.g., moves the portion of the computer system back to the initial position) without detecting, via the one or more input devices, an input since detecting the input to dismiss the user interface element. In some embodiments, the computer system moves the portion of the computer system to the initial position in response to the computer system detects a threshold period of time (e.g., 3 seconds, 15 seconds) passed without detecting, via the one or more input devices, an input (e.g., a movement input, an air gesture, and/or a voice input). In some embodiments, the computer system moves the portion of the computer system to the initial position in response to detecting an input (e.g., a movement input, an air gesture, and/or a voice input) after detecting the input to dismiss. In some embodiments, the input is different from the input to dismiss. In some embodiments, the input is separate from and the same as the input to dismiss. Moving a portion of the computer system back to its initial position after moving to dismiss content allows the computer system to indicate when it is finished dismissing the content, thereby providing improved visual feedback to the user and/or performing an operation when a set of conditions has been met without requiring further user input.

In some embodiments, the computer system is in communication with (and/or includes) one or more output devices (e.g., as discussed above with respect to FIG. 6A) (e.g., including the one or more display components, an audio component, and/or a haptic component). In some embodiments, in response to detecting the input to dismiss the user interface element, the computer system outputs, via the one or more output devices, a haptic output (e.g., as discussed above with respect to FIG. 6F and 6G) (e.g., a vibration, a force feedback, a pressure sensation, and/or a motion cue). Outputting haptic in response to detecting an input to dismiss a user interface element in addition to moving a portion of the computer system allows the computer system to indicate dismissal using different modalities so as to inform a user, thereby providing improved visual feedback to the user and/or performing an operation when a set of conditions has been met without requiring further user input.

In some embodiments, the computer system is in communication with one or more output devices (e.g., including the one or more display components, an audio component, and/or a haptic component). In some embodiments, in response to detecting the input to dismiss the user interface element and in conjunction with (e.g., before, while, and/or after) ceasing display of the user interface element, the computer system outputs, via the one or more output devices, an audio output (e.g., as discussed above with respect to FIG. 6F) (e.g., a beep, a tone, one or more words, music, and/or an alert sound) (e.g., “Let’s try something else,” or “That won’t work.”). Outputting audio in response to detecting an input to dismiss a user interface element in addition to moving a portion of the computer system allows the computer system to indicate dismissal using different modalities so as to inform a user, thereby providing improved visual feedback to the user and/or performing an operation when a set of conditions has been met without requiring further user input.

In some embodiments, the user interface element corresponds to (e.g., directed to, related to, and/or associated with) a software agent (e.g., as described above with respect to FIG. 5). In some embodiments, the user interface element includes content from an application (e.g., as discussed above with respect to FIG. 6A and 6J) different (and/or separate) from the software agent. In some embodiments, in response to detecting, via the one or more input devices, an input (e.g., a movement input, an air gesture, and/or a voice input) directed to the software agent, the computer system displays, via the one or more display components, the user interface element. In some embodiments, the content from the application includes media (e.g., music and/or videos), data, and/or a widget from and/or corresponding to the application. In some embodiments, the input directed to the software agent includes a request to perform an operation (e.g., display activities for the day, and/or explain when the next calendar event is scheduled). Displaying user interface elements corresponding to a software agent but including content from another application allows the computer system to have the software agent direct content delivery while utilizing content from different applications, thereby providing improved visual feedback to the user and/or performing an operation when a set of conditions has been met without requiring further user input.

Note that details of the processes described above with respect to process 800 (e.g., FIG. 8) are also applicable in an analogous manner to other processes described herein. For example, process 900 optionally includes one or more of the characteristics of the various processes described above with reference to process 800. For example, the second set of one or more interactions of process 900 can include the input to dismiss the user interface element of process 800. For brevity, these details are not repeated herein.

FIG. 9 is a flow diagram illustrating a process (e.g., process 900) for displaying content in accordance with some embodiments. Some operations in process 900 are, optionally, combined, the orders of some operations are, optionally, changed, and some operations are, optionally, omitted.

As described below, process 900 provides an intuitive way for displaying content. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., 600) that is in communication with (and/or includes) one or more input devices (e.g., as discussed above with respect to FIG. 6A) (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface) and one or more display components (e.g., as discussed above with respect to FIG. 6A) (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, an electronic device, and/or a personal computing device.

While (902) the computer system is operating in a standby state (e.g., 600 in FIGS. 6A, 6L, and 6M) (e.g., a power-saving state, an inactive state, a state in which the computer system is awaiting an input, and/or a locked state) and without detecting, via the one or more input devices, an input (e.g., 605a, 605e, and/or 605k) (e.g., a movement input, an air gesture, and/or a voice input) directed to the computer system (and/or a software agent, as described about with respect to FIG. 5) (e.g., from a subject, such as a person and/or a user of the computer system), in accordance with a determination that a subject (e.g., 610) (e.g., a user, a person, an animal, another computer system different from the computer system, a device, and/or an object) had a first set of one or more interactions (e.g., as discussed above with respect to FIG. 6L) (e.g., with the computer system and/or the software agent) while the computer system was operating in an active state (e.g., a non-power-saving state, a non-standby state, a state in which the computer system is outputting and/or recently output content, a state in which the computer system has recently responded to an input, and/or an unlocked state) (and/or that the subject is detected in an environment of the computer system), the computer system displays (904), via the one or more display components, a first set of one or more user interface elements (e.g., 602a and/or 602b), wherein the active state is different from the standby state. In some embodiments, the first set of one or more user interface elements are from the software agent. In some embodiments, a first user interface element of the first set of one or more user interface elements corresponds to and/or includes content from a first application of the computer system or another computer system different from the computer system. In some embodiments, a second user interface element of the first set of one or more user interface elements corresponds to and/or includes content from the first application of the computer system or another computer system different from the computer system. In some embodiments, a third user interface element of the first set of one or more user interface elements corresponds to and/or includes content from a second application of the computer system or another computer system different from the computer system. In some embodiments, the second application is different from the first application.

While (902) the computer system is operating in the standby state and without detecting, via the one or more input devices, an input directed to the computer system, in accordance with a determination that the subject had a second set of one or more interactions (e.g., as discussed above with respect to FIG. 6M) (e.g., with the computer system and/or the software agent) while the computer system was operating in the active state (and/or that the subject is detected in an environment of the computer system), the computer system displays (906), via the one or more display components, a second set of one or more user interface elements (e.g., 602b and/or 602c) (e.g., without displaying the first set of one or more user interface elements) different from the first set of one or more user interface elements, wherein the second set of one or more interactions is different from the first set of one or more interactions. In some embodiments, the second set of one or more user interface elements are from the software agent. In some embodiments, a first user interface element of the second set of one or more user interface elements corresponds to and/or includes content from a first application of the computer system or another computer system different from the computer system. In some embodiments, a second user interface element of the second set of one or more user interface elements corresponds to and/or includes content from the first application of the computer system or another computer system different from the computer system. In some embodiments, a third user interface element of the second set of one or more user interface elements corresponds to and/or includes content from a second application of the computer system or another computer system different from the computer system. In some embodiments, the second application is different from the first application. While the computer system is operating in a standby state, displaying different user interface elements based on previous interactions while the computer system was operating in an active state allows the computer system to passively provide information based on previous interactions without requiring a user to request such information, thereby providing improved visual feedback to the user and/or performing an operation when a set of conditions has been met without requiring further user input.

In some embodiments, while the computer system is operating in the standby state (and/or while not detecting, via the one or more input devices, and/or without detecting, via the one or more input devices, an input directed to the computer system), the computer system displays, via the one or more display components, a representation (e.g., 604) (e.g., a graphical representation, an image, user interface element, button, and/or affordance) of a software agent (e.g., as described above with respect to FIG. 5). In some embodiments, the input is a movement input, an air gesture, and/or a voice input. Displaying a representation of a software agent while operating in a standby state and displaying different user interface elements allows the computer system to indicate that the different user interface elements are provided via the software agent, thereby providing improved visual feedback to the user and/or performing an operation when a set of conditions has been met without requiring further user input.

In some embodiments, before displaying the first set of one or more user interface elements (and/or while the computer system is operating in the standby state), the computer system detects, via the one or more input devices, the subject in an environment (e.g., 606) (e.g., a physical environment or a virtual environment). In some embodiments, the computer system displays the first set of one or more user interface elements in response to detecting the subject in the environment and in accordance with the determination that the subject had the first set of one or more interactions while the computer system is operating in the standby state and without detecting an input directed to the computer system. In some embodiments, the computer system displays the first set of one or more user interface elements in response to detecting the subject in the environment and in accordance with the determination that the subject had the first set of one or more interactions while the computer system is operating in the standby state and without detecting an input directed to the computer system. In some embodiments, the computer system displays the second set of one or more user interface elements in response to detecting the subject in the environment and in accordance with the determination that the subject had the second set of one or more interactions while the computer system is operating in the standby state and without detecting an input directed to the computer system. In some embodiments, before displaying the second set of one or more user interface elements, the computer system detects, via the one or more input devices, the subject in the environment. While the computer system is operating in a standby state, displaying different user interface elements based on previous interactions that occurred while the computer system was operating in an active state by a subject currently being detected in an environment allows the computer system to passively provide information that is relevant to a present subject, thereby providing improved visual feedback to the user and/or performing an operation when a set of conditions has been met without requiring further user input.

In some embodiments, the subject is a person (e.g., as discussed above with respect to FIG. 6A).

In some embodiments, the subject is a first subject (e.g., 610). In some embodiments, while the computer system is operating in the standby state and without detecting, via the one or more input devices, an input (e.g., as discussed above with respect to FIG. 6L) directed to the computer system (and/or after displaying the first set of one or more user interface elements and/or after displaying the second set of one or more user interface elements), in accordance with a determination that a second subject (e.g., 630), different from the first subject, had a third set of one or more interactions (e.g., as discussed above with respect to FIG. 6M) (e.g., with the computer system and/or the software agent), while the computer system was operating in the active state (and/or that the second subject is detected in an environment of the computer system), the computer system displays, via the one or more display components, a third set of one or more user interface elements (e.g., 602d and/or 602e) (e.g., with or without displaying the first set of one or more user interface elements and the second set of one or more user interface elements) different from the first set of one or more user interface elements and the second set of one or more user interface elements, wherein the third set of one or more interactions are different from the first set of one or more interactions and the second set of one or more interactions. In some embodiments, the third set of one or more user interface elements are from the software agent. In some embodiments, a first user interface element of the third set of one or more user interface elements corresponds to and/or includes content from a first application of the computer system or another computer system different from the computer system. In some embodiments, a second user interface element of the third set of one or more user interface elements corresponds to and/or includes content from the first application of the computer system or another computer system different from the computer system. In some embodiments, a third user interface element of the third set of one or more user interface elements corresponds to and/or includes content from a second application of the computer system or another computer system different from the computer system. In some embodiments, the second application is different from the first application. In some embodiments, while the computer system is operating in the standby state and without detecting, via the one or more input devices, an input directed to the computer system, in accordance with a determination that the second subject had a fourth set of one or more interactions (e.g., as discussed above with respect to FIG. 6M) (e.g., with the computer system and/or the software agent), while the computer system was operating in the active state, the computer system displays, via the one or more display components, a fourth set of one or more user interface elements (e.g., 602a, 602b, 602c, 602d and/or 602e) (e.g., with or without displaying the first set of one or more user interface elements, the second set of one or more user interface elements, and/or the third set of one or more user interface elements) different from the first set of one or more user interface elements, the second set of one or more user interface elements, and the third set of one or more user interface elements, wherein the fourth set of one or more interactions are different from the first set of one or more interactions, the second set of one or more interactions, and the third set of one or more interactions. In some embodiments, the fourth set of one or more user interface elements are from the software agent. In some embodiments, a first user interface element of the fourth set of one or more user interface elements corresponds to and/or includes content from a first application of the computer system or another computer system different from the computer system. In some embodiments, a second user interface element of the fourth set of one or more user interface elements corresponds to and/or includes content from the first application of the computer system or another computer system different from the computer system. In some embodiments, a third user interface element of the fourth set of one or more user interface elements corresponds to and/or includes content from a second application of the computer system or another computer system different from the computer system. In some embodiments, the second application is different from the first application. While the computer system is operating in a standby state, displaying different user interface elements based on previous interactions with different subjects while the computer system was operating in an active state allows the computer system to passively provide information based on previous interactions that are specific to certain subjects without requiring a user to request such information, thereby providing improved visual feedback to the user and/or performing an operation when a set of conditions has been met without requiring further user input.

In some embodiments, before displaying the third set of one or more user interface elements, the computer system detects, via the one or more input devices, the second subject in an environment (e.g., as discussed above with respect to FIG. 6M) (e.g., a physical environment or a virtual environment). In some embodiments, detecting the second subject includes a determination that the second subject is a primary subject (e.g., a subject interacting with the computer system, a subject closer to the computer system than another subject in the environment, and/or a subject detected while another subject is in the environment), and/or a remaining subject (e.g., a subject detected after other subject(s) leave the environment). In some embodiments, the computer system displays the third set of one or more user interface elements in response to detecting the first subject in the environment while the computer system is operating in the inactive state and in accordance with the determination that the first subject had the first set of one or more interactions while the computer system is operating in the active state and without detecting an input directed to the computer system. In some embodiments, the computer system displays the third set of one or more user interface elements in response to detecting the first subject in the environment while the computer system is operating in the inactive state and in accordance with the determination that the first subject had the second set of one or more interactions while the computer system is operating in the active state and without detecting an input directed to the computer system. In some embodiments, before displaying the fourth set of one or more user interface elements, the computer system detects, via the one or more input devices, the second subject in the environment. While the computer system is operating in a standby state, displaying different user interface elements based on previous interactions while the computer system was operating in an active state depending on which subject is present allows the computer system to passively provide information based on previous interactions without requiring a user to request such information, thereby providing improved visual feedback to the user and/or performing an operation when a set of conditions has been met without requiring further user input.

In some embodiments, the subject is a first subject (e.g., 610). In some embodiments, while the computer system is operating in the standby state and without detecting, via the one or more input devices, an input (e.g., a movement input, an air gesture, and/or a voice input) directed to the computer system (and/or after displaying the first set of one or more user interface elements and/or after displaying the second set of one or more user interface elements), in accordance with a determination that a third subject (e.g., 630) (e.g., a user, a person, an animal, another computer system different from the computer system, a device, and/or an object) has a fifth set of one or more interactions (e.g., as discussed above with respect to FIG. 6M) (e.g., with the computer system and/or the software agent) and a fourth subject (e.g., a user, a person, an animal, another computer system different from the computer system, a device, and/or an object) has a sixth set of one or more interactions (e.g., as discussed above with respect to FIG. 6M) while the computer system was operating in the active state (and/or that the third subject and the fourth subject are detected in an environment of the computer system), the computer system displays, via the one or more display components, a fifth set of one or more user interface elements (e.g., 602a, 602b, 602c, 602d, and/or 602e) different from the first set of one or more user interface elements and the second set of one or more user interface elements, wherein: the fifth set of one or more interactions are different from the first set of one or more interactions and the second set of one or more interactions; the sixth set of one or more interactions are different from the first set of one or more interactions, the second set of one or more interactions, and the fifth set of one or more interactions; the third subject is different from the fourth subject and the first subject; and the fourth subject is different from the first subject. In some embodiments, the fifth set of one or more user interface elements are from the software agent. In some embodiments, a first user interface element of the fifth set of one or more user interface elements corresponds to and/or includes content from a first application of the computer system or another computer system different from the computer system. In some embodiments, a second user interface element of the fifth set of one or more user interface elements corresponds to and/or includes content from the first application of the computer system or another computer system different from the computer system. In some embodiments, a third user interface element of the fifth set of one or more user interface elements corresponds to and/or includes content from a second application of the computer system or another computer system different from the computer system. In some embodiments, the second application is different from the first application. In some embodiments, in accordance with a determination that a third subject (e.g., 630) (e.g., a user, a person, an animal, another computer system different from the computer system, a device, and/or an object) has a fifth set of one or more interactions (e.g., as discussed above with respect to FIG. 6M) (e.g., with the computer system and/or the software agent) and a fourth subject (e.g., a user, a person, an animal, another computer system different from the computer system, a device, and/or an object) has a sixth set of one or more interactions (e.g., as discussed above with respect to FIG. 6M) while the computer system was operating in the active state (and/or that the third subject and the fourth subject are detected in an environment of the computer system), displaying, via the one or more display components, a fifth set of one or more user interface elements (e.g., 602a, 602b, 602c, 602d, and/or 602e) different from the first set of one or more user interface elements and the second set of one or more user interface elements, wherein,:, in accordance with a determination that the third subject has the sixth set of one or more interactions (e.g., with the computer system and/or the software agent) and the fourth subject has the fifth set of one or more interactions while the computer system was operating in the active state (and/or that the third subject and the fourth subject are detected in an environment of the computer system), the computer system displays, via the one or more display components, a sixth set of one or more user interface elements (e.g., 602a, 602b, 602c, 602d, and/or 602e) different from the first set of one or more user interface elements, the second set of one or more user interface elements, and the fifth set of one or more user interface elements. In some embodiments, the sixth set of one or more user interface elements are from the software agent. In some embodiments, a first user interface element of the sixth set of one or more user interface elements corresponds to and/or includes content from a first application of the computer system or another computer system different from the computer system. In some embodiments, a second user interface element of the sixth set of one or more user interface elements corresponds to and/or includes content from the first application of the computer system or another computer system different from the computer system. In some embodiments, a third user interface element of the sixth set of one or more user interface elements corresponds to and/or includes content from a second application of the computer system or another computer system different from the computer system. In some embodiments, the second application is different from the first application. In some embodiments, in accordance with a determination that the third subject had the fifth set of one or more interactions and the fourth subject had the fifth set of one or more interactions, the computer system displays, via the one or more display components, a seventh set of one or more user interface elements different from the sixth set of one or more user interface elements and/or the fifth set of one or more user interface elements. In some embodiments, in accordance with a determination that the fourth subject had the sixth set of one or more interactions and the fourth subject had the sixth set of one or more interactions, the computer system displays, via the one or more display components, an eighth set of one or more user interface elements different from the seventh set of one or more user interface elements, the sixth set of one or more user interface elements and/or the fifth set of one or more user interface elements While the computer system is operating in a standby state, displaying different user interface elements based on previous interactions with different subjects while the computer system was operating in an active state allows the computer system to passively provide information based on previous interactions that are specific to certain subjects without requiring a user to request such information, thereby providing improved visual feedback to the user and/or performing an operation when a set of conditions has been met without requiring further user input.

In some embodiments, in conjunction with (e.g., before, while, and/or after) the computer system operating in the standby state without detecting an input directed to the computer system, the computer system detects, via the one or more input devices, the third subject and the fourth subject (e.g., as discussed above with respect to FIG. 6M). While the computer system is operating in a standby state, displaying different user interface elements based on previous interactions while the computer system was operating in an active state depending on which subjects are present allows the computer system to passively provide information based on previous interactions without requiring a user to request such information, thereby providing improved visual feedback to the user and/or performing an operation when a set of conditions has been met without requiring further user input.

In some embodiments, the subject is a first subject (e.g., 610). In some embodiments, while the computer system is operating in the standby state, without detecting an input directed to the computer system (and/or after displaying the first set of one or more user interface elements and/or after displaying the second set of one or more user interface elements), and in accordance with a determination that a seventh subject (e.g., 630) (e.g., an unknown subject), different from the first subject, is unknown (e.g., as discussed above with respect to FIG. 6M) (e.g., to the computer system and/or another computer system separate from the computer system) (and/or that the seventh subject is detected in an environment of the computer system), the computer system displays, via the one or more display components, a seventh set of one or more user interface elements (e.g., 602a, 602b, 602c, 602d, and/or 602e) different from the first set of one or more interactions and the second set of one or more interactions. In some embodiments, the determination that the seventh subject is unknown includes a determination that the seventh subject has had no interactions (e.g., with the computer system and/or the software agent) while the computer system was operating in the active state. In some embodiments, the determination that the seventh subject is unknown includes a determination that the seventh subject is not authenticated. While the computer system is operating in a standby state, displaying different user interface elements that are not based on previous interactions while the computer system was operating in an active state when an unknown subject is present allows the computer system to passively provide information that is not specific to any particular subject when an unknown subject is present, thereby providing improved visual feedback to the user and/or performing an operation when a set of conditions has been met without requiring further user input.

In some embodiments, before displaying the seventh set of one or more user interface elements, the computer system detects, via the one or more input devices, the seventh subject in an environment (e.g., 606) (e.g., a physical environment or a virtual environment). In some embodiments, the computer system displays the seventh set of one or more user interface elements in response to detecting the subject in the environment and in accordance with the determination that the subject had the seventh set of one or more interactions while the computer system is operating in the standby state and without detecting an input directed to the computer system. While the computer system is operating in a standby state, displaying different user interface elements that are not based on previous interactions that occurred while the computer system was operating in an active state when an unknown subject is currently being detected in an environment allows the computer system to passively provide information that is not specific to any particular subject when an unknown subject is present, thereby providing improved visual feedback to the user and/or performing an operation when a set of conditions has been met without requiring further user input.

In some embodiments, the first set of one or more interactions includes an interaction (e.g., 605a, 605e, and/or 605k) (e.g., an input previously detected via the one or more input devices, an output previously output by the computer system, and/or data received by the computer system) (and/or the first set of one or more interactions are interactions) with respect to (e.g., corresponding to, and/or are interactions with) the computer system. In some embodiments, the second set of one or more interactions are with respect to the computer system. In some embodiments, the input previously detected by the computer system includes an input (e.g., a movement input, an air gesture, and/or a voice input) by the subject and/or between the subject and another subject. In some embodiments, the input is directed to (e.g., oriented towards, looking at, and/or indicating) the computer system or not directed to the computer system (e.g., directed to nothing and/or directed to an environment). In some embodiments, the environment is a physical and/or virtual environment. While the computer system is operating in a standby state, displaying different user interface elements based on previous interactions with the computer system that occurred while the computer system was operating in an active state by a subject currently being detected in an environment allows the computer system to passively provide information that is relevant to a present subject, thereby providing improved visual feedback to the user and/or performing an operation when a set of conditions has been met without requiring further user input.

In some embodiments, the interaction is with respect to (e.g., corresponding to, and/or directed to) a software agent (e.g., represented by 604 in FIGS. 6A-6M) (e.g., as described above with respect to FIG. 5) of the computer system. While the computer system is operating in a standby state, displaying different user interface elements based on previous interactions with a software agent that occurred while the computer system was operating in an active state by a subject currently being detected in an environment allows the computer system to passively provide information that is relevant to a present subject, thereby providing improved visual feedback to the user and/or performing an operation when a set of conditions has been met without requiring further user input.

In some embodiments, the first set of one or more user interface elements includes a first user interface element (e.g., 614a, 614b, 614c, 614d, 614e, and/or 614f) and a second user interface element (e.g., 614a, 614b, 614c, 614d, 614e, and/or 614f) different (and/or separate) from the first user interface element. In some embodiments, displaying the first set of one or more user interface elements includes concurrently displaying the first user interface element and the second user interface element. In some embodiments, the second set of one or more user interface elements includes a third user interface element and a fourth user interface element different from the first user interface element. In some embodiments, displaying the second set of one or more user interface elements includes concurrently displaying the third user interface element and the fourth user interface element. While the computer system is operating in a standby state, displaying different user interface elements based on previous interactions while the computer system was operating in an active state allows the computer system to passively provide information based on previous interactions without requiring a user to request such information, thereby providing improved visual feedback to the user and/or performing an operation when a set of conditions has been met without requiring further user input.

In some embodiments, the first user interface element corresponds to (e.g., directed to, related to, and/or associated with) a first interaction (e.g., 605a) of the first set of one or more interactions. In some embodiments, the second user interface element corresponds to a second interaction (e.g., 605e and/or 605k) of the first set of one or more interactions. In some embodiments, the first interaction is different (and/or separate) from the second interaction. While the computer system is operating in a standby state, displaying different user interface elements based on previous interactions while the computer system was operating in an active state allows the computer system to passively provide information based on different previous interactions without requiring a user to request such information, thereby providing improved visual feedback to the user and/or performing an operation when a set of conditions has been met without requiring further user input.

In some embodiments, the first user interface element corresponds to (e.g., is from, directed to, at a location of, related to, and/or associated with) a first application (e.g., as discussed above with respect to FIG. 6A). In some embodiments, the second user interface element corresponds to a second application (e.g., as discussed above with respect to FIG. 6A) different from the first application. While the computer system is operating in a standby state, displaying different user interface elements based on previous interactions with different applications while the computer system was operating in an active state allows the computer system to passively provide information based on previous interactions without requiring a user to request such information, thereby providing improved visual feedback to the user and/or performing an operation when a set of conditions has been met without requiring further user input.

In some embodiments, the first set of one or more interactions includes a third interaction. In some embodiments, the first user interface element corresponds to (e.g., directed to, is based on, related to, and/or associated with) the third interaction (e.g., as discussed above with respect to FIG. 6A). In some embodiments, the second user interface element corresponds to the third interaction (e.g., as discussed above with respect to FIG. 6A). While the computer system is operating in a standby state, displaying different user interface elements based on a single interactions while the computer system was operating in an active state allows the computer system to passively provide information based on the single interaction without requiring a user to request such information, thereby providing improved visual feedback to the user and/or performing an operation when a set of conditions has been met without requiring further user input.

In some embodiments, the first user interface element corresponds to (e.g., is from, directed to, at a location of, related to, and/or associated with) a third application (e.g., as discussed above with respect to FIG. 6A) (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application). In some embodiments, the second user interface element corresponds to the third application. While the computer system is operating in a standby state, displaying different user interface elements based on a different interactions with the same application while the computer system was operating in an active state allows the computer system to passively provide information based on the different interaction without requiring a user to request such information, thereby providing improved visual feedback to the user and/or performing an operation when a set of conditions has been met without requiring further user input.

In some embodiments, the first set of one or more user interface elements includes a fourth user interface element (e.g., 614a, 614b, 614c, 614d, 614e, and/or 614f) and a fifth user interface element (e.g., 614a, 614b, 614c, 614d, 614e, and/or 614f) different from the fourth user interface element. In some embodiments, displaying the first set of one or more user interface elements includes displaying the fifth user interface element after no longer displaying the fourth user interface element (e.g., as discussed above with respect to FIG. 6M). In some embodiments, the second set of one or more user interface elements includes a sixth user interface element and a seventh user interface element different from the sixth user interface element. In some embodiments, displaying the second set of one or more user interface elements includes displaying the sixth user interface element after no longer displaying the fifth user interface element. While the computer system is operating in a standby state, displaying different user interface elements at different times based on previous interactions while the computer system was operating in an active state allows the computer system to passively provide information based on previous interactions without requiring a user to request such information, thereby providing improved visual feedback to the user and/or performing an operation when a set of conditions has been met without requiring further user input.

In some embodiments, the first set of one or more interactions includes a fourth interaction (e.g., as discussed above with respect to FIG. 6M) and a fifth interaction (e.g., as discussed above with respect to FIG. 6M) different from the fourth interaction. In some embodiments, the fourth user interface element corresponds to (e.g., directed to, related to, and/or associated with) the fourth interaction (e.g., and does not correspond to the fifth interaction). In some embodiments, the fifth user interface element corresponds to the fifth interaction (e.g., and does not correspond to the fourth interaction). While the computer system is operating in a standby state, displaying different user interface elements at different times based on different previous interactions while the computer system was operating in an active state allows the computer system to passively provide information based on the different previous interactions without requiring a user to request such information, thereby providing improved visual feedback to the user and/or performing an operation when a set of conditions has been met without requiring further user input.

In some embodiments, the fourth user interface element corresponds to (e.g., directed to, related to, and/or associated with) a fourth application (e.g., as discussed above with respect to FIG. 6A) (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application). In some embodiments, the fifth user interface element corresponds to a fifth application (e.g., as discussed above with respect to FIG. 6A) (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application) different from the fourth application. While the computer system is operating in a standby state, displaying different user interface elements at different times based on previous interactions with different applications while the computer system was operating in an active state allows the computer system to passively provide information based on the previous interactions without requiring a user to request such information, thereby providing improved visual feedback to the user and/or performing an operation when a set of conditions has been met without requiring further user input.

In some embodiments, the first set of one or more interactions includes a sixth interaction (e.g., as discussed above with respect to FIG. 6M). In some embodiments, the fourth user interface element corresponds to (e.g., directed to, related to, and/or associated with) the sixth interaction. In some embodiments, the fifth user interface element corresponds to the sixth interaction. While the computer system is operating in a standby state, displaying different user interface elements at different times based on the same previous interaction while the computer system was operating in an active state allows the computer system to passively provide information based on the same previous interaction without requiring a user to request such information, thereby providing improved visual feedback to the user and/or performing an operation when a set of conditions has been met without requiring further user input.

In some embodiments, the fourth user interface element corresponds to (e.g., directed to, related to, and/or associated with) a sixth application (e.g., as discussed above with respect to FIG. 6A). In some embodiments, the fifth user interface element corresponds to the sixth application (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application). While the computer system is operating in a standby state, displaying different user interface elements at different times based on previous interactions with the same application while the computer system was operating in an active state allows the computer system to passively provide information based on the previous interactions without requiring a user to request such information, thereby providing improved visual feedback to the user and/or performing an operation when a set of conditions has been met without requiring further user input.

In some embodiments, while displaying the first set of one or more user interface elements, the computer system detects, via the one or more input devices, an input (e.g., 605e) (e.g., an audible input and/or an air gesture) directed to (e.g., oriented towards, looking at, and/or indicating) the computer system. In some embodiments, an audible input is a clap, a snap, and/or a verbal input (e.g., “It is too hot to be outside today.”). In some embodiments, an air gesture is waving a hand and/or swiping of the hand. In some embodiments, in response to detecting the input directed to the computer system, the computer system ceases display of the first set of one or more user interface elements (e.g., as discussed above with respect to FIGS. 6G and 6H). In some embodiments, while displaying the second set of one or more user interface elements, the computer system detects, via the one or more input devices, a second audible input directed to the computer system. In some embodiments, in response to detecting the second input directed to the computer system, the computer system ceases display of the second set of one or more user interface elements. Ceasing display of user interface elements being passively presented when an input is detected allows the computer system to switch from passively presenting information to responding to inputs, thereby providing improved visual feedback to the user and/or performing an operation when a set of conditions has been met without requiring further user input.

In some embodiments, in response to detecting the input directed to the computer system (and/or while ceasing display of the first set of one or more user interface elements), the computer system changes the computer system to operate in the active state (e.g., 606 in FIG. 6B) (and/or ceases the computer system from operating in the standby state). Transitioning to an active state from an inactive state when detecting an input allows the computer system to switch from passively presenting information to responding to inputs, thereby providing improved visual feedback to the user and/or performing an operation when a set of conditions has been met without requiring further user input.

In some embodiments, while the computer system is operating in the standby state, the computer system displays, via the one or more display components, a portion (e.g., a segment and/or section) of a representation (e.g., 604) (e.g., a graphical representation, an image, user interface element, button, and/or affordance) of a software agent (e.g., as described above with respect to FIG. 5) in a first manner (e.g., 604 at FIG. 6A) (e.g., a size, a position, and/or an orientation). In some embodiments, the first manner includes a first appearance (e.g., color, highlight, and/or shape). In some embodiments, while the computer system is operating in the active state, the computer system displays, via the one or more display components, the portion of the representation of the software agent in a second manner (e.g., 604 in FIGS. 6B and/or 6E) (e.g., a size, a position, and/or an orientation) different from the first manner. In some embodiments, the second manner includes a second appearance (e.g., color, highlight, and/or shape) different from the first appearance. Changing an appearance of a representation of a software agent when in a standby state and when in an active state allows the computer system to indicate which state is in by the appearance of the representation, thereby providing improved visual feedback to the user and/or performing an operation when a set of conditions has been met without requiring further user input.

Note that details of the processes described above with respect to process 900 (e.g., FIG. 9) are also applicable in an analogous manner to the processes described herein. For example, process 700 optionally includes one or more of the characteristics of the various processes described herein with reference to process 900. For example, the first set of one or more interactions of process 900 can be include the input corresponding to the software agent of process 700. For brevity, these details are not repeated herein.

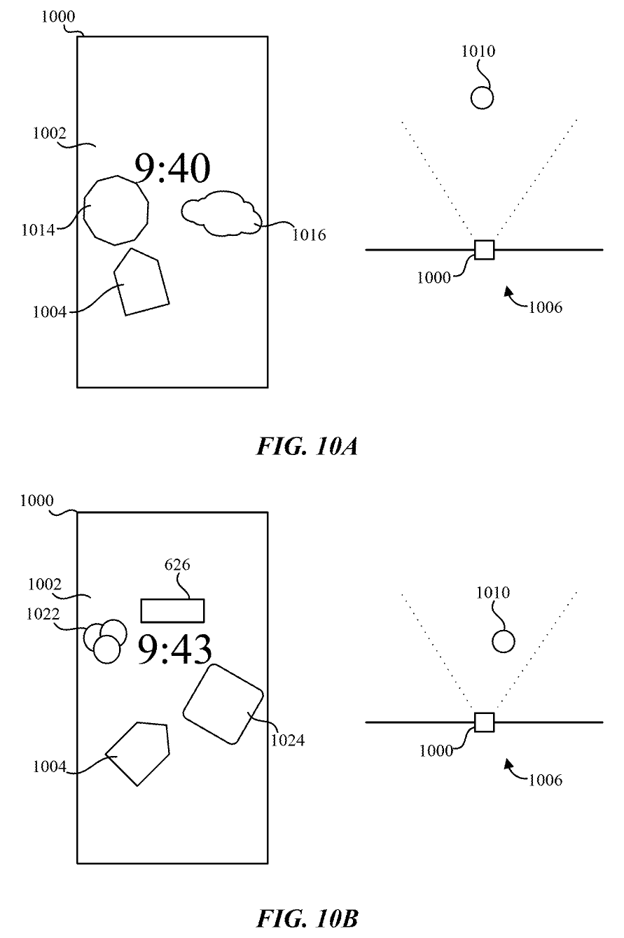

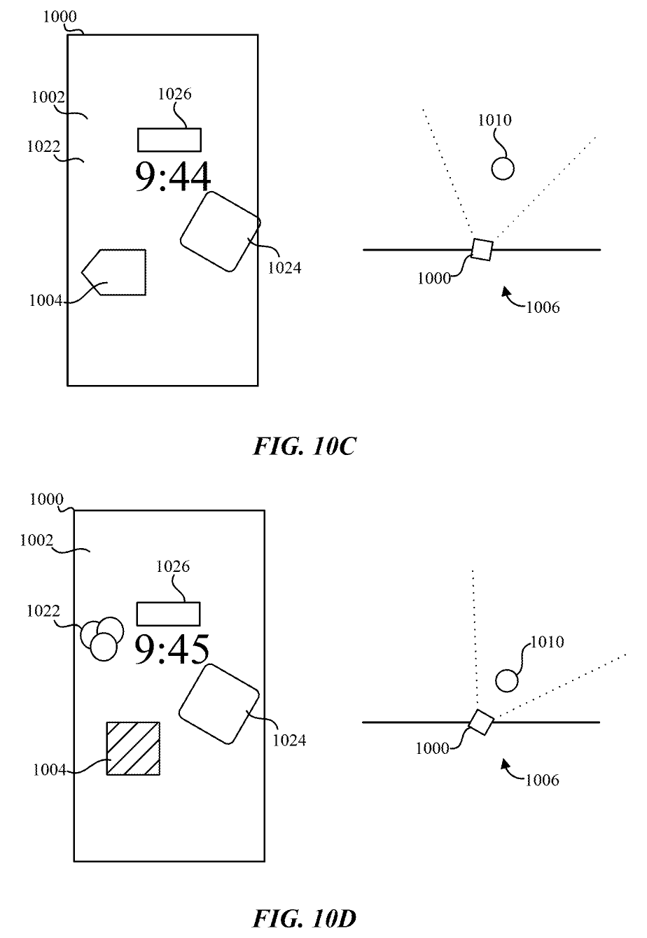

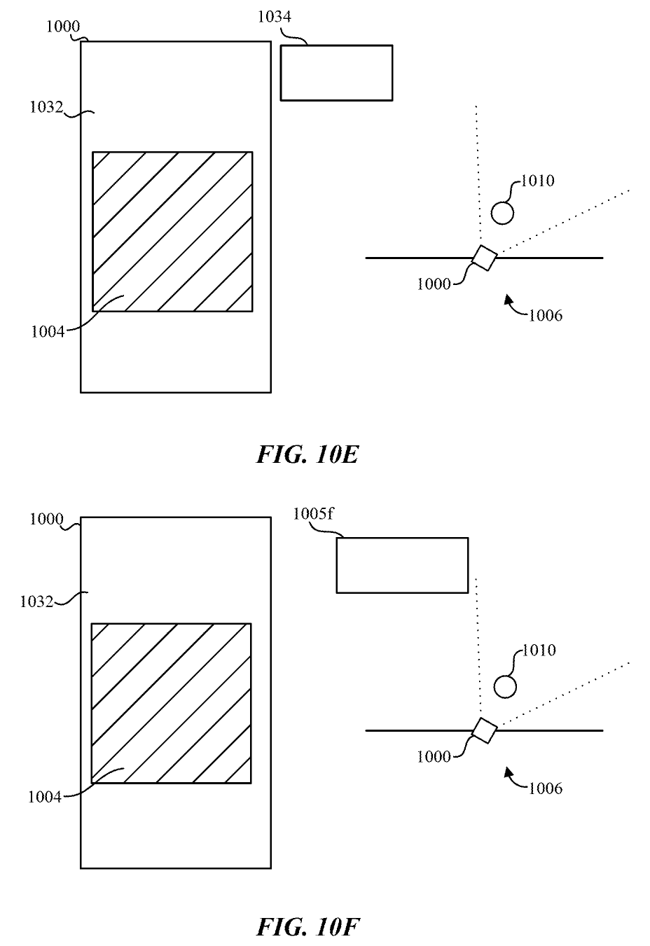

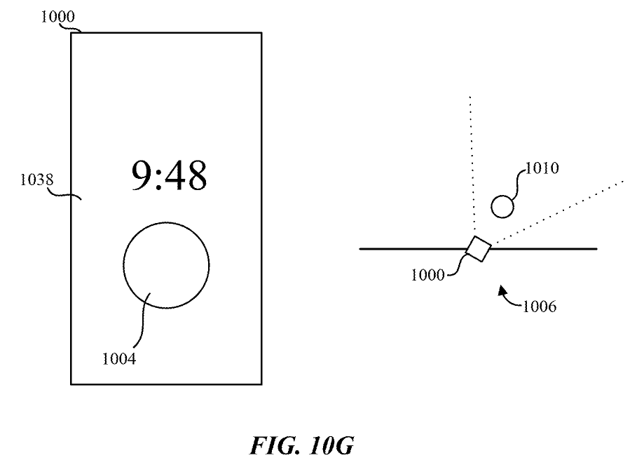

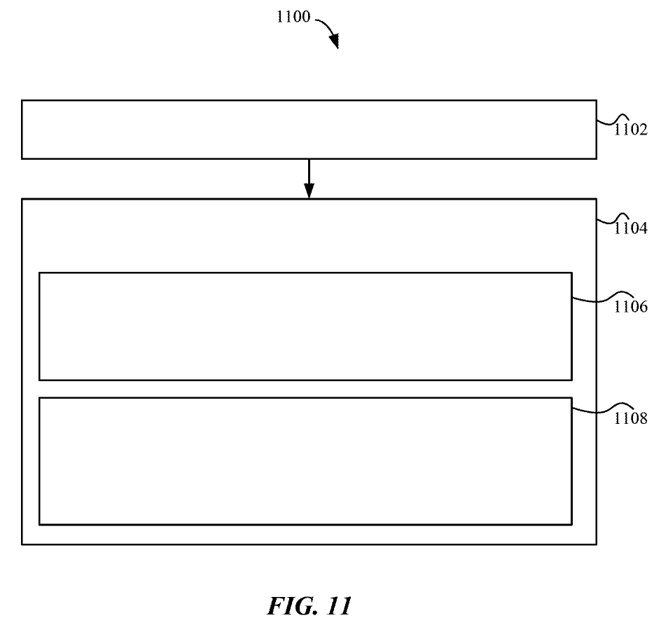

FIGS. 10A-10G illustrate exemplary user interfaces for changing modality of output in accordance with some embodiments. The user interfaces in these figures are used to illustrate the processes described below, including the process in FIG. 11.

FIGS. 10A-10G illustrate computer system 1000 as a smartphone. It should be recognized that computer system 1000 can be other types of computer systems such as a tablet, a smart watch, a laptop, a communal device, a smart speaker, an accessory, a personal gaming system, a desktop computer, a fitness tracking device, and/or a head-mounted display (HMD) device. In some embodiments, computer system 1000 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 1000 includes and/or is in communication with one or more output devices (e.g., a display screen, a projector, a touch-sensitive display, a speaker, and/or a movement component). In some embodiments, computer system 1000 includes one or more components and/or features described above in relation to computer system 100 and/or electronic device 200. In some embodiments, computer system 1000 is, includes, implements, and/or is in communication with one or more agent systems as described above with reference to FIG. 5 (e.g., referred to as “the agent” below).

While the examples in FIGS. 10A-10G include computer system 1000 detecting one or more verbal inputs, it should be recognized that such inputs are merely for explanatory purposes and that such inputs can be other types of inputs such as touch inputs via one or more touch-sensitive surfaces, physical inputs via one or more physical input mechanisms, and/or air-gesture inputs via one or more cameras. In some embodiments, inputs detected by computer system 1000 are passive inputs that are not purposefully directed at computer system 1000 by a subject (e.g., a person, an animal, an object, and/or a device). Examples of such inputs include, but are not limited to, motion of a subject through the environment, location of a subject within the environment, direction that a subject is facing and/or looking, light levels within the environment, and/or sound levels within the environment. In some embodiments, computer system 1000 includes and/or is in communication with one or more movement components (e.g., an actuator, a moveable base, a rotatable component, and/or a rotatable base) that can be used to change a position (e.g., location and/or orientation) of computer system 1000 and/or a portion (e.g., including one or more sensors, input components, and/or output components) of computer system 1000, as described above with reference to FIG. 5.

FIGS. 10A-10G are split between a left side and a right side. The right side illustrates a top-down schematic view of physical environment 1006 that includes computer system 1000 and subject 1010 (e.g., referred to below as Jane). FIG. 10A illustrates Jane from a top-down perspective with an oval representing Jane’s shoulders and a circle representing Jane’s head. At FIG. 10A, Jane is facing away from computer system 1000, a position which is illustrated by the circle being positioned farther from computer system 1000 than the oval. The top-down schematic view includes a field-of-view of one or more cameras of computer system 1000 (represented by the dotted lines casting away from computer system 1000). It should be recognized that physical environment 1006 can be different types of physical environments, such as a space for living, work, education, and/or entertainment. For example, physical environment 1006 can be a home, such as a house or apartment, or a space within that home, such as a kitchen, a living room, and/or a dining room. For another example, physical environment 1006 can be an office building or a space within the office building, such as an entry, a lobby, a meeting room, and/or a private office. The left side of FIGS. 10A-10G illustrate output of computer system 1000. While FIGS. 10A-10G illustrate computer system 1000 outputting particular content, it should be recognized that such content is merely for explanatory purposes and that such content can be in different forms, at different locations, at different sizes, include different content, and/or that more, fewer, and/or different content can be output in accordance with techniques described herein.

At FIG. 10A, computer system 1000 is in a standby state and displaying information user interface 1002. In some embodiments, the standby state of computer system 1000 is a state in which computer system 1000 performs one or more detections and/or a state in which computer system 1000 actively awaits inputs and/or commands from a user. As illustrated in FIG. 10A, while in the standby state, computer system 1000 displays information user interface 1002 with agent representation 1004, which is a visual representation of the agent, and a user interface element indicating current time (e.g., 9:40). As illustrated in FIG. 10A, computer system 1000 displays agent representation 1004 as a simple geometric shape (e.g., an arrow). It should be recognized that computer system 1000 can display agent representation 1004 as a different form, such as a waveform, an outline of a user interface, a border of a user interface, a glow on an exterior of a user interface, an avatar, or a face (e.g., including eyes, eyebrows, a nose, and/or a mouth).

In some embodiments, if computer system 1000 displays agent representation 1004 as a waveform, computer system 1000 displays the waveform as various colors and/or shapes moving based on an audio output in such a way that it appears as if the intonation of the audio output is synced with agent representation 1004. In some embodiments, if computer system 1000 displays agent representation 1004 as a face, computer system 1000 displays the eyes, eyebrows, nose, and/or mouth of agent representation 1004 as moving based on the audio output in such a way that it appears as if the audio output is coming from agent representation 1004. In such embodiments, computer system 1000 syncs movement of the mouth of agent representation 1004 with the audio output to give the impression that the agent is speaking. In some embodiments, computer system 1000 displays agent representation 1004 as moving at a time that computer system 1000 detects an audio input. For example, if computer system 1000 displays agent representation 1004 as a waveform, computer system 1000 can display the waveform based on one or more characteristics of the audio input. For another example, if computer system 1000 displays agent representation 1004 as a face, computer system 1000 can display the eyes of agent representation 1004 looking toward a location corresponding to a source of the audio input.

At FIG. 10A, while displaying information user interface 1002, computer system 1000 detects Jane is farther than a first threshold distance (e.g., 10 – 50 feet) away from computer system 1000 and that Jane is not looking at computer system 1000. In some embodiments, computer system 1000 detecting a position (e.g., a location and/or an orientation) of Jane includes detecting Jane via a sensor connected to and/or in communication with computer system 1000. For example, computer system 1000 can detect Jane via a camera of computer system 1000. For another example, computer system 1000 can detect Jane via a camera in communication with computer system 1000, such as a camera that is part of another computer system within physical environment 1006. For yet another example, computer system 1000 can detect Jane via motion sensor that is connected to and/or in communication with computer system 1000. In some embodiments, computer system 1000 detecting Jane includes detecting a personal device (e.g., a smartphone, tablet, and/or smartwatch) associated with Jane. For example, computer system 1000 can detect Jane by detecting a smartwatch of Jane via a Bluetooth and/or Ultra-Wideband signal of the smartwatch. For another example, computer system 1000 can detect a distance of Jane from computer system 1000 by detecting a distance of the personal device from computer system 1000 via a signal of the personal device. In some embodiments, computers system 1000 detects a direction Jane is looking via a camera connected to and/or in communication with computer system 1000. For example, a camera on computer system 1000 can detect that Jane is not facing computer system 1000 and determine that Jane is not looking at computer system 1000.

At FIG. 10A, based on Jane being farther than the first threshold distance away from computer system 1000 and/or that Jane is not looking at computer system 1000, a determination is made that there is a first level of likelihood that Jane will interact with computer system 1000. In some embodiments, a determination of the likelihood that Jane (or another subject) will interact with computer system 1000 is based on if Jane (or the other subject) is detected within the first threshold distance from computer system 1000. For example, if Jane is detected within the first threshold distance, a determination of a higher likelihood that Jane will interact with computer system 1000 can be made than when Jane is detected outside of the first threshold distance. In some embodiments, a determination of the likelihood that Jane (or another subject) will interact with computer system 1000 is based on a detected attention of Jane (or the other subject), including whether Jane is directing towards and/or looking at computer system 1000. For example, if computer system 1000 detects Jane looking at computer system 1000, computer system 1000 can determine a higher likelihood that Jane will interact with computer system 1000 than when detecting that Jane is not looking at computer system 1000. In some embodiments, a determination of the likelihood that Jane will interact with computer system 1000 is based on a combination of the detected distance of Jane and an amount of detected attention that Jane is directing towards computer system 1000. For example, if computer system 1000 detects Jane is within the first threshold distance from computer system 1000 and that Jane is looking at computer system 1000, computer system 1000 can determine a higher likelihood that Jane will interact with computer system 1000 than when computer system 1000 detects Jane is looking at computer system 1000 while farther than the first threshold distance from computer system 1000.

At FIG. 10A, in response to the determination that there is the first level of likelihood that Jane will interact with computer system 1000, computer system 1000 displays user interface elements that correspond to generalized (e.g., not personalized) information and/or content within information user interface 1002. As illustrated in FIG. 10A, computer system 1000 displays user interface elements score indicator 1014, which indicates a score of a recent game, and weather indicator 1016, which indicates a current temperature and weather condition (e.g., 82 degrees and cloudy) where computer system 1000 is located. Score indicator 1014 and weather indicator 1016 correspond to general information that is not personalized to a particular subject or group of subjects. In some embodiments, score indicator 1014 corresponds to information obtained via an application on computer system 1000 and/or a notification received by computer system 1000. For example, computer system 1000 can display score indicator 1014 due to receiving a notification of sports scores from a news organization. For another example, computer system 1000 can display score indicator 1014 due to a sports feed application on computer system 1000 providing computer system 1000 with the score within score indicator 1014. In some embodiments, weather indicator 1016 corresponds to information obtained via an application on computer system 1000 and/or a notification received by computer system 1000. For example, computer system 1000 can display weather indicator 1016 due to current weather information provided by a weather application on computer system 1000. For another example, computer system 1000 can display weather indicator 1016 due to recently receiving a notification from a local weather service.

It should be recognized that computer system 1000 can display more, less, and/or different user interface elements within information user interface 1002 than the ones illustrated within FIG. 10A. In some embodiments, computer system 1000 displays user interface elements associated with available applications (e.g., on computer system 100 and/or accessible by computer system 1000), functions (e.g., device functionality, functionality provided by another computer system, and/or functionality exposed by a web server and/or an application server), and/or sources of information (e.g., storage mediums of computer system 1000, storage mediums of another computer system that is accessible by computer system 1000, web-based sources of information, and/or sources of information exposed by a remote computer system). For example, computer system 1000 can display sports information, news information, media content (e.g., music, videos, images, and/or other forms of audio visual content), user information (e.g., Jane and/or another user that shares information with Jane), device information, and/or general information. In some embodiments, computer system 1000 displays relevant user interface elements within information user interface 1002. For example, computer system 1000 displays different user interface elements to different users, at different times, and/or with different user interface elements (e.g., computer system 1000 displays different user interface elements based on currently, previously, and/or to be displayed user interface elements). For example, computer system 1000 can display a music user interface element along with a recipe user interface element since Jane likes to listen to music while cooking. In some embodiments, computer system 1000 displays user interface elements that belong to a category of information within information user interface 1002. For example, computer system 1000 can display one or more user interface elements from a common category of information, such as user interface elements for different sport games, user interface elements for different music streaming applications, and/or user interface elements for different users coming to a party. In some embodiments, computer system 1000 displays user interface elements within user interface 1002 based on Jane’s activity with computer system 1000. For example, computer system 1000 can display user interface elements within information user interface 1002 based on Jane’s previous requests to computer system 1000 (e.g., computer system 1000 displays weather indicator 1016 before displaying score indicator 1014 due to Jane previously asking for the weather before a sport score). For another example, computer system 1000 can display different user interface elements together based on Jane’s previous requests (e.g., computer system 1000 displays weather information along with traffic information based on Jane previously requesting weather information for her commute and/or computer system 1000 displays music information and a recommended recipe information when Jane gets home based on Jane previously requesting the combination of information when she gets home from work). In some embodiments, computer system 1000 displays category selection user interface elements before displaying specific user interface elements to allow Jane to select a category of information. For example, computer system 1000 can display a music user interface element, a sports user interface element, a travel user interface element, and/or a news user interface element based on Jane routinely accessing the different categories of information.

In some embodiments, computer system 1000 displays user interface elements based on a current context (e.g., time, date, and/or context detected by computer system 1000). For example, due to the current date and weather, computer system 1000 can display weather indicator 1016 along with a user interface element corresponding to a local event happening that day and/or a user interface element corresponding to an upcoming national holiday. For another example, computer system 1000 can display seasonal shapes, such as leaves, haystacks, and pumpkins for fall. For yet another example, based on detecting party decorations in physical environment 1006, computer system 1000 can display information user interface 1002 with user interface elements corresponding to party situations, such as elements that resemble party hats and streamers as well as a user interface element corresponding to a local bakery that sells cake. In some embodiments, computer system 1000 displays a category of content within information user interface 1002 based on the current context. For example, computer system 1000 displays weather indicator 1016 along with other weather indicators without displaying score indicator 1014 based on the current context. For another example, computer system 1000 displays score indicator 1014 along with another score indicator for a different sport based on Jane’s interest in both sports and/or active games. Further, it should be recognized that the current context can change over time. In some embodiments, computer system 1000 alters what user interface elements are displayed within information user interface 1002 over a period of time. For example, five minutes after displaying score indicator 1014 and weather indicator 1016, computer system 1000 can display a user interface element corresponding to a news headline and a user interface element corresponding to an upcoming national holiday.

In some embodiments, computer system 1000 displays user interface elements based on a previous context (e.g., Jane’s previous activity with computer system 1000, previous events, and/or previously displayed user interface elements within information user interface 1002). For example, computer system 1000 can display score indicator 1014 and weather indicator 1016 based on Jane previously asking computer system 1000 to display the user interface elements. For another example, computer system 1000 can display score indicator 1014 and then weather indicator 1016 (e.g., once score indicator 1014 has been viewed and/or based on a predetermined amount of time passing since displaying score indicator 1014) based on Jane previously viewing the user interface elements and/or causing the same or similar user interface elements to be displayed in that order. In some embodiments, computer system 1000 displays a category of user interface elements within information user interface 1002 based on the previous context. For example, computer system 1000 can display score indicator 1014 and another score indicator (e.g., for another sport and/or for another game) based on Jane previously asking for the user interface elements together and/or within a threshold amount of time (e.g., within a common interaction with computer system 100 and/or within a common request for information). For another example, computer system 1000 can display weather indicator 1016 and other daily information user interface elements based on Jane previously requesting the user interface elements at a certain time every day (e.g., Jane asks for the weather and traffic information in the morning and/or Jane asks for weather and air quality information before her run in the afternoon).

At FIG. 10A, in response to the determination that there is the first level of likelihood that Jane will interact with computer system 1000, computer system 1000 displays agent representation 1004 directed at a user interface object within information user interface 1002. As illustrated in FIG. 10A, computer system 1000 displays agent representation 1004 as directed in the direction of score indicator 1014 by having the point of the arrow of agent representation 1004 pointing towards score indicator 1014. In some embodiments, computer system 1000 displays agent representation 1004 as indicating in a direction other than towards score indicator 1014. For example, computer system 1000 can display agent representation 1004 as pointing towards the time indicator. For another example, computer system 1000 can display agent representation as pointing towards an object within physical environment 1006, such as a lamp, door, window, pet, set of keys, and/or book. It should be recognized that computer system 1000 can display agent representation 1004 as directed in a direction in manners other than having the point of the arrow of agent representation 1004 pointing in a direction. For example, computer system 1000 can animate agent representation 1004 as moving back and forth in the direction of score indicator 1014. For another example, when computer system 1000 is displaying agent representation 1004 as having facial features, computer system 1000 can display agent representation 1004 as looking at score indicator 1014. In some embodiments, computer system 1000 displays agent representation 1004 as indicating in multiple directions over a period of time. For example, after displaying agent representation 1004 as pointing at score indicator 1014, computer system 1000 can display agent representation 1004 as pointing at weather indicator 1016. For another example, after displaying agent representation 1004 as pointing at score indicator 1014, computer system 1000 can display agent representation 1004 as pointing at a book on a table in physical environment 1006.

At FIG. 10A, in response to the determination that there is the first level of likelihood that Jane will interact with computer system 1000, computer system 1000 displays agent representation 1004 as having a neutral expression, as illustrated by agent representation being illustrated without shading or hatchings. In some embodiments, computer system 1000 displays agent representation 1004 as having a neutral expression in other ways including with a different color, shape, movement, and/or facial expression. For example, when displaying agent representation 1004 as a glow, computer system 1000 can display the glow with little to no movement and soft colors. For another example, when displaying agent representation 1004 as having facial features, computer system 1000 can display agent representation 1004 as having a neutral facial expression.

While computer system 1000 displays score indicator 1014 on the left side of information user interface 1002, weather indicator 1016 on the right side of information user interface 1002, and agent representation 1004 below score indicator 1014, it should be recognized that computer system 1000 can display score indicator 1014, weather indicator 1016, and/or agent representation 1004 at different positions within information user interface 1002. For example, computer system 1000 can display score indicator 1014 below agent representation 1004 and display weather indication 1016 above the time indicator. For another example, computer system 1000 can display agent representation 1004, score indicator 1014, and weather indicator 1016 above the time indicator. In some embodiments, computer system 1000 displays score indicator 1014, weather indicator 1016, and/or agent representation 1004 at different positions within information user interface 1002 over a period of time. For example, after displaying score indicator 1014, weather indicator 1016, and/or agent representation 1004 as illustrated in FIG. 10A, computer system 1000 can display weather indicator 1016 below agent representation 1004 and displays score indicator 1014 where weather indicator 1016 was formerly located, rotating agent representation 1004 to continue pointing at score indicator 1014. For another example, after displaying score indicator 1014, weather indicator 1016, and/or agent representation 1004 as illustrated in FIG. 10A, computer system 1000 can display agent representation 1004 as pointing weather indicator 1016 and display score indicator 1014 above the time indicator while continuing to display weather indicator at the current location. In some embodiments, computer system 1000 displays score indicator 1014, weather indicator 1016, and/or agent representation 1004 at different positions within information user interface 1002 over the period of time as part of displaying different user interface elements, as described above. For example, after displaying score indicator 1014, weather indicator 1016, and/or agent representation 1004 as illustrated in FIG. 10A, computer system 1000 can display score indicator 1014 above the time indicator, display weather indicator 1016 where score indicator 1014 was previously displayed and display a user interface element corresponding to an upcoming national holiday where weather indicator 1016 was previously displayed. For another example, after displaying score indicator 1014, weather indicator 1016, and/or agent representation 1004 as illustrated in FIG. 10A, computer system 1000 can replace score indicator 1014 with a user interface element depicting a local news headline after replacing weather indicator 1016 with a user interface element depicting a symbol of a current season. In some embodiments, displaying a user interface element in a different position includes computer system 1000 displaying an animation. For example, computer system 1000 can animate a user interface element as sliding from one position to another position. For another example, computer system 1000 can animate a user interface element as fading out (e.g., decreasing opacity) from one position and fading in (e.g., increasing opacity) to another position. Further, it should be recognized that the display of user interface elements by computer system 1000 can be used to tailor Jane’s experience. In some embodiments, computer system 100 displays the user interface elements in order based on Jane’s interaction with the user interface element. For example, computer system 1000 shows score indicator 1014 on the screen before weather indicator 1016 in order to depict that Jane’s request for the sports information came before the request for the weather. For another example, computer system 1014 can display score indicator 1014 without display weather indicator 1016 until Jane interacts with score indicator 1014 to give Jane time to view the score information before moving on to the weather information.

At FIG. 10B, while displaying information user interface 1002, computer system 1000 detects Jane is (e.g., Jane moves to be) within the first threshold distance away from computer system 1000 and that Jane is not looking at computer system 1000. In some embodiments, computer system 1000 detects Jane is within the first threshold distance away from computer system 1000 using the same method as detecting Jane is farther than the first threshold distance from computer system 1000. For example, computer system 1000 can detect the position of Jane via a camera included in and/or in communication with computer system 1000 when Jane is farther than and when Jane is within the first threshold distance from computer system 1000. For another example, computer system 1000 can detect the position of Jane by detecting a position of a personal device associated with Jane when Jane is farther than and when Jane is within the first threshold distance from computer system 1000. In some embodiments, computer system 1000 detects Jane is within the first threshold distance away from computer system 1000 using a different method than the method used detecting Jane is farther than the first threshold distance away from computer system 1000. For example, computer system 1000 can detect the position of Jane via a motion detector in communication with computer system 1000 when Jane is farther than the first threshold distance from computer system 1000 and computer system 1000 can detect the position of Jane via a camera of computer system 1000 when Jane is within the first threshold distance from computer system 1000. For another example, computer system 1000 can detect the position of Jane via a camera included in and/or in communication with computer system 1000 when Jane is farther than the first threshold distance from computer system 1000, and computer system 1000 can detect the position of Jane by detecting the position of a personal device associated with Jane.

At FIG. 10B, while displaying information user interface 1002, computer system 1000 identifies Jane. In some embodiments, computer system 1000 identifies Jane using biometric information detected via one or more sensors included in and/or in communication with computer system 1000 and compared to biometric information of known users. For example, computer system 1000 can identify Jane via voice recognition data detected via a microphone and/or facial recognition data detected via a camera. For another example, computer system 1000 identifies Jane via a fingerprint scan done on a personal device associated with Jane. In some embodiments, computer system 1000 identifies Jane via identifying a personal device associated with Jane. For example, computer system 1000 can identify Jane by detecting and identifying the smartwatch worn by Jane as being associated with Jane. For another example, when no other subjects are present, computer system 1000 can identify Jane by identifying a smartphone used to unlock a door of physical environment 1006 as being associated with Jane. In some embodiments, computer system 1000 identifies Jane via pass code verification. For example, computer system 1000 can identify Jane by comparing a PIN entered earlier by Jane upon arriving at physical environment 1006 to a database of PIN codes of known users. For another example, computer system 1000 can identify Jane via Jane logging in to another computer system within physical environment 1006 that is in communication with computer system 1000. In some embodiments, computer system 1000 uses a combination of methods to identify and/or verify an identity of a subject. For example, computer system 1000 can identify a subject with a combination of biometrics, device identity, and/or passcode verification.

In some embodiments, computer system 1000 identifies Jane after Jane comes within the first threshold distance from computer system 1000. For example, computer system 1000 can identify Jane when Jane is close enough to be identified using facial recognition via a camera of computer system 1000. In some embodiments, computer system 1000 identifies Jane before Jane is within the first threshold distance from computer system 1000. For example, computer system 1000 can identify Jane using biometric information detecting via a camera and/or microphone in communication with computer system 1000 that is outside of the first threshold distance away from computer system 1000.

At FIG. 10B, in response to detecting Jane is within the first threshold distance away from computer system 1000 and/or that Jane is not looking at computer system 1000, a determination is made that there is a second level (e.g., a change from the first level to a second level) of likelihood that Jane will interact with computer system 1000, which is higher level than the first level of likelihood that Jane will interact with computer system 1000. As illustrated in FIG. 10B, in response to the determination that there is the second level of likelihood that Jane will interact with computer system 1000 and because computer system 1000 identified Jane, computer system 1000 displays user interface elements corresponding to Jane (e.g., personalized user interface elements) within information user interface 1002. As illustrated in FIG. 10B, computer system 1000 displays balloon object 1022 and music object 1024 within information user interface 1002 and no longer displays score indicator 1014 or weather indicator 1016. In some embodiments, balloon object 1022 corresponds to information obtained via an application of computer system 1000 and/or a notification received by computer system 1000. For example, computer system 1000 can display balloon object 1022 due to receiving a text message congratulating Jane on a promotion. For another example, computer system 1000 can display balloon object 1022 due to a calendar application on computer system 1000 having a birthday party scheduled in the near future while logged into an account associated with Jane. For yet another example, computer system 1000 can display balloon object 1022 due to detecting balloons within physical environment 1006. In some embodiments, music object 1024 corresponds to information obtained via an application on computer system 1000 and/or a notification received by computer system 1000. For example, computer system 1000 can display music object 1024 due to a music application of computer system 1000 recently planning music while logged into an account associated with Jane. For another example, computer system 1000 can display music object 1024 due to an email within email account associated with Jane including tickets for an upcoming concert. Also illustrated in FIG. 10B, computer system 1000 displays Jane identifier 1026 to indicate that displayed user interface objects correspond to Jane. While computer system 1000 displays Jane identifier 1026 as text (e.g., “for Jane”) above the time indicator within information user interface 1002, computer system 1000 can display Jane identifier 1026 as a different form of identifier and/or at a different location within information user interface 1002. For example, computer system 1000 can display Jane identifier 1026 as a pictorial representation of Jane, such as a picture or caricature of Jane, along to the bottom edge of user interface. For another example, computer system 1000 can display Jane identifier 1026 as symbol preselected by Jane, such as an outline of a chess piece, as the background of information user interface 1002.

In some embodiments, computer system 1000 displays balloon object 1022 and/or music object 1024 after ceasing display of score indicator 1014 and/or weather indicator 1016. For example, computer system 1000 can animate score indicator 1014 and weather indicator 1016 sliding off the side of information user interface 1002 before animating balloon object 1022 and music object 1024 sliding on to information user interface 1002. For another example, computer system 1000 can fade in balloon object 1022 after fading out score indicator 1014 and before fading out weather indicator 1016 and fading in music object 1024. In some embodiments, computer system 1000 displays balloon object 1022 and/or music object 1024 before ceasing display of score indicator 1014 and/or weather indicator 1016. For example, while displaying score indicator 1014 and weather indicator 1016, computer system 1000 can fade in balloon object 1022 and music object 1024, temporarily displaying all four user interface elements before fading out score indicator 1014 and weather indicator 1016. For another example, computer system 1000 can animate music object 1024 as sliding on to information user interface 1002 before animating weather indicator 1016 as sliding off the side of information user interface 1002.

It should be recognized that computer system 1000 can display more, less, and/or different user interface elements than the ones illustrated in FIG. 10B. For example, computer system 1000 can display a user interface element indicating the number of days until an event, such as a vacation, Jane saved on a calendar application. For another example, in addition to the user interface elements illustrated in FIG. 10B, computer system 1000 can display a user interface element that includes an update from a friend on a social media application. For yet another example, based on detecting a bicycle (not illustrated) in physical environment 1006, computer system 1000 can display a user interface element corresponding to nearby bike paths.

At FIG. 10B, in response to the determination that there is the second level of likelihood that Jane will interact with computer system 1000, computer system 1000 continues to display agent representation 1004 as having a neutral expression and as indicating towards a user interface object within information user interface 1002. As illustrated in FIG. 10B, computer system 1000 displays agent representation 1004 as pointing at music object 1024. In some embodiments, computer system 1000 displays agent representation 1004 as pointing in a direction other than towards music object 1024. For example, computer system 1000 can display agent representation 1004 as pointing at balloon object 1022. For another example, computer system 1000 can display agent representation 1004 as pointing at painting on the wall within physical environment 1006. In some embodiments, computer system 1000 displays agent representation 1004 as pointing in different directions over a period of time. For example, after displaying agent representation 1004 as pointing at music object 1024, computer system 1000 can display agent representation 1004 as pointing at Jane identifier 1026. For another example, after displaying agent representation 1004 as pointing at music object 1024, computer system 1000 can display agent representation 1004 as pointing at a window in physical environment 1006.

In some embodiments, computer system 1000 displays agent representation 1004 with the same neutral expression when there is the determination that there is the first level of likelihood that Jane will interact with computer system 1000 and when there is the determination that there is the second level of likelihood that Jane will interact with computer system 1000. For example, computer system 1000 can display agent representation 1004 as a shape with the same color when there is the determination that there is the first level of likelihood that Jane will interact with computer system 1000 and when there is the determination that there is the second level of likelihood that Jane will interact with computer system 1000. For another example, if computer system 1000 is displaying agent representation 1004 as having facial features, computer system 1000 can display agent representation 1004 with a flat mouth and slightly raised eyebrows for when there is the determination that there is the first level of likelihood that Jane will interact with computer system 1000 and when there is the determination that there is the second level of likelihood that Jane will interact with computer system 1000. In some embodiments, in response to the determination that there is the second level of likelihood that Jane will interact with computer system 1000, computer system 1000 displays agent representation 1004 with a different neutral expression than when there was the determination that there was the first level of likelihood that Jane will interact with computer system 1000. For example, if computer system 1000 displays agent representation 1004 as a wave form, computer system 1000 can display agent representation 1004 as a linear waveform when there is the determination that there is the first level of likelihood that Jane will interact with computer system 1000 and can display agent representation 1004 as a circular waveform when there is the determination that there is the second level of likelihood that Jane will interact with computer system 1000, while maintaining the same amplitude, color, and/or brightness for both forms. For another example, if computer system 1000 is displaying agent representation 1004 as having facial features, computer system 1000 can display agent representation 1004 with a flat mouth and slightly raised eyebrows for when there is the determination that there is the first level of likelihood that Jane will interact with computer system 1000 and can display agent representation 1004 with a neutral smile when there is the determination that there is the second level of likelihood that Jane will interact with computer system 1000.

In some embodiments, computer system 1000 displays different user interface elements in response to detecting a different subject within the first threshold distance away from computer system 1000. For example, in response to detecting and identifying Marisa and not Jane, instead of displaying user interface elements corresponding to Jane within information user interface 1002, computer system 1000 can display user interface elements corresponding to Marisa, such as user interface element that indicates the other user interface elements as corresponding to Marisa, a user interface element that is a photo of Marisa’s dog, and/or a user interface element that includes Marisa’s best 5K running time. For another example, in response to detecting an unidentified subject within the first threshold distance, computer system 1000 can continue to display information user interface 1002 with user interface elements corresponding to generalized information, as described above with reference to FIG. 10A.

In some embodiments, to protect personalized content of a user, computer system 1000 displays user interface elements corresponding to generalized information in response to detecting multiple subjects. For example, in response to detecting an additional subject along with Jane within the first threshold distance away from computer system 1000, computer system 1000 displays user interface elements corresponding to generalized information and/or content within information user interface 1002, as described above with reference to FIG. 10A. In some embodiments, in response to detecting multiple identified subjects, computer system 1000 displays user interface elements corresponding to the multiple identified users. For example, in response to detecting and identifying Jane and Marisa within the first threshold distance from computer system 1000, computer system 1000 can display user interface elements corresponding to joint interests of Jane and Marisa, such as a user interface element corresponding to a book signing event that is on the calendars for both Jane and Marisa. For another example, in response to detecting and identifying Jane and Marisa within the first threshold distance from computer system 1000, computer system 1000 can display a mix of user interface elements corresponding to Jane and user interface elements corresponding to Marisa, such as balloon object 1022 and the user interface element that is a photo of Marisa’s dog.

At FIG. 10B, computer system 1000 detects that Jane is not centered within the field-of-view of computer system 1000 and, due to the determination that there is a second level of likelihood that Jane will interact with computer system 1000, computer system 1000 does not move the portion of computer system 1000 to center Jane within the field-of-view. In some embodiments, in response to detecting that Jane is centered within the field-of-view and the determination that there is a second level of likelihood that Jane will interact with computer system 1000, computer system 1000 moves the portion of computer system, 1000 so that Jane is no longer detected as centered within the field-of-view of computer system 1000. For example, in response to detecting that Jane is centered within the field-of-view of computer system 1000 while there is the second level of likelihood that Jane will interact with computer system 1000, computer system 1000 can move the portion of computer system 1000 to the left so that Jane is within but no longer centered within the field-of-view of computer system 1000 and so that information user interface 1002 is not facing Jane directly.

At FIG. 10C, while displaying information user interface 1002, computer system 1000 detects Jane is looking at computer system 1000 while Jane is within the first threshold distance away from computer system 1000. At FIG. 10C, in response to detecting that Jane is within the first threshold distance away from computer system 1000 and is looking at computer system 1000, a determination is made that there is a third level (e.g., a change from the second level to a third level) of likelihood that Jane will interact with computer system 1000, which is a higher level than the second level and/or the first level of likelihood that Jane will interact with computer system 1000.

At FIG. 10C, in response to the determination that there is the third level of likelihood that Jane will interact with computer system 1000, computer system 1000 moves the portion of computer system 1000 in the direction of Jane so that Jane has a better view of information user interface 1002 but not enough that information user interface 1002 is facing Jane head on, as illustrated by Jane not being centered within the field-of-view of computer system 1000. In some embodiments, in response to the determination that there is the third likelihood that Jane will interact with computer system 1000 and in response to detecting Jane moving within physical environment 1006, computer system 1000 moves the portion of computer system 1000 to maintain that Jane has a view of information user interface 1002 without keeping Jane centered within the field-of-view of computer system 1000. For example, if computer system 1000 detects Jane move to the side, computer system 1000 can move the portion of computer system 1000 at the same pace as Jane to keep Jane at the same position within the field-of-view of computer system 1000.

As illustrated in FIG. 10C, in response to the determination that there is the third level of likelihood that Jane will interact with computer system 1000, computer system 1000 displays agent representation 1004 as pointing towards Jane while continuing to display agent representation 1004 as having a neutral expression. Since computer system 1000 is not centered within the field-of-view of computer system 1000, to display agent representation 1004 as pointing towards Jane, computer system 1000 displays agent representation 1004 as pointing to the side in the direction of Jane. It should be recognized that computer system 1000 can display agent representation 1004 in other manners to point towards Jane. For example, when computer system 1000 displays agent representation 1004 as a glow on an exterior of a user interface, computer system 1000 can display the glow of agent representation 1004 as concentrated and/or brighter on at the spot closest to Jane. For another example, when computer system 1000 displays agent representation 1004 as having facial features, computer system 1000 can display agent representation 1004 as if agent representation 1004 is looking at Jane. In some embodiments, computer system 1000 displays agent representation 1004 with the same neutral expression when there is the determination that there is the second level of likelihood that Jane will interact with computer system 1000 and when there is the determination that there is the third level of likelihood that Jane will interact with computer system 1000, as described above with relation to FIG. 10B. In some embodiments, in response to the determination that there is the third level of likelihood that Jane will interact with computer system 1000, computer system 1000 displays agent representation 1004 with a different neutral expression than when there was the determination that there was the second level of likelihood that Jane will interact with computer system 1000, as described above with relation to FIG. 10B.

In some embodiments, in response to the determination that there is the third likelihood that Jane will interact with computer system 1000, computer system 1000 displays different user interface elements than the ones illustrated in FIG. 10C. For example, in response to the determination that there is a third likelihood that Jane will interact with computer system 1000, computer system 1000 can display user interface elements corresponding to requests from Jane, such as user interface elements corresponding to reminders or search requests. For another example, computer system 1000 can display the next user interface elements in a list of user interface elements that correspond to Jane, such as described above with reference to FIG. 10B.

At FIG. 10D, while displaying information user interface 1002, computer system 1000 detects Jane is (e.g., Jane moves to be) within a second threshold distance (e.g., 0-15 feet) away from computer system 1000 and that Jane is looking at computer system 1000. At FIG. 10D, the second threshold distance is closer to computer system 1000 than the first threshold distance. At FIG. 10D, in response to detecting that Jane is within the second threshold distance away from computer system 1000 and that Jane is looking at computer system 1000, a determination is made that there is a fourth level (e.g., a change from the third level to a fourth level) of likelihood that Jane will interact with computer system 1000, which is a higher level of likelihood than the third, the second, and/or the first level of likelihood that Jane will interact with computer system 1000.

As illustrated in FIG. 10D, in response to the determination that there is the fourth level of likelihood that Jane will interact with computer system 1000, computer system 1000 moves the portion of computer system 1000 in the direction of Jane so that information user interface 1002 is facing Jane head on, as illustrated by Jane being centered within the field-of-view of computer system 1000. At FIG. 10D, in response to the determination that there is the fourth level of likelihood that Jane will interact with computer system 1000, computer system 1000 continues to display agent representation 1004 as pointing towards Jane and, since information user interface 1002 is facing Jane head on, computer system 1000 displays agent representation 1004 as facing forward. As illustrated in FIG. 10D, to display agent representation 1004 as facing forward, computer system 1000 displaying agent representation 1004 as a square. For example, if computer system 1000 displays agent representation 1004 as a glow on an exterior of a user interface, computer system 1000 can display the glow as evenly distributed around the exterior of the user interface. For another example, if computer system 1000 displays agent representation 1004 as a face, computer system 1000 can display the eyes of agent representation 1004 as looking forward.

At FIG. 10D, in response to the determination that there is the fourth level of likelihood that Jane will interact with computer system 1000, computer system 1000 displays agent representation 1004 with an expression other than neutral, as indicated by agent representation 1004 being illustrated with diagonal line hatchings, as way of indicating to Jane that agent representation 1004 is acknowledging the presence of Jane. In some embodiments, displaying agent representation 1004 with an expression other than neutral includes displaying agent representation 1004 with a different color, shape, movement, and/or facial expression. For example, if computer system 1000 displays agent representation 1004 as a glow with little to no movement when displaying agent representation 1004 as having a neutral expression, computer system 1000 can display agent representation 1004 as a glow with a rippling movement when displaying agent representation 1004 as having a non-neutral (e.g., an expression other than a neutral expression). For another example, if computer system 1004 displays agent representation 1004 as having a neutral facial expression when displaying agent representation 1004 as having a neutral expression, computer system 1000 can display agent representation 1004 as smiling when displaying agent representation 1004 as having a non-neutral expression.

In some embodiments, in response to the determination that there is the fourth likelihood that Jane will interact with computer system 1000, computer system 1000 displays different user interface elements than the ones illustrated in FIG. 10D. For example, in response to the determination that there is the fourth likelihood that Jane will interact with computer system 1000, computer system 1000 can display user interface elements corresponding to requests from Jane, such as user interface elements corresponding to reminders or search requests. For another example, computer system 1000 can display the next user interface elements in a list of user interface elements that correspond to Jane, such as described above with reference to FIG. 10B.

At FIG. 10E, computer system 1000 detects Jane continuing to look at computer system 1000 and detects Jane reaching towards computer system 1000. At FIG. 10E, in response to computer system 1000 detecting Jane continuing to look at and/or detecting Jane reaching towards computer system 1000 while detecting Jane within the second threshold distance away from computer system 1000, a determination is made that there is a fifth level (e.g., a change from the fourth level to a fifth level) of likelihood that Jane will interact with computer system 1000, which is a higher level of likelihood than the fourth, the third, the second, and/or the first level of likelihood that Jane will interact with computer system 1000. In some embodiments, while detecting Jane is within the second threshold distance away from computer system 1000, a determination is made that there is the fifth level of likelihood that Jane will interact with computer system 1000 in response to detected criteria other than Jane continuing to look at computer system 1000, such as a change in the facial expression of Jane, Jane leaning towards computer system 1000, and/or Jane gesturing towards computer system 1000. For example, a determination can be made that there is the fifth level of likelihood that Jane will interact with computer system 1000 in response to detecting Jane smile at computer system 1000 while detecting Jane is within the second threshold distance away from computer system 1000. For another example, a determination can be made that there is the fifth level of likelihood that Jane will interact with computer system 1000 in response to detecting Jane leaning forward towards computer system 1000 while detecting Jane is within the second threshold distance away from computer system 1000.

In some embodiments, the criteria on which a determination that there is the fifth level of likelihood that a subject will interact with computer system 1000 varies depending on which subject is detected. For example, while the determination is made that there is the fifth level of likelihood that Jane will interact with computer system 1000 in response to computer system 1000 detecting Jane continuing to look at and/or detecting Jane reaching towards computer system 1000 while detecting Jane within the second threshold distance away from computer system 1000, a determination can be made that there is the fifth level of likelihood that Mary will interact with computer system 1000 in response to detecting Mary within the second threshold distance away from computer system 1000 and detecting Mary looking at computer system 1000 continuously while crossing the second threshold distance to be closer to computer system 1000. For another example, a determination can be made that there is the fifth level of likelihood that John will interact with computer system 1000 in response to detecting John before he crosses the second threshold distance if computer system 1000 detects that John has his hands full (e.g., John is carrying objects, such as groceries, work supplies, sports gear, and/or luggage).

At FIG. 10E, in response to the determination that there is the fifth level of likelihood that Jane will interact with computer system 1000, computer system 1000 switches from the standby state to an active state. In some embodiments, the active state of computer system 1000 is a higher-power state, a state in which computer system 1000 performs one or more detections, a state in which computer system 1000 detects one or more inputs from a user, and/or a state in which computer system 1000 provides one or more outputs.

As illustrated in FIG. 10E, in response to the determination that there is the fifth level of likelihood that Jane will interact with computer system 1000, computer system 1000 displays agent user interface 1032, which is a user interface for interacting with the agent and visual representations of the agent. At FIG. 10E, as part of displaying agent user interface 1032, computer system 1000 ceases display of information user interface 1002.

As illustrated in FIG. 10E, in response to the determination that there is the fifth level of likelihood that Jane will interact with computer system 1000, computer system 1000 displays agent representation 1004 as occupying a majority of agent user interface 1032. At FIG. 10E, computer system 1000 displays agent representation 1004 as larger in response to the determination that there is the fifth level of likelihood that Jane will interact with computer system 1000 than in response to the determination that there as the fourth level that Jane will interact with computer system 1000. In some embodiments, computer system 1000 displays agent representation 1004 as larger as a reaction to agent representation 1004 being the sole user interface element within agent user interface 1032, allowing more room to display agent representation 1004.

As indicated by agent representation 1004 being illustrated with diagonal line hatching, in response to the determination that there is the fifth level of likelihood that Jane will interact with computer system 1000, computer system 1000 displays agent representation 1004 with a non-neutral expression. In some embodiments, computer system 1000 displays agent representation 1004 with the same non-neutral expression in response to the determination that there is the fifth level and the determination that there is the fourth level of likelihood that Jane will interact with computer system 1000. For example, computer system 1000 can display agent representation 1004 as a shape with the same color when there is the determination that there is the fourth level of likelihood that Jane will interact with computer system 1000 and when there is the determination that there is the fifth level of likelihood that Jane will interact with computer system 1000. For another example, if computer system 1000 is displaying agent representation 1004 as having facial features, computer system 1000 can display agent representation 1004 with a large grin for when there is the determination that there is the first level of likelihood that Jane will interact with computer system 1000 and when there is the determination that there is the second level of likelihood that Jane will interact with computer system 1000. In some embodiments, computer system 1000 displays agent representation 1004 with different non-neutral expressions in response to the determination that there is the fifth level and the determination that there is the fourth level of likelihood that Jane will interact with computer system 1000. For example, if computer system 1000 displays agent representation 1004 as a wave form, computer system 1000 can display agent representation 1004 as a single line waveform for when there is the determination that there is the fourth level of likelihood that Jane will interact with computer system 1000 and can display agent representation 1004 as a multiline waveform when there is the determination that there is the fifth level of likelihood that Jane will interact with computer system 1000, while maintaining. For another example, if computer system 1000 is displaying agent representation 1004 as having facial features, computer system 1000 can display agent representation 1004 with a grin for when there is the determination that there is the fourth level of likelihood that Jane will interact with computer system 1000 and can display agent representation 1004 with a large smile and head tilt when there is the determination that there is the fifth level of likelihood that Jane will interact with computer system 1000.

At FIG. 10E, in response to the determination that there is the fifth level of likelihood that Jane will interact with computer system 1000, computer system 1000 outputs audio 1034 which includes a greeting and an identity of a detected user (e.g., “Hi, Jane! Welcome home!”) as a way of greeting and informing Jane that computer system 1000 has acknowledged Jane as an active user. It should be recognized that computer system 1000 can greet and inform Jane in other ways, such as with a visual greeting and/or a different audio greeting. For example, in response to the determination that there is the fifth level of likelihood that Jane will interact with computer system 1000, computer system 1000 can output the audio “It is good to see you, Jane”. For another example, in response to the determination that there is the fifth level of likelihood that Jane will interact with computer system 1000, computer system 1000 can display the text “Welcome home”. For yet another example, in response to the determination that there is the fifth level of likelihood that Jane will interact with computer system 1000, computer system 1000 can display the text “Hi, Jane” while outputting audio 1034.

At FIG. 10E, the portion of computer system 1000 is positioned so that Jane is centered within the field-of-view of computer system 1000 so that agent user interface 1032 is facing Jane and computer system 1000 is displaying agent representation 1004 as pointing towards Jane. In some embodiments, if the portion of computer system 1000 was not positioned so Jane is centered within the field-of-view of computer system 1000 and/or computer system 1000 was displaying agent representation 1004 as pointing in a direction other than toward Jane, in response to the determination that there is the fifth level of likelihood that Jane will interact with computer system 1000, computer system 1000 can move the portion of computer system 1000 to place Jane at the center of the field-of-view of computer system 1000 and/or alter agent representation 1004 to be displayed as pointing toward Jane as a way to indicate to Jane that the agent is focused on Jane. In some embodiments, in response to detecting Jane move within physical environment 1006 during the determination that there is the fifth level of likelihood that Jane will interact with computer system 1000, computer system 1000 can move the portion of computer system 1000 to keep Jane within the field-of-view of computer system 1000 and/or computer system 1000 can alter agent representation 1004 to appear to keep pointing towards Jane as Jane moves through physical environment 1006.

While the examples above describe computer system 1000 responding to determinations that there is a higher level (e.g., a transition from a lower level to a higher level) of likelihood that Jane will interact with computer system 1000, it should be noted that computer system 1000 can respond a determination that there is a lower level (e.g., a transition from a higher level to a lower level) of likelihood that Jane will interact with computer system 1000. For example, in response to detecting Jane move from within the second threshold distance to outside the second threshold distance away from computer system 1000 while continuing to look at computer system 1000, a determination can be made that there is the third level of likelihood that Jane will interact with computer system 1000 and, in response, computer system 1000 can display information user interface 1002 as illustrated in FIG. 10C.

At FIG. 10F, while displaying agent user interface 1032, computer system 1000 detects input 1005f. While input 1005f is a verbal input from Jane instructing computer system 1000 to go to sleep (e.g., “Go to sleep.”), input 1005f can be other types of inputs such as an air-gesture, a gaze, and/or an input on a touch screen of computer system 1000. For example, input 1005f can be a closing fist air-gesture. For another example, input 1005f can be a swipe down input on a touch screen of computer system 1000.

At FIG. 10G, in response to detecting input 1005f, computer system 1000 transitions from the active mode to the inactive mode. As illustrated in FIG. 10G, as part of transitioning to the inactive mode, computers system 1000 displays sleep user interface 1038 after ceasing display of agent user interface 1032. In some embodiments, the inactive state of computer system 1000 is a lower-power state, a sleep state, an idle state, a state in which computer system 1000 forgoes performance of one or more detections, a state in which computer system 1000 forgoes detection of one or more inputs from a user, and/or a state in which computer system 1000 forgoes one or more outputs.

As illustrated in FIG. 10G, computer system 1000 displays agent representation 1004 within sleep user interface 1038 as a circle and a neutral expression (e.g., no hatchings) to indicate to Jane that the agent is not active. It should be noted that computer system 1000 can display agent representation 1004 in a form other than a circle to indicate to Jane that the agent is not active. For example, if computer system 1000 displays agent representation 1004 as having facial features, computer system 1000 can display agent representation 1004 as having a sleeping face with eyes closed and a snoring mouth. For another example, if computer system 1000 displays agent representation 1004 as a glow along an entire edge of a user interface while the agent is active, computer system 1000 can display agent representation 1004 as a glow along a portion of the edge of sleep user interface 1038 to indicate that the agent is not active.

In some embodiments, computer system 1000 responds as illustrated in FIG. 10G because input 1005f indicates to computer system 1000 that there is low likelihood that Jane will interact with computer system 1000. This low likelihood is a sixth level likelihood that is lower than the first, the second, the third, the fourth, and/or the fifth level likelihood that Jane will interact with computer system 1000. In some embodiments, computer system 1000 responds as illustrated in FIG. 10G in response to a determination that there is a low likelihood that Jane (e.g., any subject) will interact with computer system 1000. In some such embodiments, a determination that there is a low likelihood that Jane will interfere with computer system 1000 based on Jane not being detect for a predetermined amount of time. For example, if Jane has left physical environment 1006 and has not been detected via a camera connected to and/or in communication with computer system 1000 for a predetermined period of time, a determination can be made that there is a low likelihood that Jane will interact with computer system 1000.

FIG. 11 is a flow diagram illustrating a process (e.g., process 1100) for changing modality of output in accordance with some embodiments. Some operations in process 1100 are, optionally, combined, the orders of some operations are, optionally, changed, and some operations are, optionally, omitted.

As described below, process 1100 provides an intuitive way for changing modality of output in accordance with some embodiments. Process 1100 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by adjusting a computer system’s mode of output (e.g., video, audio, and/or movement) based on a subject’s likelihood of interaction with the computer system) enhances the operability of the device by reducing accidental and mistaken inputs, reducing energy usage by the device. Displaying user interface elements with different appearances at different times (such as by changing a display of content based on a subject’s likelihood of interaction with a computer system) helps to avoid image persistence or burn in effects that can occur with some display technologies when the same object is displayed with the same appearance at the same location repeatedly or for a long period of time. Performing an operation when a set of conditions has been met without requiring further user input (such as by displaying a specific application for a subject based on the subject’s likelihood of interaction with the computer system) enhances the operability of the device by reducing unnecessary inputs and/or steps to navigate through different user interfaces or sets of controls, reducing energy usage by the device.

In some embodiments, process 1100 is performed at a computer system (e.g., 1000) that is in communication (e.g., wired communication and/or wireless communication) with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a gyroscope, an inertial measurement unit, a global positioning system, a sensor, a mouse, a keyboard, a touchpad, and/or a touch-sensitive surface) and one or more output devices (e.g., one or more display components, one or more movement components, and/or one or more audio components). In some embodiments, the computer system is a phone, a watch, a tablet, a fitness tracking device, an accessory device, a processor, a head-mounted display (HMD) device, a communal device, a media device, a speaker, a television, an electronic device, a camera, and/or a personal computing device.

The computer system detects (1102), via the one or more input devices, a subject (e.g., a user, a person, an animal, another computer system different from the computer system, a device, and/or an object) (e.g., 1010) in a physical environment (e.g., a locality, a room, a location within a dwelling and/or structure, and/or a physical and/or virtually defined space) (e.g., 1006). In some embodiments, detecting the subject in the physical environment includes detecting one or more characteristics (e.g., location, movement, attention, and/or expression) of the subject. In some embodiments, detecting the subject in the physical environment includes moving a portion (e.g., including at least one of the one or more output devices and/or at least one of the one or more input devices) of the computer system to detect the subject in the physical environment.

In response to (1104) (and/or while) detecting the subject in the physical environment, in accordance with a determination that the subject has (and/or exceeds) a first likelihood (e.g., determined, calculated, and/or estimated probability) of interaction with the computer system, the computer system outputs (1106) (e.g., displays, moves a portion, including at least one of the one or more output devices and/or at least one of the one or more input devices, of the computer system, and/or audibly outputs), via the one or more output devices (e.g., the one or more display components, the one or more movement components, and/or the one or more audio components), a first modality of output (e.g., visual output, movement output, and/or audio output) without outputting, via the one or more output devices, a second modality of output (e.g., visual output, movement output, and/or audio output) different from the first modality of output (e.g., as described above with respect to FIGS. 10A-10B). In some embodiments, the subject has (and/or exceeds) the first likelihood of interaction with the computer system when one or more detected characteristics of the subject exceeds a first threshold (and/or does not exceed a second threshold). In some embodiments, in response to and/or while detecting the subject in the physical environment and in accordance with the determination that the subject has (and/or exceeds) the first likelihood of interaction with the computer system, the computer system forgoes (and/or ceases) output of another modality of output (e.g., different from the first modality of output). In some embodiments, in response to detecting the subject in the physical environment and in accordance with a determination that the subject does not have (and/or exceed) the first likelihood of interaction with the computer system, the computer system forgoes (and/or ceases) output of the first (and/or any) modality of output. In some embodiments, in response to detecting the subject in the physical environment and in accordance with the determination that the subject does not have (and/or exceed) the first likelihood of interaction with the computer system, the computer system outputs, via the one or more output devices, another modality of output (e.g., different from the first modality of output).

In response to (1104) detecting the subject in the physical environment, in accordance with a determination that the subject has (and/or exceeds) a second likelihood (e.g., determined, calculated, and/or estimated probability) of interaction with the computer system, the computer system outputs (1108) (e.g., displays, moves a portion, including at least one of the one or more output devices and/or at least one of the one or more input devices, of the computer system, and/or audibly outputs), via the one or more output devices (e.g., the one or more display components, the one or more movement components, and/or the one or more audio components), the first modality of output and the second modality of output (and/or adds the second modality of output) (e.g., as described above with respect to FIGS. 10C-10F), wherein the second likelihood of interaction is different from (e.g., greater or less than) the first likelihood of interaction. In some embodiments, the subject has (and/or exceeds) the second likelihood of interaction with the computer system when one or more detected characteristics of the subject exceeds a second threshold (and/or does not exceed a third threshold different from the second threshold). In some embodiments, in response to and/or while detecting the subject in the physical environment and in accordance with the determination that the subject has (and/or exceeds) the second likelihood of interaction with the computer system, the computer system forgoes (and/or ceases) output of another modality of output (e.g., different from the first modality of output and the second modality of output). In some embodiments, in response to detecting the subject in the physical environment and in accordance with a determination that the subject does not have (and/or exceed) the second likelihood of interaction with the computer system, the computer system forgoes (and/or ceases) output of the first modality of output and/or the second modality of output. In some embodiments, in response to detecting the subject in the physical environment and in accordance with the determination that the subject does not have (and/or exceed) the second likelihood of interaction with the computer system, the computer system outputs, via the one or more output devices, another modality of output (e.g., different from the first modality of output and/or the second modality of output).

In some embodiments, the determination that the subject has the first likelihood of interaction with the computer system includes a determination that the subject is directing a first threshold (e.g., an amount, a level and/or a degree of) of attention towards (e.g., aimed at, faced toward, and/or in the direction of) the computer system (e.g., as described above with respect to FIGS. 10A-10B). In some embodiments, the determination that the subject has the second likelihood of interaction with the computer system includes a determination that the subject is directing a second threshold (e.g., an amount, a level and/or a degree of) of attention towards (e.g., aimed at, faced toward, and/or in the direction of) the computer system (e.g., as described above with respect to FIGS. 10C-10F). In some embodiments, the second threshold of attention is different from the first threshold of attention. In some embodiments, the one or more output devices include one or more display components (e.g., a display screen, a projector, a head mounted display, and/or a touch-sensitive display). In some embodiments, as part of outputting the first modality of output without outputting the second modality of output, the computer system displays, via the one or more display components, a representation (e.g., an avatar, user interface object, an animation, a character, and/or content that is representative) (e.g., 1004) of an agent (e.g., as described above with respect to FIG. 5). In some embodiments, the determination that the subject is directing the first threshold of attention toward the computer system includes a determination that the subject is looking at the representation of the agent for less than a first predetermined period of time (e.g., 5 seconds and/or 6-10 seconds). In some embodiments, as part of outputting the first modality of output and the second modality of output the computer system displays, via the one or more display components, the representation of the agent and outputs, via the one or more output devise, audio content (e.g., speech, music, and/or white noise) (e.g., 1034). In some embodiments, the determination that the subject is directing the second threshold of attention toward the computer system includes a determination that the subject is directed at (e.g., looking at, positioned toward and/or aligned toward) the representation of the agent for a second predetermined period of time (e.g., 5 seconds and/or 6-10 seconds). In some embodiments, the second predetermined period of time is different from the first predetermined period of time.

In some embodiments, the determination that the subject has the first likelihood of interaction with the computer system includes a determination that the subject is within a first proximity (e.g., distance such as further than 5 ft or a range 1 in to 5 ft) of the computer system (and/or a portion of the computer system) (e.g., as described above with respect to FIG. 10A). In some embodiments, the determination that the subject has the second likelihood of interaction with the computer system includes a determination that the subject is within a second proximity (e.g., distance such as 5 ft or a range 1in-5 ft) of the computer system (and/or a portion of the computer system) (e.g., as described above with respect to FIGS. 10B-10D). In some embodiments, the second proximity is different from the first proximity of the computer system. In some embodiments, the determination that the subject is within the first proximity of the computer system is based on a notification or an alert, corresponding to (e.g., related to and/or associated with) a distance of the subject to the computer system (and/or a portion of the computer system), received from an external device different from the computer system (e.g., smartphone, tablet, and/or smart watch). In some embodiments, the determination that the subject is within the first proximity of the computer system includes a determination of the distance of the subject to the computer system (and/or the portion of the computer system). In some embodiments, the determination that the subject is within the second proximity of the computer system is based on a notification or an alert, corresponding to (e.g., related to and/or associated with) the distance of the subject to the computer system (and/or a portion of the computer system), received from the external device. In some embodiments, the determination that the subject is within the second proximity of the computer system includes a determination of the distance of the subject to the computer system (and/or a portion of the computer system).

In some embodiments, the one or more output devices includes one or more display components (e.g., a display screen, a projector, a head mounted display, and/or a touch-sensitive display). In some embodiments, outputting the first modality of output includes displaying, via the one or more display components, content (e.g., respective content, user interfaces, user interface elements, images, texts, photos, videos, animation, and/or notifications) (e.g., 1004, 1014, 1016, 1004, 1022, 1024, 1026, and/or a current time). In some embodiments, the content is personalized content corresponding to (e.g., created for, generated for, associated with and/or related to) the subject. In some embodiments, the content is general content (e.g., as described above with respect to FIG. 10A). In some embodiments, while the computer system outputs the first modality of output without output of the second modality of output, the computer system operates in a standby mode (e.g., an ambient mode, an inactive mode, a lower-power mode, a hibernation mode, a sleep mode, and/or a ready state mode) (e.g., as described above with respect to FIG. 10A).

In some embodiments, the content is a respective content. In some embodiments, in accordance with the determination that the subject has the first likelihood of interaction with the computer system, the respective content is a first content (e.g., user interfaces, user interface elements, images, texts, photos, videos, animation, and/or notifications) (e.g., as described above with respect to FIG. 10A-10D). In some embodiments, the first content is generalized content. In some embodiments, the first content is personalized content corresponding to (e.g., related to, associated with, and/or generated for) the subject. In some embodiments, the first content is displayed by the computer system for a predetermined period of time before the computer system ceases displaying the first content. In some embodiments, the first content is displayed while the computer system is in a standby mode (e.g., an ambient mode, an inactive mode, a lower-power mode, a hibernation mode, a sleep mode, and/or a ready state mode). In some embodiments, in accordance with the determination that the subject has the second likelihood of interaction with the computer system, the respective content is a second content (e.g., user interfaces, user interface elements, images, texts, photos, videos, animation, and/or notifications) (e.g., as described above with respect to FIG. 10B-10F). In some embodiments, the first content is different from the second content. In some embodiments, the second content is generalized content. In some embodiments, the second content is personalized content (e.g., as described above with respect to FIG. 10B-10D) corresponding to (e.g., related to, associated with, and/or generated for) the subject. In some embodiments, the second content is displayed by the computer system for a predetermined period of time before the computer system ceases displaying the second content. In some embodiments, the second content is displayed while the computer system is in a standby mode (e.g., an ambient mode, an inactive mode, a lower-power mode, a hibernation mode, a sleep mode, and/or a ready state mode).

In some embodiments, outputting the first modality of output without outputting the second modality of output includes displaying, via the one or more display components, a representation (e.g., an avatar, user interface object, an animation, a character, and/or content that is representative) (e.g., 1004) of an agent (e.g., as described above with respect to FIG. 5) in a first manner (e.g., in a style, at a size, in a color, an animation style, performing an action, and/or looking in a direction). In some embodiments, outputting the first modality of output and the second modality of output includes displaying, via the one or more display components, the representation of the agent in a second manner (e.g., in a style, at a size, in a color, an animation style, performing an action, and/or looking in a direction) (e.g., as described above with respect to 10D-10F) different from the first manner. In some embodiments, displaying the representation of the agent in the second manner includes visually emphasizing the representation of the agent more than the first manner. In some embodiments, displaying the representation of the agent in the first manner includes visually emphasizing the representation of the agent more than when displaying the representation of the agent in the second manner. In some embodiments, outputting the first modality of output and the second modality of output includes displaying, via the one or more display components, the representation of the agent in the second manner and other user interface elements including information that was generated by an application that is executing on the computer system. In some embodiments, while displaying the representation of the agent in the second manner, the computer system minimizes the size of the other user interface elements. In some embodiments, after a predetermined of time of displaying the representation of the agent in the second manner, the computer system ceases display of the other user interface elements.

In some embodiments, displaying the representation of the agent in the first manner includes displaying, via the one or more display components, the representation of the agent directed away from the subject (e.g., looking away from a direction of the subject, looking away from an area of the subject, and/or looking away from a position of the subject) in the physical environment (e.g., as described above with respect to FIG. 10A-10B). In some embodiments, displaying the representation of the agent in the second manner includes displaying, via the one or more display components, the representation of the agent directed toward the subject (e.g., looking toward a direction of the subject, looking toward an area of the subject, and/or looking toward a position of the subject) in the physical environment (e.g., as described above with respect to FIG. 10C-10F). In some embodiments, while displaying the representation of the agent directed away from the subject, the computer system detects (and/or receives) an input from the subject and, in response to detection of the input from the subject, displays, via the one or more display components, the representation of the agent directed toward the subject. In some embodiments, while displaying the representation of the agent directed toward the subject in the physical environment, the computer system detects (and/or receives) an input from another subject different from the subject and, in response to detection of the input from the other subject, displays, via the one or more display components, the representation of the agent directed toward the other subject in the physical environment.

In some embodiments, displaying the representation of the agent in the first manner includes displaying, via the one or more display components, the representation of the agent with a first characteristic (e.g., an facial expression such as a smile, a straight face, and/or blinking) (e.g., as described above with respect to FIGS. 10A-10F). In some embodiments, displaying the representation of the agent in the second manner includes displaying, via the one or more display components, the representation of the agent with a second characteristic (e.g., a facial expression such as a smile, a straight face, and/or blinking) (e.g., as described above with respect to FIGS. 10A-10F) different from the first characteristic. In some embodiments, while displaying the representation of the agent with the first characteristic, the computer system detects (and/or receives) an input from the subject and, in response to detection of the input from the subject, the computer system displays, via the one or more display components, the representation of the agent with a third characteristic different from the first characteristic and/or the second characteristic. In some embodiments, while displaying the representation of the agent with the second characteristic, the computer system detects (and/or receives) an input from another subject different from the subject and, in response to detection of the input from the other subject, the computer system displays, via the one or more display components, the representation of the agent with a fourth characteristic different from the first characteristic, the second characteristic, and/or the third characteristic.

In some embodiments, the computer system is in communication (e.g., wired communication and/or wireless communication) with (and/or includes) one or more movement components (e.g., an actuator, a movable base, a rotatable component, a motor, a lift, a level, and/or a rotatable base). In some embodiments, outputting the first modality of output and the second modality of output includes moving, via the one or more movement components, a portion (e.g., that includes one or more input devices and/or one or more output devices) of the computer system (e.g., as described above with respect to FIGS. 10C-10F). In some embodiments, the computer system outputs the first modality of output and the second modality of output simultaneously. In some embodiments, the computer system synchronizes output of the first modality of output and the second modality of output.

In some embodiments, moving the portion of the computer system includes: in accordance with a determination that the subject is at a first position in the physical environment, moving, via the one or more movement components, the portion of the computer system in a first manner (e.g., direction, speed, acceleration, and/or movement pattern) (e.g., as described above with respect to FIGS. 10C-10F); and, in accordance with a determination that the subject is at a second position in the physical environment, moving, via the one or more movement components, the portion of the computer system in a second manner (e.g., speed, acceleration, and/or movement pattern) (e.g., as described above with respect to FIGS. 10C-10F). In some embodiments, the first position is different from the second position. In some embodiments, the first manner is different from the second manner. In some embodiments, the second manner is based on (e.g., in a direction of, a position of, and/or an area of) the second position. In some embodiments, the computer system detects, via the one or more input devices, the subject is at the second position in the physical environment. In some embodiments, the computer system receives, from another computer system (e.g., personal device of the subject, security camera, and/or a server), an indication that the subject is at the second position. In some embodiments, the first manner is based on (e.g., in a direction of, a position of, and/or an area of) the first position. In some embodiments, the computer system detects, via the one or more input devices, the subject is at the first position in the physical environment. In some embodiments, the computer system receives, from another computer system (e.g., personal device of the subject, security camera, and/or a server), an indication that the subject is at the first position.

In some embodiments, moving the portion of the computer system includes: in accordance with a determination that the subject is moving in a first direction in the physical environment, moving, via the one or more movement components, the portion of the computer system in a second direction (e.g., as described above with respect to FIGS. 10C-10F); and, in accordance with a determination that the subject is moving in a third direction in the physical environment, moving, via the one or more movement components, the portion of the computer system in a fourth direction (e.g., as described above with respect to FIGS. 10C-10F). In some embodiments, the first direction is different from the third direction. In some embodiments, the second direction is different from the fourth direction. In some embodiments, the fourth direction tracks (e.g., follows, copies, and/or mirrors) the third direction. In some embodiments, the computer system detects, via the one or more input device, movement of the subject in the physical environment. In some embodiments, the computer system receives from another computer system (e.g., personal device of the subject, security camera, and/or a server) an indication of the movement of the subject. In some embodiments, the second direction tracks (e.g., follows, copies, and/or mirrors) the first direction. In some embodiments, the computer system detects, via the one or more input device, movement of the subject in the physical environment. In some embodiments, the computer system receives from another computer system (e.g., personal device of the subject, security camera, and/or a server) an indication of the movement of the subject.

In some embodiments, the one or more output devices includes one or more cameras (e.g., a periscope camera, a telephoto camera, a wide-angle camera, and/or an ultra-wide-angle camera). In some embodiments, the computer system is in communication (e.g., wired communication and/or wireless communication) with (and/or includes) one or more movement components (e.g., an actuator, a movable base, a rotatable component, a motor, a lift, a level, and/or a rotatable base). In some embodiments, while (and/or in response to or after) detecting the subject in the physical environment, in accordance with a determination that the subject has (and/or exceeds) a third likelihood (e.g., determined, calculated, and/or estimated probability) of interaction with the computer system, the computer system moves (and/or configures movement of), via the one or more movement components, a portion (e.g., that includes one or more input devices and/or one or more output devices) of the computer system to maintain (e.g., keep, align, and/or position) the subject in a first area (e.g., a space, a center portion, an edge portion, and/or a peripheral portion) of a field of view of the one or more cameras (e.g., as described above with respect to FIGS. 10C-10F). In some embodiments, the third likelihood of interaction with the computer system is the first likelihood of interaction with the computer system. In some embodiments, the third likelihood of interaction with the computer system is different from the first likelihood of interaction with the computer system. In some embodiments, the third likelihood of interaction with the computer system is the second likelihood of interaction with the computer system. In some embodiments, the third likelihood of interaction with the computer system is different from the second likelihood of interaction with the computer system. In some embodiments, the first area of the field of view of the one or more cameras is a peripheral (e.g., border, edge, and/or boundary) area of the field of view. In some embodiments, while detecting the subject in the physical environment, in accordance with a determination that the subject has (and/or exceeds) a fourth likelihood (e.g., determined, calculated, and/or estimated probability) of interaction with the computer system, the computer system moves (and/or configures movement of), via the one or more movement components, the portion of the computer system to maintain (e.g., keep, align, and/or position) the subject in a second area (e.g., a space, a center portion, an edge portion, and/or a peripheral portion) of the field of view of the one or more cameras (e.g., as described above with respect to FIGS. 10C-10F), wherein the fourth likelihood of interaction with the computer system is different from the third likelihood of interaction with the computer system, and wherein the first area of the field of view of the one or more cameras is different from the second area of the field of view of the one or more cameras. In some embodiments, the fourth likelihood of interaction with the computer system is the first likelihood of interaction with the computer system. In some embodiments, the fourth likelihood of interaction with the computer system is different from the first likelihood of interaction with the computer system. In some embodiments, the fourth likelihood of interaction with the computer system is the second likelihood of interaction with the computer system. In some embodiments, the fourth likelihood of interaction with the computer system is different from the second likelihood of interaction with the computer system. In some embodiments, the second area of the field of view of the one or more cameras is a center (e.g., middle and/or main) area of the field of view.

In some embodiments, in response to detecting the subject in the physical environment and in accordance with a determination that the subject has (and/or exceeds) a fifth likelihood (e.g., determined, calculated, and/or estimated probability) of interaction with the computer system, the computer system outputs (e.g., displays, moves a portion, including at least one of the one or more output devices and/or at least one of the one or more input devices, of the computer system, and/or audibly outputs), via the one or more output devices (e.g., the one or more display components, the one or more movement components, and/or the one or more audio components), a fifth modality of output (e.g., visual output, movement output, and/or audio output) (e.g., as described above with respect to FIGS. 10C-10F), wherein the fifth likelihood of interaction with the computer system is different from the first likelihood of interaction with the computer system and the second likelihood of interaction with the computer system, and wherein fifth modality of output is different from the first modality of output and the second modality of output. In some embodiments, the fifth likelihood of interaction with the computer system is greater or less than the first likelihood of interaction with the computer system. In some embodiments, the fifth likelihood of interaction with the computer system is greater or less than the second likelihood of interaction with the computer system.

In some embodiments, in response to detecting the subject in the physical environment and in accordance with the determination that the subject has the fifth likelihood of interaction with the computer system, the computer system outputs, via the one or more output devices, the first modality of output (and/or the second modality of output) (e.g., as described above with respect to FIGS. 10C-10F). In some embodiments, in response to detecting the subject in the physical environment and in accordance with the determination that the subject has the fifth likelihood of interaction with the computer system, the computer system outputs the fifth modality of output and the first modality of output without output of the second modality of output. In some embodiments, in response to detecting the subject in the physical environment and in accordance with the determination that the subject has the fifth likelihood of interaction with the computer system, the computer system outputs the fifth modality of output and the second modality of output without output of the first modality of output. In some embodiments, in response to detecting the subject in the physical environment and in accordance with the determination that the subject has the fifth likelihood of interaction with the computer system, the computer system outputs the fifth modality of output with output of the first modality of output and the second modality of output.

In some embodiments, the one or more output devices includes one or more display components (e.g., a display screen, a projector, a head mounted display, and/or a touch-sensitive display). In some embodiments, outputting the first modality of output without outputting the second modality of output includes displaying, via the one or more display components, a representation (e.g., an avatar, user interface object, an animation, a character, and/or content that is representative) of an agent (e.g., as described above with respect to FIG. 5) in a first manner (e.g., a size, a style, a characteristic, and/or an expression) (e.g., as described above with respect to FIGS. 10B-10F). In some embodiments, outputting the first modality of output and outputting the second modality of output includes displaying, via the one or more display components, the representation of the agent in a second manner (e.g., a size, a style, a characteristic, and/or an expression) different from the first manner (e.g., as described above with respect to FIGS. 10B-10F). In some embodiments, outputting the first modality of output and outputting the second modality of output includes the computer system displaying the representation of the agent in the second manner and the computer system outputting, via the one or more output devices, audio content. In some embodiments, the computer system synchronizes displaying the representation of the agent in the second manner with the outputting of the audio content, so it appears as if the representation of the agent in the second manner is outputting the audio content. In some embodiments, outputting the fifth modality of output includes displaying, via the one or more display components, the representation of the agent in a third manner (e.g., a size, a style, a characteristic, and/or an expression) (e.g., as described above with respect to FIGS. 10B-10F) different from the first manner and the second manner. In some embodiments, outputting the fifth modality of output includes the computer system displaying the representation of the agent in the third manner without the computer system outputting the first modality of output and the second modality of output.

In some embodiments, in response to detecting the subject in the physical environment and in accordance with the determination that the subject has the fifth likelihood of interaction with the computer system, the computer system outputs, via the one or more output devices, the second modality of output (and/or the first modality of output) (e.g., as described above with respect to FIGS. 10C-10F). In some embodiments, in response to detecting the subject in the physical environment and in accordance with the determination that the subject has the fifth likelihood of interaction with the computer system, the computer system outputs the fifth modality of output and the second modality of output without output of the first modality of output. In some embodiments, in response to detecting the subject in the physical environment and in accordance with the determination that the subject has the fifth likelihood of interaction with the computer system, the computer system outputs the fifth modality of output, the second modality of output, and output of the first modality of output.

In some embodiments, outputting the fifth modality of output includes outputting, via the one or more output devices, audio content (e.g., a verbal greeting, speech, music and/or white noise) (e.g., 1034 and/or as described above with respect to FIG. 10E). In some embodiments, outputting the audio content includes sending, to a speaker of another computer system different for the computer system, the audio content for output by the speaker.

In some embodiments, the audio content includes an identification (e.g., full name, nickname, alias, and/or account ID) (e.g., “Jane” in 1034) of the subject (e.g., as described above with respect to FIG. 10E).

In some embodiments, while (and/or after) outputting the first modality of output and the second modality of output, the computer system detects a change in (e.g., a location of, a position of, a direction of, and/or the likelihood of interaction with computer system of) the subject in the physical environment (e.g., as described above with respect to FIGS. 10B-10F). In some embodiments, detecting the change in the subject in the physical environment includes receiving a notification and/or alert from another computer system such as a personal device of the subject different from the computer system. In some embodiments, the computer system detects the change in the subject in the physical environment using image recognition. In some embodiments, as part of detecting the change in the subject in the physical environment, the computer system detects, via the one or more input devices, the change in the subject in the physical environment. In some embodiments, in response to detecting the change in the subject in the physical environment and in accordance with a determination that the subject has (and/or exceeds) a sixth likelihood (e.g., determined, calculated, and/or estimated probability) of interaction with the computer system, the computer system outputs, via the one or more output devices, a sixth modality of output (e.g., visual output, movement output, and/or audio output) (e.g., as described above with respect to FIGS. 10B-10F), wherein the sixth modality of output is different from the first modality of output and the second modality of output, and wherein the sixth likelihood of interaction with the computer system is different from the first likelihood of interaction with the computer system and the second likelihood of interaction with the computer system. ISE in response to detecting the change in the subject in the physical environment and in accordance with the determination that the subject has the sixth likelihood of interaction with the computer system, the computer system outputs the sixth modality of output without output of the first modality of output and the second modality of the output. ISE in response to detecting the change in the subject in the physical environment and in accordance with the determination that the subject has the sixth likelihood of interaction with the computer system, the computer system outputs the sixth modality of output, the first modality of output and the second modality of the output.

In some embodiments, while (and/or after) outputting the first modality of output without outputting the second modality of output, the computer system detects a change in (e.g., a location of, a position of, a direction of, and/or the likelihood of interaction with computer system of) the subject in the physical environment (e.g., as described above with respect to FIGS. 10B-10F). In some embodiments, detecting the change in the subject in the physical environment includes receiving a notification and/or alert from another computer system such as a personal device of the subject different from the computer system. In some embodiments, the computer system detects the change in the subject in the physical environment using image recognition. In some embodiments, detecting the change in the subject in the physical environment includes, detecting, via the one or more input devices, the change in the subject in the physical environment. In some embodiments, in response to detecting the change in the subject in the physical environment and in accordance with a determination that the subject has (and/or exceeds) the second likelihood (e.g., determined, calculated, and/or estimated probability) of interaction with the computer system, the computer system outputs the first modality of output and the second modality of output (e.g., as described above with respect to FIGS. 10B-10F). In some embodiments, in response to detecting the change in the subject in the physical environment and in accordance with the determination that the subject has the second likelihood of interaction with the computer system, the computer system outputs the first modality of output, the second modality of output, and a third modality of output, wherein the third modality of output is different from the first modality of output and the second modality of output.

In some embodiments, in response to detecting the subject in the physical environment and in accordance with a determination that the subject has (and/or is less than) an seventh likelihood (e.g., determined, calculated, and/or estimated probability) of interaction with the computer system, the computer system forgoes output of the first modality of output and the second modality of output (e.g., as described above with respect to FIG. 10G), wherein the seventh likelihood of interaction with the computer system is different from the first likelihood of interaction with the computer system and the second likelihood of interaction with the computer system. In some embodiments, the determination that the subject has the seventh likelihood of interaction with the computer system includes a determination that the computer system previously detected an input from the subject to enter a sleep mode (e.g., an ambient mode, an inactive mode, a lower-power mode, a hibernation mode, a sleep mode, and/or a ready state mode). In some embodiments, the computer system detects the input form the subject to enter the sleep mode by receiving the input from a personal device of the subject different from the computer system. In some embodiments, the computer system detects, via the one or more input devices, the input from the subject to enter the sleep mode.

Note that details of the processes described above with respect to process 1100 (e.g., FIG. 11) are also applicable in an analogous manner to the processes described herein. For example, process 900 optionally includes one or more of the characteristics of the various processes described herein with reference to process 1100. For example, the first set of one more user interface elements of process 900 can be content included in the first modality of output of process 1100. For brevity, these details are not repeated herein.

The description above, has been described with reference to specific examples for the purpose of explanation. Such specific examples can be in the form of textual description above and/or in the accompanying drawings. However, such embodiments should not be interpreted as being exhaustive and/or limiting to the disclosure (e.g., limiting to the explicit manners described herein). Many modifications and variations are possible in view of the above teachings by one of ordinary skill in the art without departing from the scope of the present disclosure.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

Aspects of the technology described above can include gathering and/or using data from various sources. Such data can be used to improve interactions that a device has with its environment (e.g., interactions with users). In some scenarios, such data can include personal information that is usable to uniquely identify a specific person. Such personal information can include demographic data, telephone numbers, email addresses, location and/or location-related data, home addresses, work addresses, and/or any other identifying information. The use of such personal information can be utilized for the benefit of users of the device. For example, a user’s personal information can be used to improve interactions that the device engages in with the user. Other benefits from the use for personal information data are also possible and within the scope of the present disclosure.

The use of personal information can require one or more entities handling such data. These entities can be involved in collecting, processing, disclosing, transferring, storing, or other functions that support the technologies described herein. The present disclosure expects that (e.g., does not preclude) that all use of personal information data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such personal information, and such collection and/or use should only be for legitimate and reasonable uses. Further, personal information of a user should not be shared, disclosed, sold, and/or provided for uses other than legitimate and/or reasonable uses.

Various scenarios can arise in which personal information is not available, such as when a user selects not to share such information. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of personal information can benefit a user by improving the operation of the device, the present disclosure contemplates that embodiments of the present technology can be used without such data. For example, operations of the device can use non-personal information (e.g., instead of and/or in place of personal information). Other techniques include making inferences based on non-personal information data or a minimal amount of personal information.

What is claimed is:

1. A method, comprising:
at a computer system that is in communication with one or more input devices and one or more output devices:
detecting, via the one or more input devices, a subject in a physical environment; and
in response to detecting the subject in the physical environment:
in accordance with a determination that the subject has a first likelihood of interaction with the computer system, outputting, via the one or more output devices, a first modality of output without outputting, via the one or more output devices, a second modality of output different from the first modality of output; and
in accordance with a determination that the subject has a second likelihood of interaction with the computer system, outputting, via the one or more output devices, the first modality of output and the second modality of output, wherein the second likelihood of interaction is different from the first likelihood of interaction.

2. The method of claim 1, wherein the determination that the subject has the first likelihood of interaction with the computer system includes a determination that the subject is directing a first threshold of attention towards the computer system, wherein the determination that the subject has the second likelihood of interaction with the computer system includes a determination that the subject is directing a second threshold of attention towards the computer system, and wherein the second threshold of attention is different from the first threshold of attention.

3. The method of claim 1, wherein the determination that the subject has the first likelihood of interaction with the computer system includes a determination that the subject is within a first proximity of the computer system, wherein the determination that the subject has the second likelihood of interaction with the computer system includes a determination that the subject is within a second proximity of the computer system, and wherein the second proximity is different from the first proximity of the computer system.

4. The method of claim 1, wherein the one or more output devices includes one or more display components, and wherein outputting the first modality of output includes displaying, via the one or more display components, content.

5. The method of claim 4, wherein:
the content is a respective content;
in accordance with the determination that the subject has the first likelihood of interaction with the computer system, the respective content is a first content;
in accordance with the determination that the subject has the second likelihood of interaction with the computer system, the respective content is a second content; and
the first content is different from the second content.

6. The method of claim 4, wherein outputting the first modality of output without outputting the second modality of output includes displaying, via the one or more display components, a representation of an agent in a first manner, and wherein outputting the first modality of output and the second modality of output includes displaying, via the one or more display components, the representation of the agent in a second manner different from the first manner.

7. The method of claim 6, wherein displaying the representation of the agent in the first manner includes displaying, via the one or more display components, the representation of the agent directed away from the subject in the physical environment, and wherein displaying the representation of the agent in the second manner includes displaying, via the one or more display components, the representation of the agent directed toward the subject in the physical environment.

8. The method of claim 6, wherein displaying the representation of the agent in the first manner includes displaying, via the one or more display components, the representation of the agent with a first characteristic, and wherein displaying the representation of the agent in the second manner includes displaying, via the one or more display components, the representation of the agent with a second characteristic different from the first characteristic.

9. The method of claim 1, wherein the computer system is in communication with one or more movement components, and wherein outputting the first modality of output and the second modality of output includes moving, via the one or more movement components, a portion of the computer system.

10. The method of claim 9, wherein moving the portion of the computer system includes:
in accordance with a determination that the subject is at a first position in the physical environment, moving, via the one or more movement components, the portion of the computer system in a first manner; and
in accordance with a determination that the subject is at a second position in the physical environment, moving, via the one or more movement components, the portion of the computer system in a second manner, wherein the first position is different from the second position, and wherein the first manner is different from the second manner.

11. The method of claim 9, wherein moving the portion of the computer system includes:
in accordance with a determination that the subject is moving in a first direction in the physical environment, moving, via the one or more movement components, the portion of the computer system in a second direction; and
in accordance with a determination that the subject is moving in a third direction in the physical environment, moving, via the one or more movement components, the portion of the computer system in a fourth direction, wherein the first direction is different from the third direction, and wherein the second direction is different from the fourth direction.

12. The method of claim 1, wherein the one or more output devices includes one or more cameras, and wherein the computer system is in communication with one or more movement components, the method further comprising:
while detecting the subject in the physical environment:
in accordance with a determination that the subject has a third likelihood of interaction with the computer system, moving, via the one or more movement components, a portion of the computer system to maintain the subject in a first area of a field of view of the one or more cameras; and
in accordance with a determination that the subject has a fourth likelihood of interaction with the computer system, moving, via the one or more movement components, the portion of the computer system to maintain the subject in a second area of the field of view of the one or more cameras, wherein the fourth likelihood of interaction with the computer system is different from the third likelihood of interaction with the computer system, and wherein the first area of the field of view of the one or more cameras is different from the second area of the field of view of the one or more cameras.

13. The method of claim 1, further comprising:
in response to detecting the subject in the physical environment and in accordance with a determination that the subject has a fifth likelihood of interaction with the computer system, outputting, via the one or more output devices, a fifth modality of output, wherein the fifth likelihood of interaction with the computer system is different from the first likelihood of interaction with the computer system and the second likelihood of interaction with the computer system, and wherein fifth modality of output is different from the first modality of output and the second modality of output.

14. The method of claim 13, further comprising:
in response to detecting the subject in the physical environment and in accordance with the determination that the subject has the fifth likelihood of interaction with the computer system, outputting, via the one or more output devices, the first modality of output.

15. The method of claim 13, wherein:
the one or more output devices includes one or more display components;
outputting the first modality of output without outputting the second modality of output includes displaying, via the one or more display components, a representation of an agent in a first manner;
outputting the first modality of output and outputting the second modality of output includes displaying, via the one or more display components, the representation of the agent in a second manner different from the first manner; and
outputting the fifth modality of output includes displaying, via the one or more display components, the representation of the agent in a third manner different from the first manner and the second manner.

16. The method of claim 13, further comprising:
in response to detecting the subject in the physical environment and in accordance with the determination that the subject has the fifth likelihood of interaction with the computer system, outputting, via the one or more output devices, the second modality of output.

17. The method of claim 13, wherein outputting the fifth modality of output includes outputting, via the one or more output devices, audio content.

18. The method of claim 17, wherein the audio content includes an identification of the subject.

19. The method of claim 1, further comprising:
while outputting the first modality of output and the second modality of output, detecting a change in the subject in the physical environment; and
in response to detecting the change in the subject in the physical environment and in accordance with a determination that the subject has a sixth likelihood of interaction with the computer system, outputting, via the one or more output devices, a sixth modality of output, wherein the sixth modality of output is different from the first modality of output and the second modality of output, and wherein the sixth likelihood of interaction with the computer system is different from the first likelihood of interaction with the computer system and the second likelihood of interaction with the computer system.

20. The method of claim 1, further comprising:
while outputting the first modality of output without outputting the second modality of output, detecting a change in the subject in the physical environment; and
in response to detecting the change in the subject in the physical environment and in accordance with a determination that the subject has the second likelihood of interaction with the computer system, outputting the first modality of output and the second modality of output.

21. The method of claim 1, further comprising:
in response to detecting the subject in the physical environment and in accordance with a determination that the subject has an seventh likelihood of interaction with the computer system, forgoing output of the first modality of output and the second modality of output, wherein the seventh likelihood of interaction with the computer system is different from the first likelihood of interaction with the computer system and the second likelihood of interaction with the computer system.

22. A non-transitory computer-readable storage medium storing one or more programs configured to be executed by one or more processors of a computer system that is in communication with one or more input devices and one or more output devices, the one or more programs including instructions for:
detecting, via the one or more input devices, a subject in a physical environment; and
in response to detecting the subject in the physical environment:
in accordance with a determination that the subject has a first likelihood of interaction with the computer system, outputting, via the one or more output devices, a first modality of output without outputting, via the one or more output devices, a second modality of output different from the first modality of output; and
in accordance with a determination that the subject has a second likelihood of interaction with the computer system, outputting, via the one or more output devices, the first modality of output and the second modality of output, wherein the second likelihood of interaction is different from the first likelihood of interaction.

23. A computer system that is configured to communicate with one or more input devices and one or more output devices, the computer system comprising:
one or more processors; and
memory storing one or more programs configured to be executed by the one or more processors, the one or more programs including instructions for:
detecting, via the one or more input devices, a subject in a physical environment; and
in response to detecting the subject in the physical environment:
in accordance with a determination that the subject has a first likelihood of interaction with the computer system, outputting, via the one or more output devices, a first modality of output without outputting, via the one or more output devices, a second modality of output different from the first modality of output; and
in accordance with a determination that the subject has a second likelihood of interaction with the computer system, outputting, via the one or more output devices, the first modality of output and the second modality of output, wherein the second likelihood of interaction is different from the first likelihood of interaction.
